(19) United States
(12) Patent Application Publication
(10) Pub. No.: US 2025/0173787 A1
(43) Pub. Date: May 29, 2025

(54) PERSONAL LOAN-LENDING SYSTEM AND METHODS THEREOF

(71) Applicant: loanDepot.com, LLC, Irvine, CA (US)

(72) Inventors: Eileen Kim, Laguna Niguel, CA (US); Anne Eckles, Irvine, CA (US); Benjamin Lack, Ladera Ranch, CA (US); Maja Todorovic, Irvine, CA (US)

(73) Assignee: loanDepot.com, LLC, Irvine, CA (US)

(21) Appl. No.: 19/039,702

(22) Filed: Jan. 28, 2025

Related U.S. Application Data
(63) Continuation-in-part of application No. 18/139,259, filed on Apr. 25, 2023.
(63) Continuation-in-part of application No. 16/443,555, filed on Jun. 17, 2019, now abandoned.
(60) Provisional application No. 62/687,046, filed on Jun. 19, 2018.

(51) Int. Cl. G06Q 40/03

(52) U.S. Cl. CPC G06Q 40/03

(57) ABSTRACT

This disclosure relates to a lending system comprising a processor, a memory, and at least one network interface controller configured to enable data exchange with external systems. The memory includes lending management logic configured to execute a personal loan-lending system wherein one or more loans are generated by collecting and preprocessing borrower data from multiple sources, conducting risk assessment and scoring, generating one or more scores based on the conducted risk assessment, and approving loans based on the generated scores. The system leverages machine learning processes to refine scoring accuracy and dynamically adapt to borrower profiles and external conditions. The system may integrate with third-party data sources for enhanced verification and incorporate compliance logic to ensure adherence to regulatory standards. By employing automated, data-driven processes, the system improves efficiency, accuracy, and security in loan origination, servicing, and compliance while enabling dynamic risk management and tailored loan product offerings.

### PRIORITY

This application is a continuation-in-part of, and claims the benefit of U.S. patent application, entitled “Personal Loan-Lending System And Methods Thereof,” filed on Apr. 25, 2023, and having application Ser. No. 18/139,259 which claims the benefit of, and priority to, U.S. patent application, entitled “Personal Loan-Lending System And Methods Thereof,” filed on Jun. 17, 2019, and having application Ser. No. 16/443,555, which claims the benefit of, and priority to, U.S. Provisional Application, filed on Jun. 19, 2018, and having application Ser. No. 62/687,046, the entirety of each of said applications being incorporated herein by reference.

### FIELD

Embodiments of the present disclosure generally relate to the field of banking. More specifically, embodiments of the disclosure relate to a system for personal loan-lending and methods thereof.

### BACKGROUND

An important financial service provided by financial institutions is lending, which can include originating loans, servicing loans, or both originating and serving loans. There are many different types of loans available through such financial institutions. Broadly, the different types of loans are divided between secured loans and unsecured loans, wherein the secured loans are secured against borrowers' assets. Secured loans include, for example, mortgages, home equity loans, home equity lines of credit, or automotive loans. Unsecured loans include, for example, personal loans, personal lines of credit, student loans, or credit cards.

Lending, particularly originating loans such as personal loans, requires many fragmented, often manual processes of both borrowers and lenders. For a borrower, such processes include filling out a loan application and providing information in support of the loan application, the supporting information including, for example, employment, income, and liability information. For a lender, such processes include processing the borrower's loan application and verifying the supporting information, underwriting a potential loan and performing a detailed risk assessment in view of the supporting information, and, ultimately, upon approval from underwriting, funding the loan. Moreover, such processes are highly specific to loan type. This obviates any financial benefit from economies of scale that could otherwise be passed onto borrowers and lenders alike if such processes were more tightly integrated. Accordingly, there is a need for a more highly automated, more tightly integrated lending platform that facilitates lending for at least unsecured loan types such as personal loans.

Disclosed herein is a personal loan-lending system and methods thereof that address at least the foregoing need.

### SUMMARY

Disclosed herein is a personal loan-lending system including, in some embodiments, a personal loan-originating system configured for originating personal loans, a personal loan-servicing system configured for servicing the personal loans, and third-party integration supporting the originating or the servicing of the personal loans. The third-party integration includes one or more application programming interfaces (“APIs”) configured for transferring loan-related information between the personal loan-lending system and third parties. The personal loan-lending system includes one or more server hosts supporting a personal loan-originating application stack and a personal loan-servicing application stack.

In some embodiments, the personal loan-originating application stack includes a web server, an application server, a database server, and an e-mail server. Each server of the web server, the application server, the database server, and the e-mail server is configured to operate at least in part in a primary memory of at least one server host of the one or more server hosts.

In some embodiments, the personal loan-servicing application stack also includes a web server, an application server, a database server, and an e-mail server. Each server of the web server, the application server, the database server, and the e-mail server is configured to operate at least in part in a same primary memory of the at least one server host or a different primary memory of at least one other server host of the one or more server hosts.

In some embodiments, the application server is configured to provide at least a mobile web application configured to operate at least in part in a primary memory of a mobile device and present a borrower graphical user interface (“GUI”) within a mobile web browser on a touchscreen of a display of the mobile device. The borrower GUI is configured to allow potential borrowers to enter borrower-related information into a number of borrower-fillable sections of a digital application.

In some embodiments, the application server is configured to provide at least a web application configured to operate at least in part in a primary memory of a personal computer and present a lender GUI within a web browser on a screen of a monitor associated with the personal computer. The lender GUI is configured to allow a representative of the lender to review the borrower-related information entered in the number of sections of the digital application.

In some embodiments, the lender GUI is configured to allow the representative of the lender to send secured e-mail messages through the lender GUI by way of the e-mail server with automatic e-mail headers and attachments determined in accordance with a focus in the lender GUI on a particular borrower and loan process step.

In some embodiments, the number of sections of the digital application include a borrower-account registration section, a loan-purpose section, a borrower-profile section, an income-information section, an employment-history section, a banking-information section, or a combination thereof. Each section of the number of sections is configured to hold the borrower-related information until transferred to the database server and stored in a database on a storage device of the at least one server host of the one or more server hosts.

In some embodiments, the personal loan-originating application stack includes an automatic underwriting module. The automatic underwriting module is configured to perform detailed risk assessments in view of the borrower-related information transferred to the database server and stored in the database on the storage device of the at least one server host of the one or more server hosts.

In some embodiments, each section of the number of sections of the digital application optionally includes a graphical element configured to activate a servlet upon activation of the graphical element by a potential borrower. The servlet is configured to allow the potential borrowers to upload electronic copies or images of documents selected from at least driver's licenses, pay stubs, and bank statements.

In some embodiments, the personal loan-originating application stack includes an optical character recognition (“OCR”) module. The OCR module is configured to recognize text in uploaded images of documents, extract text from the images, and provide the text by way of the web server for automated filling of the borrower-related information.

In some embodiments, the borrower-related information from the banking information section transferred to the database server and stored in the database on the storage device of the at least one server host of the one or more server hosts is later used by the personal loan-originating system for automatically depositing personal-loan funds.

In some embodiments, the borrower-related information from the banking information section transferred to the database server and stored in the database on the storage device of the at least one server host of the one or more server hosts is later used by the personal loan-servicing system for automatically setting up monthly Automated Clearing House (“ACH”) payments on personal loans in accordance with terms of the personal loans, the terms ranging from 3 to 5 years.

Also disclosed herein is non-transitory (i.e., non-transient) computer or machine-readable media (“CRM”) including executable instructions that, when executed on one or more server hosts by at least an equal number of processors, cause the one or more server hosts to instantiate a personal loan-lending system configured to perform a number of steps. The number of steps include, in some embodiments, instantiating a personal loan-originating application stack of a personal loan-originating system for originating personal loans, instantiating a personal loan-servicing application stack of a personal loan-servicing system for servicing the personal loans; and providing third-party integration supporting the originating or the servicing of the personal loans. The third-party integration includes one or more APIs configured for transferring loan-related information between the personal loan-lending system and third parties.

In some embodiments, the number of steps further include operating the personal loan-originating application stack at least in part in a primary memory of at least one server host of the one or more server hosts. The personal loan-originating application stack includes a web server, an application server, a database server, and an e-mail server.

In some embodiments, the number of steps further include operating the personal loan-servicing application stack at least in part in a same primary memory of the at least one server host or a different primary memory of at least one other server host of the one or more server hosts. The personal loan-servicing application stack includes a web server, an application server, a database server, and an e-mail server.

In some embodiments, the number of steps further include providing at least a mobile web application by way of the application server. The mobile web application is configured to operate at least in part in a primary memory of a mobile device and present a borrower GUI within a mobile web browser on a touchscreen of a display of the mobile device. The borrower GUI is configured to allow potential borrowers to enter borrower-related information into a number of borrower-fillable sections of a digital application.

In some embodiments, the number of steps further include providing at least a web application by way of the application server. The web application is configured to operate at least in part in a primary memory of a personal computer and present a lender GUI within a web browser on a screen of a monitor associated with the personal computer. The lender GUI is configured to allow a representative of the lender to review the borrower-related information entered in the number of sections of the digital application.

In some embodiments, the number of steps further include sending secured e-mail messages through the lender GUI by way of the e-mail server. The lender GUI is configured to allow the representative of the lender to send the secured e-mail messages with automatic e-mail headers and attachments determined in accordance with a focus in the lender GUI on a particular borrower and loan process step.

In some embodiments, the number of steps further include transferring to the database server and storing in a database on a storage device of the at least one server host of the one or more servers borrower-related information held in the number of sections of the digital application. The number of sections of the digital application for the personal loan include a borrower-account registration section, a loan-purpose section, a borrower-profile section, an income-information section, an employment-history section, a banking-information section, or a combination thereof.

In some embodiments, the number of steps further include automatically underwriting with an automatic underwriting module of the personal loan-originating application stack. The automatic underwriting module is configured to perform detailed risk assessments in view of the borrower-related information transferred to the database server and stored in the database on the storage device of the at least one server host of the one or more server hosts.

In some embodiments, the number of steps further include providing a servlet configured to allow the potential borrowers to upload electronic copies or images of documents selected from at least driver's licenses, pay stubs, and bank statements. Each section of the number of sections of the digital application optionally includes a graphical element configured to activate the servlet upon activation of the graphical element by a potential borrower and upload the electronic copes or images of documents.

In some embodiments, the number of steps further include recognizing text in uploaded images of documents with an OCR module of the personal loan-originating application stack, extracting text from the uploaded images of documents with the OCR module, and providing the text by way of the web server for automated filling of the borrower-related information.

In some embodiments, the number of steps further include automatically depositing personal-loan funds by way of the personal loan-originating system. The borrower-related information from the banking information section transferred to the database server and stored in the database on the storage device of the at least one server host of the one or more server hosts is used for automatically depositing the personal-loan funds.

In some embodiments, the number of steps further include automatically setting up monthly ACH payments by way of the personal loan-originating system on personal loans in accordance with terms of the personal loans. The borrower-related information from the banking information section transferred to the database server and stored in the database on the storage device of the at least one server host of the one or more server hosts is used for automatically setting up the monthly ACH payments.

In some embodiments, a lending system, includes a processor; at least one network interface controller configured to enable data exchange with external systems; and a memory communicatively coupled to the processor, wherein the memory includes a lending management logic configured to execute a personal loan-lending system wherein one or more loans are generated by collecting and preprocessing borrower data from multiple sources; conducting risk assessment and scoring to the collected data generating one or more scores based on the conducted risk assessment and approving a loan based on the one or more scores, wherein the one or more scores are generated via one or more machine learning processes.

In some embodiments, the borrower data is collected from one or more sources including: customer data, environmental data, or compliance data.

In some embodiments, the lending management logic is further configured to validate the collected borrower against at least Know Your Customer (KYC) data and Anti-Money Laundering (AML) requirements.

In some embodiments, the one or more machine learning processes include training models using historical data and real-time borrower behavior to improve an accuracy of the generated scores.

In some embodiments, the memory further includes an external integration logic configured to retrieve additional borrower information from third-party data providers to enhance an accuracy of risk assessment.

In some embodiments, the one or more scores include a credit score, a fraud likelihood score, and a financial health score, each generated using distinct algorithms tailored to specific data inputs.

In some embodiments, the lending management logic is further configured to dynamically adjust a loan approval criteria based on at least one of: environmental data, including geographic risk data or market condition data.

In some embodiments, the score generation is based on at least borrower demographics and financial profiles generated by one or more large language models.

In some embodiments, the lending management logic is further configured to generate detailed risk assessment reports for each loan via the one or more machine learning processes, summarizing the collected data and scoring metrics.

In some embodiments, the one or more machine learning processes are configured to self-optimize by analyzing outcomes of previously approved loans to refine scoring algorithms.

In some embodiments, the lending management logic is further configured to track and update borrower repayment history in near real-time to continuously adjust risk and financial health scores.

In some embodiments, the lending management logic further includes utilizing compliance logic to generate at least one regulatory compliance report based on borrower data and the scoring process.

In some embodiments, a method for operating a loan server includes executing a personal loan-lending system wherein one or more loans are generated by collecting and preprocessing borrower data from multiple sources conducting risk assessment and scoring to the collected data generating one or more scores based on the conducted risk assessment and approving a loan based on the one or more scores, wherein the one or more scores are generated via one or more machine learning processes.

In some embodiments, executing the personal loan-lending system further includes generating a borrower financial profile via one or more machine learning processes prior to conducting a risk assessment.

In some embodiments, the one or more machine learning processes is a large language model.

In some embodiments, the risk assessment utilizes the generated borrower financial profile.

In some embodiments, executing the personal loan-lending system further includes converting the risk assessment into an input compatible with a neural network.

In some embodiments, the one or more machine learning processes utilize at least a neural network configured with at least the one or more scores as an input to the neural network.

In some embodiments, the one or more machine learning processes utilize at least a neural network configured with at least the one or more scores, and converted risk assessments as inputs to the neural network.

In some embodiments, a personal loan-lending system operable by way of a set of executable instructions stored in non-transient machine-readable media of one or more server hosts by at least an equal number of processors, the personal loan-lending system includes a personal loan-originating system configured for originating personal loans, wherein originating personal loans includes at least collecting and preprocessing borrower data from multiple sources, conducting risk assessment and scoring to the collected data, generating one or more scores based on the conducted risk assessment; and approving a loan based on the one or more scores, wherein the one or more scores are generated via one or more machine learning processes, a personal loan-servicing system configured for servicing the personal loans; and third-party integration supporting the originating or the servicing of the personal loans.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 provides a schematic illustrating an integrated lending-and-brokering environment including a lending platform in accordance with various embodiments of the disclosure;

FIG. 2 provides a schematic illustrating the lending platform including the personal loan-lending system in accordance with various embodiments of the disclosure;

FIG. 3 provides a schematic illustrating a personal loan-originating system of the personal loan-lending system in accordance with various embodiments of the disclosure;

FIG. 4 provides a schematic illustrating a personal loan-servicing system of the personal loan-lending system in accordance with various embodiments of the disclosure;

FIG. 5 provides a schematic illustrating a process of the personal loan-originating system in accordance with various embodiments of the disclosure;

FIG. 6 provides a schematic illustrating a process of the personal loan-servicing system in accordance with various embodiments of the disclosure;

FIG. 7 is a diagram depicting various subsets of artificial intelligence in accordance with various embodiments of the disclosure;

FIG. 8 depicts different methods of machine-based learning in accordance with various embodiments of the disclosure;

FIG. 9 depicts a machine learning lifecycle in accordance with various embodiments of the disclosure; and

FIG. 10 is an exemplary neural network for use in a fully controlled camera system in accordance with various embodiments of the disclosure.

FIG. 11 is a conceptual illustration of a variety of tokens for utilization within a large language model in accordance with various embodiments of the disclosure;

FIG. 12 is a conceptual illustration of an embedding matrix for a large language model, in accordance with various embodiments of the disclosure;

FIG. 13 is a conceptual illustration of an input prompt converted from a series of tokens into a series of tensors in accordance with various embodiments of the disclosure;

FIG. 14 is a conceptual illustration of an attention layer process within a large language model in accordance with various embodiments of the disclosure;

FIG. 15 is a conceptual illustration of a multi-layer perceptron within a large language model in accordance with various embodiments of the disclosure;

FIG. 16 is a conceptual illustration of an unembedding process within a large language model in accordance with various embodiments of the disclosure;

FIG. 17 is a conceptual illustration of a personal loan-lending system in accordance with various embodiments of the disclosure;

FIG. 18 is a conceptual illustration of a plurality of data that can be utilized in accordance with various embodiments of the disclosure;

FIG. 19 provides a schematic illustrating components of a network host in accordance with various embodiments of the disclosure; and

FIG. 20 depicts a process for loan processing in accordance with various embodiments of the disclosure.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

Before some particular embodiments are disclosed in greater detail, it should be understood that the particular embodiments disclosed herein do not limit the scope of the concepts provided herein. It should also be understood that a particular embodiment disclosed herein can have features that can be readily separated from the particular embodiment and optionally combined with or substituted for features of any of a number of other embodiments disclosed herein.

Regarding terms used herein, it should also be understood the terms are for the purpose of describing some particular embodiments, and the terms do not limit the scope of the concepts provided herein. Ordinal numbers (e.g., first, second, third, etc.) are generally used to distinguish or identify different features or steps in a group of features or steps, and do not supply a serial or numerical limitation. For example, “first,” “second,” and “third” features or steps need not necessarily appear in that order, and the particular embodiments including such features or steps need not necessarily be limited to the three features or steps. Labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” and the like are used for convenience and are not intended to imply, for example, any particular fixed location, orientation, or direction. Instead, such labels are used to reflect, for example, relative location, orientation, or directions. Singular forms of “a,” “an,” and “the” include plural references unless the context clearly dictates otherwise.

Unless defined otherwise, all technical and scientific terms used herein have the same meaning as commonly understood by those of ordinary skill in the art.

As previously set forth, lending requires many fragmented, often manual processes of both borrowers and lenders. Moreover, such processes are highly specific to loan type. This obviates any financial benefit from economies of scale that could otherwise be passed onto borrowers and lenders alike if such processes were more tightly integrated and generalized across the loan types. Accordingly, there is a need for a more highly automated, more tightly integrated lending platform that dissolves lines between lending for secured and unsecured loan types.

Disclosed herein is a personal loan-lending system and methods thereof that address at least the foregoing need.

For example, a personal loan-lending system is disclosed herein including, in some embodiments, a personal loan-originating system configured for originating personal loans, a personal loan-servicing system configured for servicing the personal loans, and third-party integration supporting the originating or the servicing of the personal loans. The third-party integration includes one or more application programming interfaces configured for transferring loan-related information between the personal loan-lending system and third parties such as credit bureaus, employment verification providers, or the like. The personal loan-lending system includes one or more server hosts supporting a personal loan-originating application stack and a personal loan-servicing application stack. Also disclosed herein are methods of the personal loan-lending system.

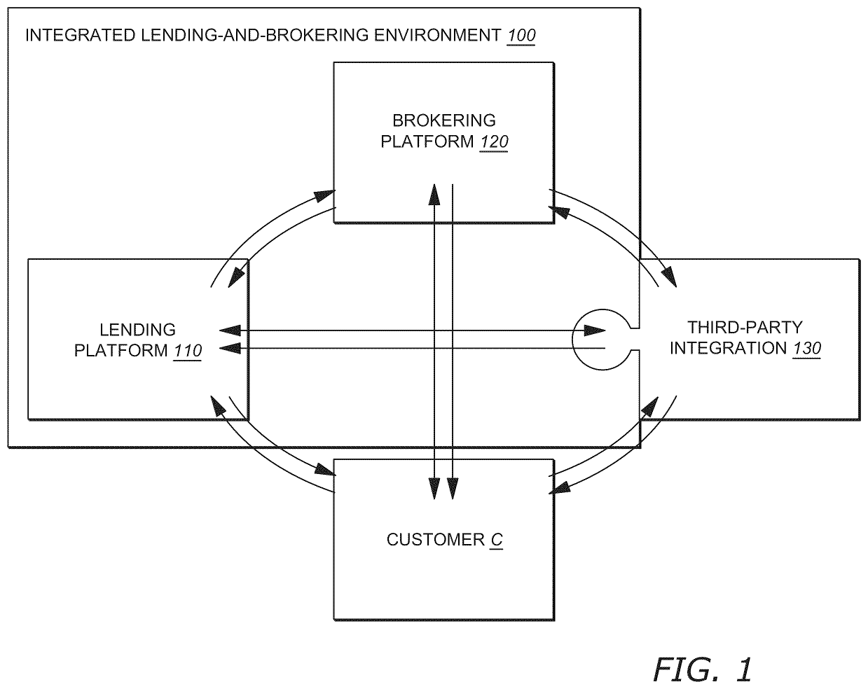

Referring to FIG. 1, a schematic illustrating an integrated lending-and-brokering environment 100 including a lending platform 110 in accordance with some embodiments is shown. As shown in the embodiment depicted in FIG. 1, the integrated lending-and-brokering environment 100 may include, in some embodiments, the lending platform 110, a brokering platform 120, and third-party integration 130, wherein the integrated lending-and-brokering environment 100 is configured for information sharing such that at least a customer need not provide duplicative customer information to any systems of the integrated lending-and-brokering environment 100 or any personnel associated therewith.

In many embodiments, the lending platform 110 can be configured for gathering and processing lending-related information for originating loans, servicing loans, or both, wherein the loans are selected from unsecured loans and secured loans. The brokering platform 120 can be configured for gathering and processing brokering-related information for buying assets, selling assets, buying services related to selling the assets, or a combination thereof, wherein the assets include real estate, and wherein the services include services for improving such real estate (e.g., home improvement-related services). In more embodiments, the third-party integration 130 may include one or more interfaces with the lending-and-brokering environment 100 such as one or more APIs, one or more web applications, or at least one API and at least one web application. The third-party integration 130 can allow the one or more third-parties to at least contribute additional information for the processing of the lending-related information, the brokering-related information, or both.

It is contemplated that, in some embodiments, the lending platform 110 may include an artificial intelligence (AI) model that can be configured to accurately perform one or more of the steps comprising automatically underwriting loans, as described herein. For example, a server host can include an AI logic or module that may be configured to train one or more AI processes (e.g., machine learning or other suitable large language model (LLM), large action model (LAM), or the like) to perform one or more steps described within the disclosure. In some embodiments, a neural network or other processing system may be utilized. In some embodiments, the AI modules may be trained on dataset(s) representing user account histories and/or previous readjustments, determinations, qualifying offers, weights, metrics, thresholds, qualifying scores, or any other suitable or relevant training data. In certain embodiments, the AI modules may be trained on specific user account(s) and/or credit history.

In further embodiments, the AI module may be configured to self-correct and improve based on a feedback process for modifying the one or more assigned weights and/or unique thresholds. For example, upon a readjustment of weights of metrics, the readjustment values can be measured as leading to a desired outcome or an undesired outcome according to one or more criteria or ground truths, which can then be fed back into the AI module as training data. As the AI module further trains on these readjustments, it can determine whether those readjustments are desirable or undesirable. Thus, the AI module can be configured to self-correct or otherwise improve as it continues to make additional readjustments. It is contemplated that a wide variety of potential AI modules can be employed for such a self-correcting techniques. In various embodiments, one or more AI modules may be used in a similar manner for other determinations, computations, and/or predictions within the system. In additional embodiments, one or more AI modules may be configured to automatically generate any one or more of metrics, weights, thresholds, tiers, qualifying scores for tiers, qualifying offers, reports, or any other suitable aspect of the systems described herein, without limitation. In some embodiments, such AI modules may be configured to similarly self-correct and improve this generation based on one or more feedback processes.

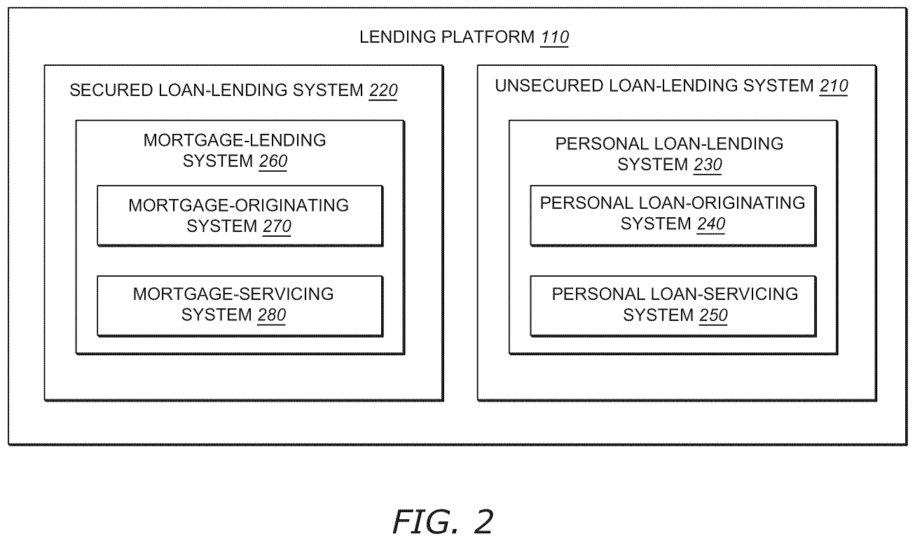

Although a specific embodiment for an integrated lending-and-brokering environment including a lending platform suitable for carrying out the various steps, processes, methods, and operations described herein is discussed with respect to FIG. 1, any of a variety of systems and/or processes may be utilized in accordance with embodiments of the disclosure. For example, other arrangements may be suitable based on the relationship between the various parties, including those where no third-party integrations are necessary. Those skilled in the art will recognize that the system presented in FIG. 1 is simplified for illustration purposes. The elements depicted in FIG. 1 may also be interchangeable with other elements of FIGS. 2-20 as required to realize a particularly desired embodiment.

Referring to FIG. 2, a schematic illustrating the lending platform 110 including a personal loan-lending system 230 in accordance with various embodiments of the disclosure is shown. As can be seen in the embodiment depicted in FIG. 2, the lending platform 110 includes an unsecured loan-lending system 210 and a secured loan-lending system 220. The unsecured loan-lending system 210 includes at least the personal loan-lending system 230 having a personal loan-originating system 240 and a personal loan-servicing system 250. The personal loan-originating system 240 is configured for originating personal loans. The personal loan-servicing system 250 is configured for servicing the personal loans. The personal-loan lending system 230 includes one or more server hosts supporting at least a personal loan-originating application stack for originating the personal loans and a personal loan-servicing application stack for servicing the personal loans. The secured loan-lending system 220 includes at least a mortgage-lending system 260 having a mortgage-originating system 270 and a mortgage-servicing system 280.

In many embodiments, the lending platform 110 depicted in FIG. 2 can serve as a comprehensive framework for facilitating loan origination and servicing across both unsecured and secured loan types. At the core of this platform are the Unsecured Loan-Lending System 210 and the Secured Loan-Lending System 220, each of which may have distinct functions tailored to the type of loan being processed. Together, they may create an integrated environment capable of handling diverse lending scenarios with efficiency and scalability. In further embodiments, the Unsecured Loan-Lending System 210 can focus on loans that are not backed by collateral, such as personal loans. This system may include the Personal Loan-Lending System 230, which itself can comprise two primary subsystems: the Personal Loan-Originating System 240 and the Personal Loan-Servicing System 250.

The Personal Loan-Originating System 240 may be responsible for the initial stages of loan processing, including borrower application management, creditworthiness evaluations, and fraud detection. Advanced technologies, such as an automatic underwriting module, can streamline risk assessment by leveraging borrower-provided data and integrating third-party services like credit bureaus and employment verification systems. Additionally, tools such as Optical Character Recognition (OCR) may facilitate the automated extraction of information from documents submitted by borrowers, such as pay stubs or IDs. This system can also include a loan product generator that may create tailored loan offerings based on borrower profiles.

The Personal Loan-Servicing System 250 may ensure smooth post-origination management of loans. Key functionalities can include payment processing, such as setting up automated ACH transactions for recurring payments, and debt collection for delinquent accounts. The system may provide distinct interfaces for debtors and creditors, enabling seamless account management and communication. By integrating these servicing capabilities, the platform may not only simplify loan repayments for borrowers but also ensure creditors can efficiently track and manage loan portfolios.

The Secured Loan-Lending System 220 may focus on loans backed by collateral, such as mortgages. This system can include the Mortgage-Lending System 260, which may be further divided into the Mortgage-Originating System 270 and the Mortgage-Servicing System 280. The Mortgage-Originating System 270 may handle processes specific to secured loans, such as property evaluations and legal verifications. Meanwhile, the Mortgage-Servicing System 280 can oversee post-origination activities, including payment collection, escrow management, and compliance reporting. Together, these subsystems may provide a robust infrastructure for handling the complexities associated with secured lending.

At the infrastructure level, the lending platform may be powered by a modular server architecture that can support its origination and servicing activities. Each loan type-secured or unsecured—may rely on dedicated server hosts, with application stacks designed for specific tasks. For example, web servers can facilitate user interfaces for borrowers and creditors, database servers may store loan-related data securely, and application servers may handle backend processing, including underwriting and risk analysis. APIs may enable seamless third-party integration, connecting the platform to external services such as credit bureaus, fraud detection systems, and banking networks.

Although a specific embodiment for a lending platform including a personal loan-lending system suitable for carrying out the various steps, processes, methods, and operations described herein is discussed with respect to FIG. 2, any of a variety of systems and/or processes may be utilized in accordance with embodiments of the disclosure. For example, other arrangements may be suitable based on the types of products being offered. Those skilled in the art will recognize that the system presented in FIG. 2 is simplified for illustration purposes. The elements depicted in FIG. 1 may also be interchangeable with other elements of FIGS. 1 and 3-20 as required to realize a particularly desired embodiment.

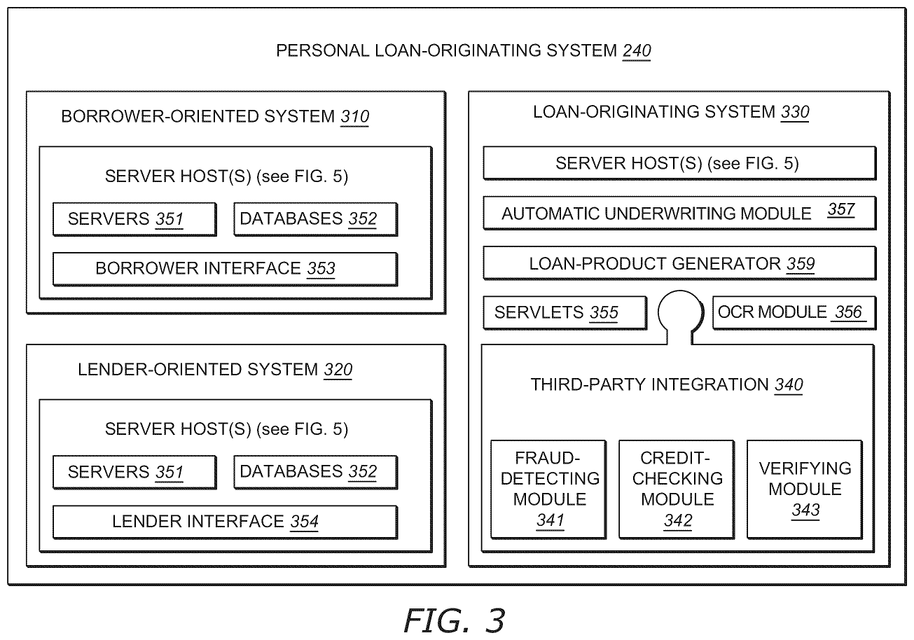

Referring to FIG. 3, a schematic illustrating the personal loan-originating system 240 of the personal loan-lending system 230 in accordance with various embodiments of the disclosure is shown. As depicted in the embodiment depicted in FIG. 3, the personal loan-originating system 240 can include a borrower-oriented system 31, a lender-oriented system 320, a loan-originating subsystem 330 for at least loan-application processing, and third-party integration 340 supporting personal-loan origination.

Again, the personal-loan lending system 230 may include one or more server hosts. These one or more server hosts can be shared among at least the borrower-oriented system 310, the lender-oriented system 320, and the loan-originating subsystem 330 of the personal loan-originating system 240. That said, each system of the borrower-oriented system 310, the lender-oriented system 320, and the loan-originating subsystem 330 can alternatively or additionally include one or more dedicated server hosts as needed.

In a number of embodiments, the personal loan-originating application stack for originating the personal loans includes a web server, an application server, a database server, one or more databases, and an e-mail server. Collectively, such servers and databases are respectively shown in FIG. 3 as servers 351 and databases 352. Each server of the web server, the application server, the database server, and the e-mail server are configured to operate at least in part in a primary memory of at least one server host of the one or more server hosts.

In additional embodiments, the application server can be configured to provide at least a web application configured to operate at least in part in a primary memory of a computer system and present a borrower interface 353, or borrower GUI 353, within a web browser on a screen of a display of the computer system. For example, the application server may be configured to provide a mobile web application configured to operate at least in part in a primary memory of a mobile device and present a borrower GUI within a mobile web browser on a touchscreen of a display of the mobile device. The borrower GUI 353 can be configured to allow potential borrowers to enter borrower-related information into a number of borrower-fillable sections of a digital application.

In association with the foregoing servlets, the personal loan-originating system 240 can also include an OCR module 356 as shown in FIG. 3. The OCR module 356 may be configured in certain embodiments to recognize text in uploaded images of documents, extract text from the images, and provide the text by way of the web server for automated filling of the borrower-related information. These steps can be supplemented by one or more A.I. processes.

In more embodiments, the application server may also be configured to provide at least a web application configured to operate at least in part in a primary memory of another computer system and present a lender interface 354, or lender GUI 354, within a web browser on a screen of a display of the computer system. For example, the application server can also be configured to provide at least a web application configured to operate at least in part in a primary memory of a personal computer and present a lender GUI within a web browser on a screen of a monitor associated with the personal computer. The lender GUI 354 being configured in certain embodiments to allow a representative of the lender to review the borrower-related information entered in the number of sections of the digital application.

The lender GUI 354 (shown as “lender interface”) is configured to allow the representative of the lender to send secured e-mail messages through the lender GUI 354 by way of the e-mail server with automatic e-mail headers and attachments determined in accordance with a focus in the lender GUI 354 on a particular borrower and loan process step. The secured e-mail messages can solicit additional borrower-related information and direct recipient borrower to one or more pages of a web site or the borrower GUI 353 to upload electronic copies or images of documents.

In additional embodiments, the personal loan-originating system 240 can further include an automatic underwriting module 357 configured to perform detailed risk assessments in view of the borrower-related information transferred to the database server and stored in the one or more databases 354 on the storage device of the at least one server host of the one or more server hosts. The third-party integration 340 may include one or more API modules such as a fraud-checking module 341, credit-checking module 342, and a verifying module 343 configured for transferring loan-related information between the personal loan-originating system 240 and third parties such as fraud-detecting companies bureaus, credit bureaus, employment-verification providers, or other third-party vendors.

In still more embodiments, the personal loan-originating system 240 can include a loan-product generator 359 configured to generate different loan products from which potential borrowers can choose once at least some of the borrower-related information from the digital application is processed. In various embodiments, a borrower interface 353 can be configured as a web application of the personal loan-originating system 240. As those skilled in the art will recognize, the borrow may be prompted to enter a number of different items into a plurality of fillable entry fields. These fields may be configured into various sections, such as, but not limited to, a borrower-account registration section, a loan-purpose section, a borrower-profile section, an income-information section, an employment-history section, banking-information section, or one or more combinations of the foregoing borrower-fillable sections.

Such sections are not typically presented to a potential borrower all at once in order to avoid inundating the potential borrower, as inundating the potential borrower can reduce quality of the borrower-related information provided by the borrow in the number of borrower-fillable sections. Each section of the number of sections is configured to hold the borrower-related information until transferred to the database server and stored in a database of the one or more databases 352 on a storage device of the at least one server host of the one or more server hosts. As such, a digital application for a potential borrower can exist in an incomplete state in the database of the one or more databases 352.

Furthermore, the borrower interface 353 may exist in a borrower-recognizable state corresponding to the incomplete state of the digital application in the database of the one or more databases. For example, if the potential borrower has finished with the borrower-account registration but has not selected an offer in accordance with the next section of the digital application, this is recorded in the database of the one or more databases 352 and recognized by the potential borrower in the borrower interface as a required step for moving to the next section of the digital application. The borrower-related information from the banking information section transferred to the database server and stored in the one or more databases 352 on a storage device of the at least one server host of the one or more server hosts is later used by the personal loan-originating system for automatically depositing personal-loan funds.

Each section of the number of sections of the digital application optionally includes one or more graphical elements such as an on-screen button (e.g., “Save & Continue,” etc.) configured to respectively activate one or more servlets 355 of the loan-originating subsystem 330 upon activation by a potential borrower. One or more of the servlets is configured to allow the potential borrowers to upload electronic copies or images of documents selected from at least driver's licenses, pay stubs, and bank statements.

In more embodiments, the application server may also be configured to provide at least a web application configured to operate at least in part in a primary memory of another computer system and present a lender interface 354, or lender GUI 354 (shown as “Lender Interface”), within a web browser on a screen of a display of the computer system. For example, the application server can be configured to provide at least a web application configured to operate at least in part in a primary memory of a personal computer and present a lender GUI within a web browser on a screen of a monitor associated with the personal computer. The lender GUI 354 may also be configured to allow a representative of the lender to review the borrower-related information entered in the number of sections of the digital application. The lender GUI 354 can be configured to allow the representative of the lender to send secured e-mail messages through the lender GUI 354 by way of the e-mail server with automatic e-mail headers and attachments determined in accordance with a focus in the lender GUI 3540 on a particular borrower and loan process step. The secured e-mail messages can solicit additional borrower-related information and direct recipient borrower to one or more pages of a web site or the borrower GUI 353 to upload electronic copies or images of documents.

In still further embodiments, the personal loan-originating system 240 can include an automatic underwriting module 357 configured to perform detailed risk assessments in view of the borrower-related information transferred to the database server and stored in the one or more databases 354 on the storage device of the at least one server host of the one or more server hosts. The third-party integration 340 includes one or more API modules such as a fraud-detecting module 341, credit-checking module 342, and a verifying module 343 configured for transferring loan-related information between the personal loan-originating system 240 and third parties such as fraud-detecting companies bureaus, credit bureaus, employment-verification providers, or other third-party vendors. Finally, in certain embodiments, the personal loan-originating system 240 can include a loan-product generator 359 configured to generate different loan products from which potential borrowers can choose once at least some of the borrower-related information from the digital application is processed.

Although a specific embodiment for the personal loan-originating system of the personal loan-lending system suitable for carrying out the various steps, processes, methods, and operations described herein is discussed with respect to FIG. 3, any of a variety of systems and/or processes may be utilized in accordance with embodiments of the disclosure. For example, one or more A.I. processes, such as those described below can be utilized by one or more of these components to supplement, or otherwise augment the processing of the system. Those skilled in the art will also recognize that the system presented in FIG. 3 is simplified for illustration purposes. The elements depicted in FIG. 3 may also be interchangeable with other elements of FIGS. 1-2 and 4-20 as required to realize a particularly desired embodiment.

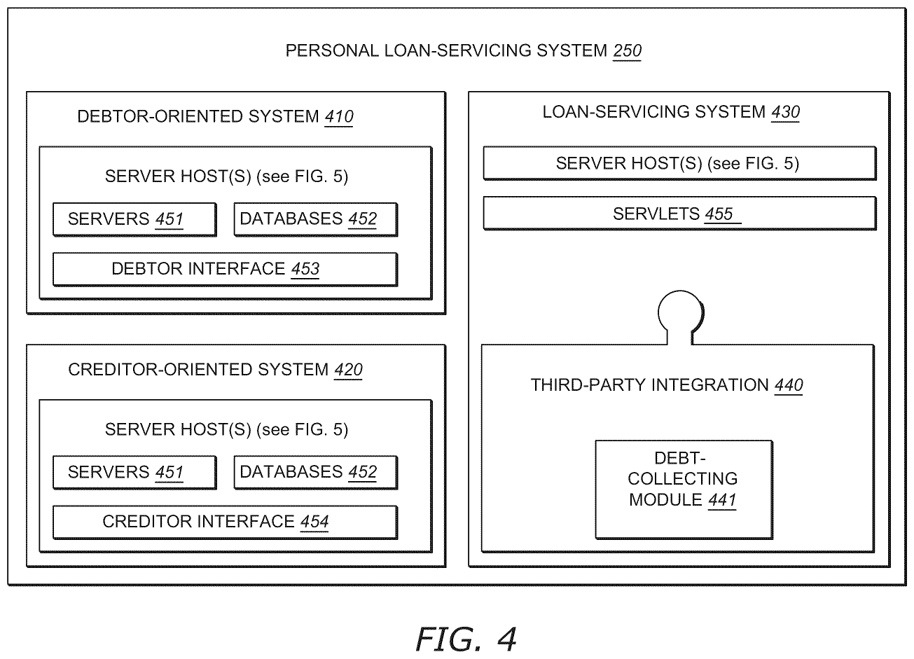

Referring to FIG. 4, a schematic illustrating a personal loan-servicing system 250 in accordance with various embodiments of the disclosure is shown. As shown in embodiment depicted in FIG. 4, the personal loan-servicing system 250 can include a debtor-oriented system 410, a creditor-oriented system 420, a loan-servicing subsystem 430, and third-party integration 440 supporting personal-loan servicing. Again, the personal-loan lending system 250 can include one or more server hosts, described in more detail below. The one or more server hosts can be shared among at least the debtor-oriented system 410, the creditor-oriented system 420, and the loan-servicing subsystem 430 of the personal loan-servicing system 250. That said, each system of the debtor-oriented system 410, the creditor-oriented system 420, and the application-processing system 430 can alternatively or additionally include one or more dedicated server hosts as needed.

In many embodiments, the personal loan-servicing application stack for servicing the personal loans can include a web server, an application server, a database server, one or more databases, and an e-mail server. Collectively, such servers and databases are respectively shown in FIG. 4 as servers 451 and databases 452. Each server of the web server, the application server, the database server, and the e-mail server can be configured to operate at least in part in a primary memory of at least one server host of the one or more server hosts. The application server can be configured to provide at least a web application configured to operate at least in part in a primary memory of a computer system and present a debtor interface 453, or debtor GUI 453, within a web browser on a screen of a display of the computer system. For example, the application server can be configured to provide a mobile web application configured to operate at least in part in a primary memory of a mobile device and present a debtor GUI within a mobile web browser on a touchscreen of a display of the mobile device. The debtor GUI 453 can be configured to allow borrowers to pay down existing personal loans.

In certain embodiments, the debtor GUI 453 may optionally can include one or more graphical elements such as an on-screen button configured to respectively activate one or more servlets 455 of the loan-servicing subsystem 430 upon activation by a debtor. One or more of the servlets can be configured to allow the debtor to transfer funds by way of an ACH transfer from a linked bank account to pay down an existing personal loan. The borrower-related information from the banking information section of the digital application transferred to the database server and stored in the one or more databases 354 on the storage device of the at least one server host of the one or more server hosts can be used by the personal loan-servicing system 250 for automatically setting up monthly ACH payments on personal loans in accordance with terms of the personal loans, which terms range from 3 to 5 years.

The application server may also be configured to provide at least a web application configured to operate at least in part in a primary memory of another computer system and present a creditor interface 454, or creditor GUI 454, within a web browser on a screen of a display of the computer system. For example, the application server can be configured to provide at least a web application configured to operate at least in part in a primary memory of a personal computer and present a creditor GUI within a web browser on a screen of a monitor associated with the personal computer. The creditor GUI 354 can be configured to allow a representative of the creditor to review the borrower-related information for debtors with existing personal loans. In some embodiments, the third-party integration 440 can include one or more API modules such as a debt-collecting module 441 configured for transferring loan-related information between the personal loan-servicing system 250 and third parties such as debt collectors.

In some embodiments, the integrated lending-and-brokering environment may include one or more application stacks such as the personal loan-originating application stack and the personal loan-servicing application stack. Each application stack can be independently configured to run at least in part from a primary memory of at least one server host of the server hosts of the lending-and-brokering environment. In some embodiments, the server hosts supporting the integrated lending-and-brokering environment and the one or more application stacks thereof can include a web server, an application server, a database server with an associated database, an e-mail server configured to send and receive secured e-mail messages, or a combination thereof.

For expository convenience, the server host may be configured to support the web server, the server host can be configured to support the application server, the server host is often configured to support the database server, and the server host is typically configured to support the e-mail server. However, the web server, the application server, the database server, and the e-mail server can be supported by any one or more of the server hosts in any of a number of ways. In various embodiments, the server hosts can further support mobile device-oriented server counterparts such as a mobile web server or a mobile application server if such mobile device-oriented server counterparts are not already integrated with their counterpart servers.

With respect to the personal loan-originating application stack for originating personal loans, an application server of the personal loan-originating application stack supported by, for example, the server host can include a borrower-oriented web application server module (not shown) configured to service requests from one of more client hosts such as a borrower's client host for a borrower-oriented web application (e.g., the borrower GUI 353). The borrower-oriented web application server module can be a mobile web application server module configured to service requests from one of more mobile devices (e.g., smart phones, tablet computers, etc.) for a mobile web application version of the borrower-oriented web application. The personal loan-originating application stack can also include a lender-oriented web application server module (not shown) configured to service requests from one of more client hosts such as a lender's client host for a lender-oriented web application (e.g., the lender GUI 354). The lender-oriented web application server module can be a mobile web application server module configured to service requests from one of more mobile devices (e.g., smart phones, tablet computers, etc.) for a mobile web application version of the lender-oriented web application.

With respect to the personal loan-servicing application stack for servicing personal loans, an application server of the personal loan-servicing application stack supported by, for example, the server host can include a debtor-oriented web application server module (not shown) configured to service requests from one of more client hosts such as a borrower's client host for a debtor-oriented web application (e.g., the debtor GUI 453). The debtor-oriented web application server module can be a mobile web application server module configured to service requests from one of more mobile devices (e.g., smart phones, tablet computers, etc.) for a mobile web application version of the debtor-oriented web application. The personal loan-servicing application stack can also include a creditor-oriented web application server module (not shown) configured to service requests from one of more client hosts such as a creditor's client host for a creditor-oriented web application (e.g., the creditor GUI 454). The creditor-oriented web application server module can be a mobile web application server module configured to service requests from one of more mobile devices (e.g., smart phones, tablet computers, etc.) for a mobile web application version of the creditor-oriented web application.

With respect to any third party-oriented application stack, an application server of the third party-oriented application stack supported by, for example, the server host can include a third party-oriented web application server module (not shown) configured to service requests from one of more client hosts such as a third party's client host for a third party-oriented web application. The third party-oriented web application server module can be a mobile web application server module configured to service requests from one of more mobile devices (e.g., smart phones, tablet computers, etc.) for a mobile web application version of the third party-oriented web application.

Although a specific embodiment for the personal loan-originating system of the personal loan-lending system suitable for carrying out the various steps, processes, methods, and operations described herein is discussed with respect to FIG. 4, any of a variety of systems and/or processes may be utilized in accordance with embodiments of the disclosure. For example, such client hosts can alternatively run local applications native to the operating systems of the client hosts. Those skilled in the art will also recognize that the system presented in FIG. 4 is simplified for illustration purposes. The elements depicted in FIG. 4 may also be interchangeable with other elements of FIGS. 1-3 and 5-20 as required to realize a particularly desired embodiment.

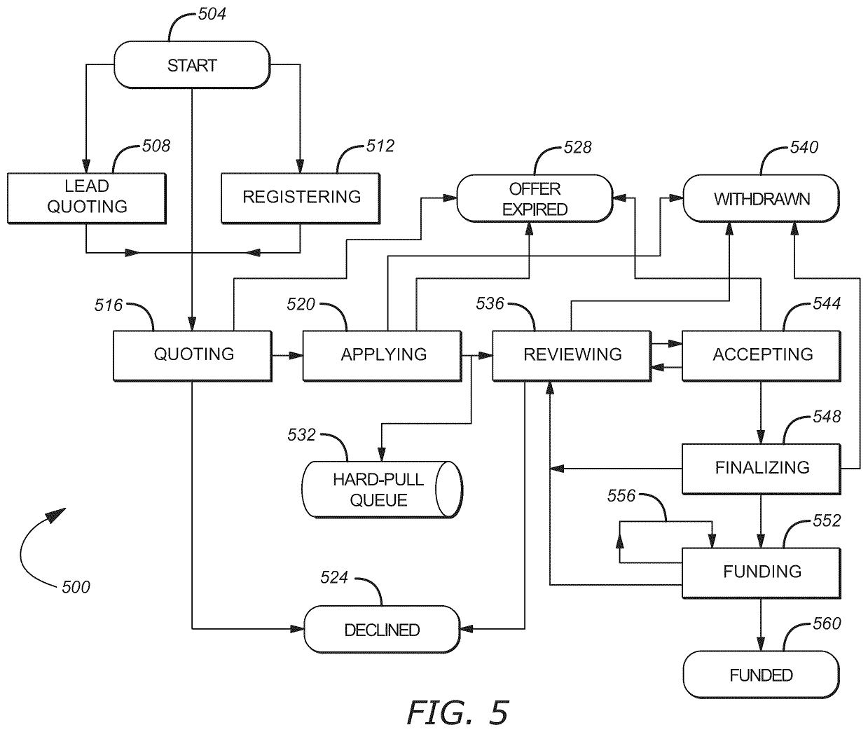

Referring to FIG. 5, a schematic illustrating a process 500 by which potential borrowers and representatives of the lender interact by way of the personal loan-originating system 240 in accordance with various embodiments of the disclosure is shown. The process 500 generally illustrates one embodiment whereby a personal loan is successfully funded. The process 500 begins at a start step 504 wherein a borrower seeks a personal loan. The borrower may begin the process 500 as an external lead 508 or by way of a registration step 512, wherein the borrower creates an account. The process 500 moves to a quotation step 516 wherein the borrower receives one or more offers. When the borrower selects an offer, the process 500 advances to an application step 520. In some instances, however, a credit/fraud/pricing engine may decline the borrower, in which case the process 500 moves the borrower to a declined step 524. Further, in some instances, the borrower may neglect to select from among the offers presented in step 516. When the borrower fails to select an offer, the process 500 may move to an offer expired step 528.

While at the application step 520, the borrower may be prompted to complete an application for the personal loan. Upon completing the application, the borrower's application may be placed into a hard-pull queue 532 until a hard inquiry into the borrower's credit history may be performed. It is contemplated that the hard inquiry may be performed by an underwriter at a reviewing step 536. In some instances, however, wherein the borrower does not complete the application in step 520, the process moves to the offer expired step 528. Further, in some instances the borrower may voluntarily withdraw the application during either the application step 520 or the reviewing step 536. In such instances, the process 500 may move to a withdrawn step 540. Moreover, the underwriter or a fraud analyst may decline the borrower's application during the reviewing step 536, in which case the process 500 may move to the declined step 524.

When the underwriter approves the borrower's application, the process 500 may move from step 536 to an accepting step 544. As shown in FIG. 5, the process 500 may move between steps 536, 544 during underwriting and preparation of final documents. If the borrower fails to accept the final documents, the process 500 may move to the offer expired step 528. However, if the borrower does accept the final documents, the process 500 may advance to a finalizing step 548. During the finalizing step 548, the final documents may be subjected to a quality control analysis wherein critical variables in the final documents are checked for accuracy. If additional verification is needed, the process 500 may return to the reviewing step 536. Further, if the borrower withdraws the application, the process 500 may move to the withdrawn step 540.

Once final verification of the application is completed, the process 500 moves to a funding step 552. During step 552, the final loan documents and an ACH request are sent to a lender. If the lender rejects the ACH request, the funding step 552 may resubmit the ACH request, 556, or refer the loan documents back to the reviewing step 536 for further underwriting and analysis. If the lender accepts the ACH request, the process advances to step 506 wherein the borrower receives net proceeds by ACH and a loan boarding file is sent to the servicer.

In various embodiments, integration of artificial intelligence (AI) and large language model (LLM) technologies into the process 500 may occur to enhance the efficiency, accuracy, and user experience of the personal loan-originating system. In these embodiments, AI and LLMs can play a significant role at various stages of the process, transforming it into an intelligent, borrower-centric framework. For example, in the quotation step 516, AI and/or LLMs can analyze borrower-provided data, often incomplete or unstructured, to dynamically generate personalized loan offers. Borrowers may input informal inquiries or vague details, which LLMs can interpret to provide tailored suggestions or clarify options in real-time. AI may also leverage historical data to predict and present the most appealing offers, ensuring relevance and competitiveness.

During the application step 520, LLMs can function as virtual loan advisors, guiding borrowers step-by-step. Borrowers may ask questions about specific sections, such as required documentation or interest rate calculations, and receive clear, conversational responses. Simultaneously, AI can validate input for accuracy and completeness, minimizing delays caused by errors or omissions. Likewise, in the reviewing step 536 the process 500 may benefit from AI-driven risk assessment tools, which can evaluate creditworthiness by analyzing factors like credit scores, financial histories, and employment data. These tools can also detect potential fraud or inconsistencies in borrower applications. LLMs can complement this by summarizing borrower profiles and generating recommendations for underwriters, combining the speed and accuracy of automation with the oversight required for complex cases. Additionally, fraud detection can be enhanced by pairing AI's pattern recognition capabilities with LLMs' ability to process unstructured data, such as documents uploaded by borrowers. This dual-layered approach can ensure thorough verification without compromising efficiency.

In further embodiments, such as in the finalizing step 548, AI and LLMs can help to streamline document review and quality control checks. AI can verify critical variables, such as interest rates and payment schedules, while LLMs can identify inconsistencies and summarize the loan terms for lender representatives. Borrowers can interact with LLM-powered chatbots to resolve last-minute questions, ensuring a smooth transition to final approval. Throughout the entire process, AI and LLMs can manage borrower communications with precision and personalization. For example, in cases where an offer expires or an application is declined, LLMs can generate tailored notifications explaining the outcome and providing actionable next steps. Updates and reminders can also be delivered in natural, conversational language, fostering borrower engagement and trust.

The use of AI with reinforcement learning can further optimize and in some embodiments self-optimize the process over time by analyzing borrower interactions and loan outcomes. AI can dynamically adjust thresholds or criteria for approvals based on historical data, improving decision-making accuracy. LLMs can assist by generating insights for lender representatives, highlighting trends in borrower behavior and identifying opportunities for process refinement. Moreover, the scalability and accessibility of AI and LLMs can allow the system to handle high volumes of borrowers across diverse demographics. Multilingual capabilities can enable personalized interactions in borrowers' preferred languages or dialects, broadening the system's reach and inclusivity.

Although a specific embodiment for a process by which potential borrowers and representatives of the lender interact by way of the personal loan-originating system suitable for carrying out the various steps, processes, methods, and operations described herein is discussed with respect to FIG. 5, any of a variety of systems and/or processes may be utilized in accordance with embodiments of the disclosure. For example, the process 500 may have one or more steps added or consolidated as needed. In some embodiments, one or more steps may be outsourced to a third-party. Those skilled in the art will also recognize that the system presented in FIG. 5 is simplified for illustration purposes. The elements depicted in FIG. 5 may also be interchangeable with other elements of FIGS. 1-4 and 6-20 as required to realize a particularly desired embodiment.

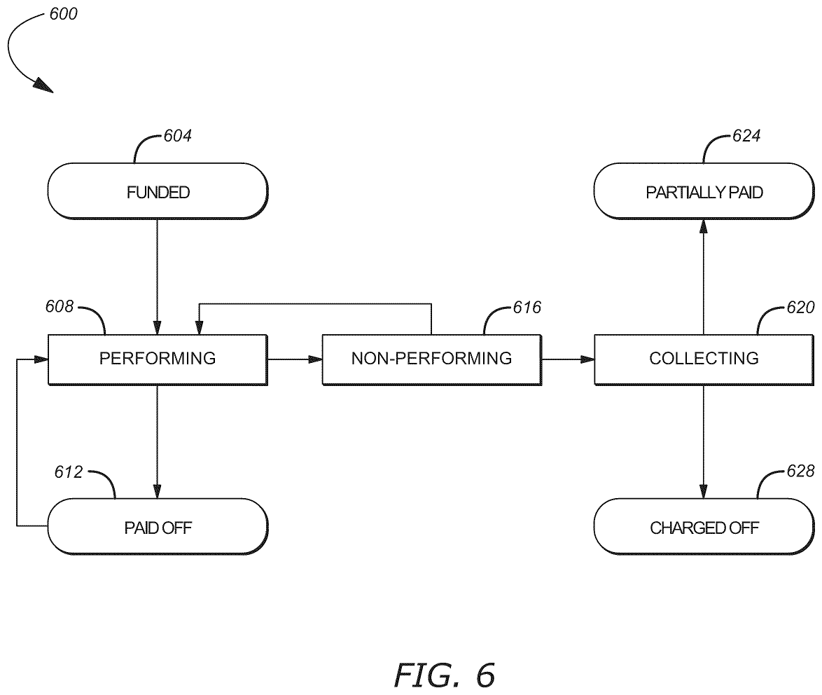

Referring to FIG. 6, a schematic illustrating a process 600 by which debtors and representatives of the creditor interact by way of the personal loan-servicing system 2500 in accordance with various embodiments of the disclosure is shown. The process 600 can generally illustrate how a personal loan may be successfully paid off. In many embodiments, the process 600 can begin at a funded state 604 and progresses to performing step 608 wherein a loan application is converted into a loan. In further embodiments, when the borrower pays off the load, the process 600 can moves to a paid-off state at step 612. However, if there is a payment reversal or non-sufficient funds, the process 600 can move back to the performing step 608. If the borrower's payment is late, the process 600 may move to a non-performing step 616. When the borrower pays, however, the process 600 may move back to the performing step 608.

In some instances, the borrower may fail to make any payments and accrue gross delinquencies. In such cases, the process 600 may move from step 616 to a collecting step 620 wherein a collections process is initiated. If the collections process results in a partially recovered payment, the process 600 may advance to a partially paid state 624. If the payment is unrecoverable, however, the process may move to a charged off state 628.

In many embodiments, artificial intelligence (AI) and large language model (LLM) systems can be leveraged in the process 600 to enhance the personal loan-servicing system. These technologies can improve efficiency, automate repetitive tasks, and provide personalized interactions throughout the servicing lifecycle, from loan funding to potential collection activities. At the funded step 604, AI and LLMs can be configured to monitor borrower payment behavior and generate predictive models for identifying borrowers who may encounter financial difficulties. By analyzing historical payment data, credit scores, and spending patterns, AI can provide early warning signals for accounts that may transition to non-performing. LLMs can also serve as proactive communication tools, generating personalized messages to remind borrowers of upcoming payments or offer assistance programs to mitigate risks of delinquency.

When a loan is in the performing step 608, AI can assist in monitoring payments and detecting anomalies such as payment reversals or insufficient funds. This detection can trigger automated workflows to notify borrowers and suggest corrective actions, such as scheduling a repayment or linking alternative payment methods. LLMs can be integrated into these workflows to provide borrowers with clear, conversational explanations of payment issues and offer guidance on resolving them. Such systems can also reduce borrower anxiety by offering real-time or near real-time support and tailored solutions.

In cases where a loan transitions to the non-performing state, AI can be employed to assess the severity of the delinquency and recommend appropriate next steps. Machine learning models can analyze borrower profiles and past recovery data to suggest tailored collection strategies. LLMs, meanwhile, can interact with borrowers in a supportive and empathetic manner, presenting repayment options or negotiating payment plans. By humanizing the collections process, these systems can increase borrower engagement and improve recovery outcomes.

If the loan progresses to the collections step 620, AI can prioritize accounts based on recovery likelihood and assign them to the appropriate collections pathways. This prioritization can ensure that resources are allocated efficiently, focusing on accounts with the highest potential for recovery. LLMs can facilitate automated yet personalized communications with borrowers, such as offering settlement options or addressing concerns about their outstanding balance. For partially recovered accounts, AI systems can analyze payment histories and dynamically adjust recovery strategies, while LLMs can continue to provide clear explanations and support. In scenarios where payment is deemed unrecoverable and the loan is charged off, AI can generate comprehensive reports summarizing the account's history, recovery attempts, and reasons for charge-off. These reports can be used to inform internal decision-making and compliance processes. LLMs can assist by drafting notifications to borrowers about the charge-off status and any remaining obligations, ensuring the communication is clear and legally compliant.

Although a specific embodiment for a process by which debtors and representatives of the creditor interact by way of the personal loan-servicing system suitable for carrying out the various steps, processes, methods, and operations described herein is discussed with respect to FIG. 6, any of a variety of systems and/or processes may be utilized in accordance with embodiments of the disclosure. For example, the process 600 may have one or more steps added or consolidated as needed. In some embodiments, one or more steps may be outsourced to a third-party. Those skilled in the art will also recognize that the system presented in FIG. 6 is simplified for illustration purposes. The elements depicted in FIG. 6 may also be interchangeable with other elements of FIGS. 1-5 and 7-20 as required to realize a particularly desired embodiment.

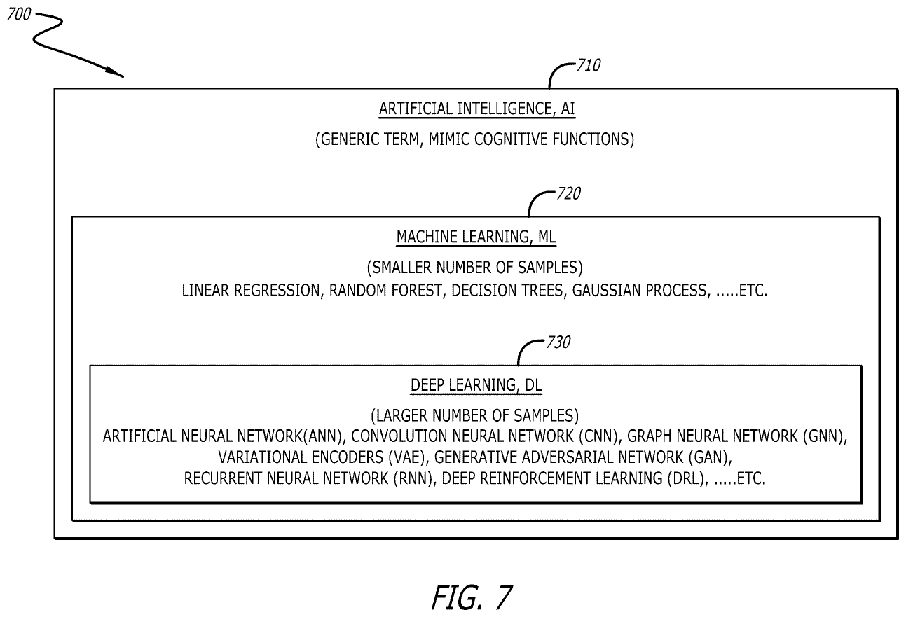

Referring to FIG. 7, a diagram 700 depicting various subsets of artificial intelligence in accordance with various embodiments of the disclosure is shown. Artificial intelligence (AI) 710 is typically understood in the art to be the development of machines and algorithms that mimic human intelligence, for example, by optimizing actions to achieve certain goals. At its core, AI 710 often involves designing algorithms and models that mimic cognitive functions, such as learning, reasoning, problem-solving, perception, and even language understanding. Unlike traditional computer programs that follow a fixed set of instructions, AI systems have the ability to adapt, improve, and make decisions based on input data and environmental interactions.

AI 710 can be considered a generic term because it encompasses a wide range of subfields and techniques, from simple rule-based systems to advanced machine learning and deep learning models. These AI techniques are used to simulate various aspects of human cognition. For example, machine learning (ML) 720 allows computers to learn from data patterns without explicit programming for each task, while natural language processing (NLP) enables machines to understand and generate human language. Deep learning (DL) 730, a more advanced branch of AI, uses neural networks to automatically learn complex patterns from large datasets, akin to the human brain's information processing. This versatility makes AI a powerful tool across diverse applications, including image recognition, autonomous driving, voice assistants, healthcare diagnostics, and materials discovery.

A goal of AI is often to create systems that can function autonomously and intelligently in real-world scenarios. As AI 710 continues to evolve, it can increasingly mirror human-like cognition, enabling machines to not just process data but to “think” in a way that can handle uncertainty, make predictions, and even interact with their surroundings in a meaningful manner. While AI systems are far from achieving the full breadth of human intelligence, their ability to replicate specific cognitive functions makes them invaluable in tackling complex, data-driven challenges.

Machine Learning (ML) 720 is a subset of Artificial Intelligence (AI) 710 that focuses on the development of algorithms and statistical models that enable computers to learn and make decisions from data without explicit programming. In traditional programming, a computer is given a fixed set of rules to follow, but ML 720 can shift this paradigm by allowing systems to identify patterns, adapt, and improve their performance based on the data they encounter. This data-driven approach makes ML particularly valuable for tasks that are too complex or dynamic to define using straightforward rules, such as, for example, recognizing images, predicting consumer behavior, or diagnosing diseases. In various embodiments described herein, machine-learning methods may be utilized to automate or create efficiencies within various aspects of the loan process.

ML models can be configured to analyze large amounts of data to identify trends and relationships that inform their predictions or classifications. The process typically involves three stages: training, validation, and testing. During training, the model learns from a dataset by adjusting its internal parameters to minimize errors between its predictions and the actual results. Techniques like linear regression, decision trees, random forests, and Gaussian processes are commonly used in ML 720. These algorithms can handle various data types, including numerical, categorical, and structured datasets like spreadsheets or grids. One of the key strengths of ML is its ability to generalize from the training data to make accurate predictions on new, unseen data. In a number of embodiments described herein, training data may be generated from customer data, environmental data, scraped data, compliance data, scoring data, reporting data, and the like.

However, traditional ML methods rely heavily on feature engineering, wherein human experts manually identify the most relevant features or patterns within the data. For example, when using ML 720 for image recognition, an expert might need to extract features like edges, textures, or color patterns before feeding them into a model. This requirement can limit the scalability of traditional ML approaches, especially when dealing with large, unstructured datasets such as images, text, or graphs. Additionally, ML algorithms may often work best when provided with relatively structured data, and they often need a reasonable amount of samples (typically more than 100) to learn effectively.

Deep Learning (DL) 730 is a specialized subset of Machine Learning (ML) 720 that employs multi-layered artificial neural networks to automatically learn complex patterns and representations from large, often unstructured datasets. Inspired by the way the human brain processes information, DL 730 consists of interconnected layers of “neurons” that can adaptively change as they are exposed to more data. Unlike traditional ML methods, which require manual feature engineering to identify key data characteristics, DL models can automatically extract features directly from raw data, such as images, text, or molecular structures. This automated feature extraction allows DL 730 to handle data types and tasks that were previously difficult or impossible for ML models to tackle effectively.

DL models, including Convolutional Neural Networks (CNNs), Graph Neural Networks (GNNs), and Recurrent Neural Networks (RNNs), excel at processing various forms of data. CNNs are particularly effective for image analysis, recognizing intricate patterns in visual inputs, making them indispensable in areas like materials science for analyzing microscopic images or detecting defects in materials. GNNs, on the other hand, are designed to work with graph-based data, such as molecular structures, social networks, or atomic interactions. They can learn the dependencies and relationships within graph-like structures, which is crucial for predicting properties of complex molecules and materials. RNNs and their variants, such as Long Short-Term Memory (LSTM) networks, are suited for sequential data like time series or natural language processing, allowing for the analysis and generation of textual information or the prediction of temporal patterns in scientific research.

One of the defining characteristics of deep learning is its requirement for large datasets (typically over 1100 samples for example) to effectively train neural networks. The deep, multi-layered structure of these networks enables them to capture highly complex and abstract representations of the data, but it also demands significant computational power. Techniques like Variational Autoencoders (VAEs) and Generative Adversarial Networks (GANs) add to the versatility of DL by enabling the generation of new data samples that resemble the training set, aiding in areas such as materials discovery and synthetic data creation. Deep Reinforcement Learning (DRL) combines neural networks with decision-making processes to solve problems that involve optimization and control, further expanding DL's application potential. In summary, DL's ability to automatically learn from raw, unstructured data and model intricate patterns makes it a powerful tool in AI, particularly for complex domains like image recognition, natural language processing, and materials science.

Artificial Neural networks (ANNs or sometimes just NNs) are often a foundation of a DL system. The basic unit of a neural network is typically the perceptron, which can take inputs, assigns weights to these inputs, and combines them to produce an output. The final output is then passed through an activation function (such as, for example, ReLU, sigmoid, or hyperbolic tangent) to introduce non-linearity, which enables the network to model complex patterns.

Neural networks are typically trained through a process of backpropagation, where the system's predictions are compared against the known output, and a loss function is used to measure the difference between the prediction and the actual result. The network's weights can be adjusted through a process called gradient descent, which can be configured to minimize the loss function over time. However, the training process can be prone to problems like overfitting (where the model performs well on the training data but poorly on new data). To counter this, techniques such as regularization (e.g., regularization, dropout), early stopping, and mini-batches can be utilized to prevent the network from becoming overly specialized to the training set.

CNNs are a specific type of ML 720 neural network designed to work particularly well with image data, making them highly relevant for as image data can be generated within a loan application and/or processing documents and thus be subject to processing. As those skilled in the art will recognize, CNNs typically use specialized layers known as convolutional layers, which apply filters (also known as kernels) to the input data. These filters slide over the input (e.g., an image), detecting patterns like edges or textures, which are then passed to the next layer for further processing. The advantage of CNNs is their ability to automatically learn and extract relevant features from raw data without the need for manual feature engineering. Furthermore, pooling layers (e.g., max-pooling or average pooling) are often added after convolutional layers to reduce the dimensionality of the data, helping to make the system more efficient while retaining the most important information. After several layers of convolutions and pooling, the CNN can output a prediction, such as classifying a document as completed, suspicious, or otherwise.

While CNNs are well-suited for grid-based data like images, many real-world problems in can involve non-grid data, such as financial scores, credit reports, reporting, etc. This type of data may better be represented as a graph, where nodes represent entities (e.g., assets) and edges represent relationships between them (e.g., owners, status, etc.). Thus, Graph Neural Networks (GNNs) can be utilized to operate on such graph-based data.

In GNNs, information is passed between nodes through edges in a process called message passing. This allows the network to capture dependencies and relationships within the graph structure. The key feature of GNNs is their ability to aggregate information from neighboring nodes, which is crucial in predicting properties that depend on the current/local structure, such as the behavior of an asset/liability or the properties of a loan applicant.

Generative models aim to learn the underlying distribution of a dataset and generate new samples that resemble the original data. Two common types of generative models are Variational Autoencoders (VAEs) and Generative Adversarial Networks (GANs). VAEs are often configured to work by encoding data into a lower-dimensional latent space and then decoding it back into its original form. This allows for the generation of new data by sampling points from the latent space. This can be utilized when attempting to determine the eligibility of a loan application or the like.

Similarly, GANs consist of two components: a generator that creates fake/generated data and a discriminator that tries to distinguish between real and fake data. The two components are trained in a competitive process where the generator tries to “fool” the discriminator, leading to increasingly realistic generated data. This type of process may be utilized to compare real loan applications to fraudulent loan applications for example.

Reinforcement Learning (RL) involves an agent learning to make decisions by interacting with an environment and receiving feedback (rewards or penalties) based on its actions. Deep Reinforcement Learning (DRL) combines RL with DL techniques, allowing agents to learn from high-dimensional inputs, such as images or complex camera simulations.

In loan processing, DRL can be used in scenarios where an optimal decision needs to be made, such as approving or denying a loan application or finding the best configuration for underwriting a loan based on the desired or current properties of the applicant(s) and/or market, etc. The combination of RL and DL can allow for learning from raw data, making it a powerful tool for dynamic and real-time decision-making within loan processing procedures.

Although a specific embodiment for a diagram 700 depicting various subsets of artificial intelligence suitable for carrying out the various steps, processes, methods, and operations described herein is discussed with respect to FIG. 7, any of a variety of systems and/or processes may be utilized in accordance with embodiments of the disclosure. For example, other subset may be present and available for use within AI 710. Those skilled in the art will recognize that the diagram 700 presented in FIG. 7 is simplified for illustration purposes and various methods and techniques may interact with other areas (ML 720 with DL 730, etc.). The elements depicted in FIG. 7 may also be interchangeable with other elements of FIGS. 1-6 and 8-20 as required to realize a particularly desired embodiment.

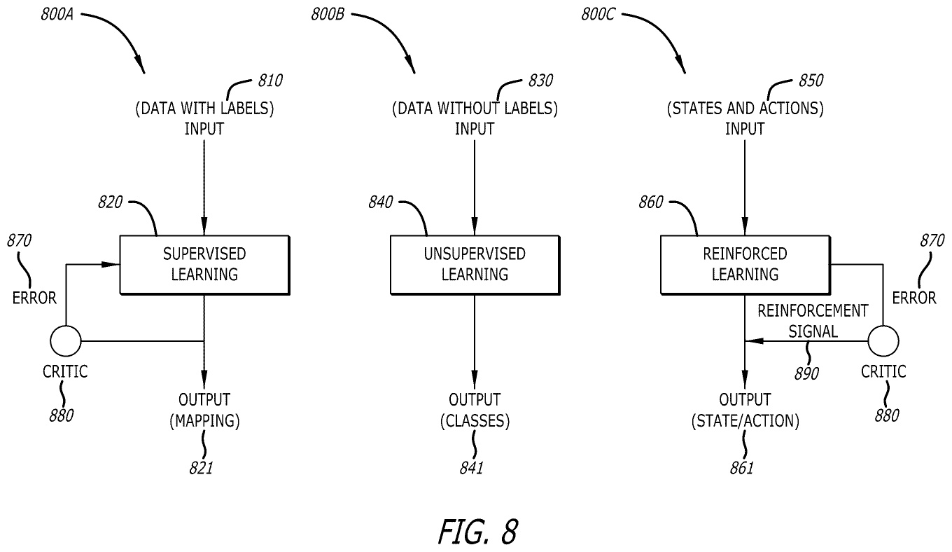

Referring to FIG. 8, different methods of machine-based learning in accordance with various embodiments of the disclosure are shown. In many embodiments, a machine learning model is defined as a mathematical representation of the output of the training process. A machine learning model is often considered similar to computer software designed to recognize patterns or behaviors based on previous experience or data. However, the learning algorithm can discover patterns within the training data, and output an ML model which can capture these patterns and make predictions on new data.

ML models can be understood as a device that has been trained to find patterns within new data and make predictions. These models can be represented as a complex mathematical function that would be impractical for a human to calculate that takes requests in the form of input data, makes predictions on input data, and then provides an output in response. First, these models can be trained over a set of data, and then they are provided an algorithm or other task to reason over data, extract the pattern from feed data and learn from that data. Once the model(s) is/are trained, they can be used to predict a new and previously unseen dataset.

There are various types of machine learning models available based on different business goals and data sets available. Often, based on the desired application, ML models can be configured as or settle into one of three different model types: supervised learning, unsupervised learning, and/or reinforcement learning. Supervised learning can further be broken down into two categories of classification and regression. Likewise, unsupervised learning can be divided into three categories: clustering, association rule, and/or dimensionality reduction.

In the embodiment depicted in FIG. 8, a supervised learning system 800A is shown. The supervised learning system 800A can be configured with a supervised learning model 820 that accepts input data 810 and generates an output 821. However, the output data is often reviewed by a critic 880 that can determine one or more errors 870 that are fed back into the supervised learning model 820 for use in updating.

Supervised learning systems 800A are often considered the simplest machine learning model to understand in which input data (such as training data) has a known label or result as an output. So, the supervised learning model 820 can be understood to work on the principle of input-output pairs. As such, a function can be trained using a training data set, which is then applied to unknown data and makes some predictive performance. Supervised learning is task-based and mostly tested on labeled data sets.

Supervised learning systems 800A may often involve one or more regression problems. In regression problems, the output is a continuous variable. Some commonly used Regression models include linear regression, decision trees, and random forests. Linear regression is typically the most straight forward machine learning model in which a prediction of one output variable is made using one or more input variables. The representation of linear regression can be processed as a linear equation, which combines a set of input values (denoted as x) and a predicted output (denoted as y) for the set of those input values. As those skilled in the art will recognize, this may be represented in the form of a line: Y=bx+c. A typical aim of a linear regression-based model can be to find the optimal fit line that best fits the available data points. Linear regression can be extended to multiple linear regressions (finding a plane of best fit in higher dimensional space) and polynomial regressions (finding the best fit curve).

Decision trees are also popular machine learning models that can be used for both regression and classification problems. A decision tree uses a tree-like structure of decisions along with their possible consequences and outcomes. In this, each internal node is used to represent a test on an attribute while each branch is used to represent the outcome of the test. The more nodes a decision tree has, the more accurate the result will be. This may be used when making decisions related to approving or denying a loan application, etc. The advantage of decision trees is that they are intuitive and easy to implement, but may lack accuracy depending on the available computational or time resources available.

Random forests are an ensemble learning method, which may consist of a large number of decision trees. For example, each decision tree in a random forest predicts an outcome, and the prediction with the majority of votes is considered as the outcome. A random forest model can be used for both regression and classification problems. For the classification task, the outcome of the random forest may be taken from the majority of votes. Whereas in the regression task, the outcome can be taken from the mean or average of the predictions generated by each tree.

Classification models are another type of supervised learning, which can be used to generate conclusions from observed values in one or more categorical forms. For example, a classification model can identify if an email is spam or not; whether a submission if potentially fraudulent/incorrect or not, etc. Classification algorithms can also be used to predict between two or more classes and/or categorize an output into different groups. For these classification systems, a classifier model can be designed that classifies the dataset into different categories, and each category can subsequently be assigned a label. As those skilled in the art will recognize, there are currently two main types of classifications in machine learning: binary and multi-class. Binary classification can be utilized when there are only two possible classes (i.e., yes/no, dog/cat, etc.). Multi-class classification can be utilized when there are more than two possible classes, thus requiring a multi-class classifier.

One of the potential classification processes is logistic regression. Logistic regression can be used to solve various classification problems in machine learning systems. These processes are similar to linear regression but are often used to predict categorical variables. While some variations can be configured to generate a prediction as an output in either “yes” or “no”, 0 or 1, “true” or “false”, etc. However, in some embodiments, the system can instead be configured to not give exact values, but instead provide probabilistic values between zero and one, etc.

Another classification process that can be utilized is a support vector machine (SVM) which is widely used for classification and regression tasks. However, the main aim of SVM is to find the best decision boundaries in an N-dimensional space, which can be utilized to segregate data points into classes, and generate a best decision boundary often known as a hyperplane. SVM processes can select the extreme vector to find a hyperplane, wherein these vectors are known as support vectors.

Naïve Bayes is another popular classification algorithm used in machine learning. This process receives its name as it is based on Bayes theorem and follows the naïve(independent) assumption between the features which is often given as the formula:

$$P ( y \vert X ) = \frac{P ( X \vert y ) * P ( y )}{P ( X )}$$

This formula takes a class or target y and a predictor attribute (X) and calculates a posterior probability P(y|X) of that class given a particular predictor. P(y) is the prior probability of that class, P(X) is the prior probability of the predictor, and P(X|y) is the likelihood or probability of the predictor given the class. As those skilled in the art will recognize, this may be more succinctly understood as the posterior chance being a result of the prior results times the likelihood divided by the evidence available. Each naïve Bayes classifier assumes that the value of a specific variable is independent of any other variable/feature. For example, if a fruit needs to be classified based on color, shape, and taste. So yellow, oval, and sweet will be recognized as mango. Here each feature is independent of other features. Likewise, various embodiments herein can classify based on documents presented, market conditions, internal scoring, etc.

Again, in the embodiment depicted in FIG. 8, an unsupervised learning system 800B is shown. The unsupervised learning system 800B can be configured with an unsupervised learning model 840 that accepts input data 830 and generates an output 841. Unlike other model types, there are no critics or error signals to process. Unsupervised learning models 840 can implement the learning process opposite to supervised learning, which means it enables the model to learn from an unlabeled training dataset. Based on the unlabeled dataset, the unsupervised learning model 840 can predict the output. Using an unsupervised learning system 800B, the unsupervised learning model 840 can learn hidden patterns from the dataset by itself without any supervision. In various embodiments, unsupervised learning models 840 are often utilized to perform tasks involving clustering, association rule learning, and/or dimensional reduction.

Clustering is an unsupervised learning technique that involves clustering or grouping the available data points into different clusters based on similarities and/or differences. The objects or data points with the most similarities remain in the same group, and they have no or very few similarities from other groups. Clustering algorithms can be used in a variety of different tasks such as, but not limited to image segmentation, statistical data analysis, market segmentation, and the like. Some commonly used clustering algorithms that can be selected include K-means Clustering, hierarchal Clustering, DBSCAN, etc.

Association rule learning is an unsupervised learning technique which finds unique relations among variables within a large data set. In many embodiments, a primary aim of this type of learning algorithm is to find the dependency of one data item on another data item and map those variables accordingly so that it can satisfy some desired outcome. For example, in certain embodiments, an association rule system may be utilized to approve or deny a loan application. This algorithm can be applied in market basket analysis, web usage mining, continuous production, etc. However, those skilled in the art will recognize that other scenarios may be available based on the desired application. Some popular algorithms of association rule learning are Apriori Algorithm, Eclat, and FP-growth algorithm.

In additional embodiments, the number of features/variables present in a dataset can be understood as the dimensionality of the dataset, and the technique used to reduce the dimensionality is known as a dimensionality reduction technique. Although more data provides more accurate results, it can also affect the performance of the model/algorithm, such as yielding overfitting outcomes, etc. In such cases, dimensionality reduction techniques can be utilized. It is often desired that this process involves converting the higher dimensions dataset into lesser dimensions dataset while also ensuring that the ensuing results provide similar information. Different dimensionality reduction methods can be utilized, such as, but not limited to, PCA (Principal Component Analysis), Singular Value Decomposition (SVD), etc.

Finally, in the embodiment depicted in FIG. 8, a reinforcement learning system 800C is shown. The reinforcement learning system 800C can be configured with a reinforcement learning model 860 that accepts input data 850 and generates an output 861. In reinforcement learning, the reinforcement learning model 860 learns actions for a given set of states that lead to a goal state. In the embodiment depicted in FIG. 8, a critic 880 can receive or otherwise notice an error 870 within the reinforcement learning model 860 actions, and adjust the outcome/output such that the “reward” or “punishment” is adjusted to better model the future behaviors or processing of the reinforcement learning model 860.

It is a feedback-based learning model that can takes feedback signals after each state or action by interacting with the environment. This feedback works as a reward (positive for each good action and negative for each bad action), and the agent's goal is to maximize the positive rewards to improve their performance. The behavior of the model in reinforcement learning is similar to human learning, as humans learn things by experiences as feedback and interact with the environment. Popular methods of reinforcement learning including q-learning, state-action-reward-state-action (SARSA), and deep Q network.

Q-learning is one of the popular model-free algorithms of reinforcement learning, which is based on the Bellman equation. It often aims to learn the policy that can help the AI agent to take the best action for maximizing the reward under a specific circumstance. It can incorporate Q values for each state-action pair that indicate the reward to following a given state path, and it tries to maximize that Q-value.

SARSA is an on-policy algorithm based on the Markov decision process. In many embodiments, it can use the action performed by the current policy to learn the Q-value. The SARSA algorithm stands for State Action Reward State Action, which symbolizes the tuple (s, a, r, s′, a′). Finally, deep Q neural networking (or DQN) is Q-learning within a neural network. It can be deployed within a big state space environment where defining a Q-table would be a complex task. So, in these embodiments, rather than using a Q-table, the neural network instead utilizes Q-values for each action based on the state.

Although a specific embodiment for different methods of machine-based learning suitable for carrying out the various steps, processes, methods, and operations described herein is discussed with respect to FIG. 8, any of a variety of systems and/or processes may be utilized in accordance with embodiments of the disclosure. For example, those skilled in the art will recognize that methods of learning described herein are generalized and may incorporate other types developed as well as a combination of one or more methods based on the goals of the desired application. The elements depicted in FIG. 8 may also be interchangeable with other elements of FIGS. 1-7 and 9-20 as required to realize a particularly desired embodiment.

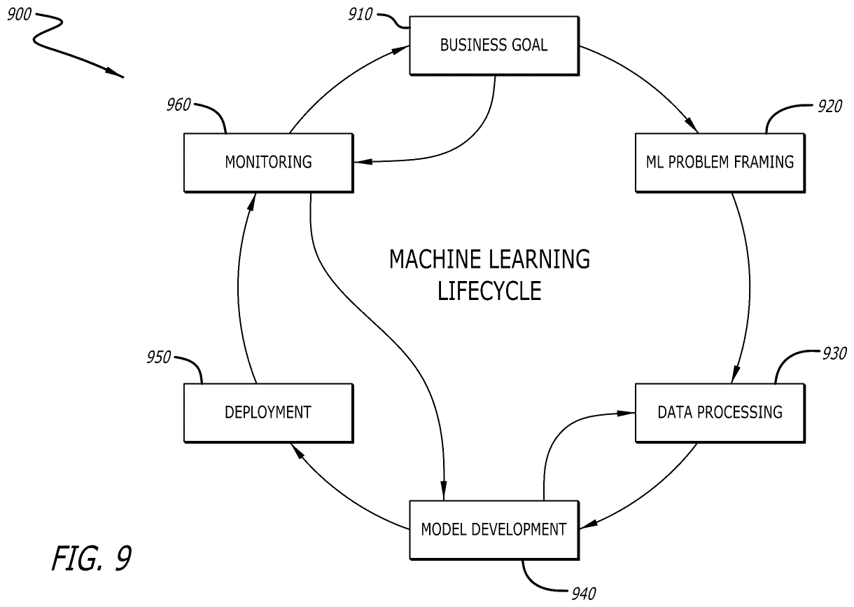

Referring to FIG. 9, a machine learning lifecycle 900 in accordance with various embodiments of the disclosure is shown. During the development of machine learning systems, the embodiment depicted in FIG. 9 can provide a framework for how to structure the design and maintenance of these systems. This machine learning lifecycle 900 outlines various stages involved in building, deploying, and improving ML models to solve real-world problems. By following this structured process, businesses and organizations can ensure that their machine learning projects align with strategic goals, use data effectively, and adapt to changing conditions over time. This machine learning lifecycle 900 emphasizes that developing a machine learning model is not a one-time effort but an iterative process requiring ongoing monitoring and adjustment. The feedback loop inherent in the machine learning lifecycle 900 allows for continual refinement and optimization of models to maintain their accuracy and relevance.

In many embodiments, a first stage of the machine learning lifecycle 900 is identifying the business goal 910, which sets the overall direction and purpose of the ML project. This can involve understanding the specific problems or opportunities within the business or project that machine learning can address. A clear business goal 910 ensures that the project remains focused on delivering tangible value, whether it is making the loan process more efficient, reducing fraud, etc. Without a well-defined goal, it can be challenging to align the subsequent stages of the ML lifecycle 900, as the choice of model, data processing methods, and performance metrics can all depend on what the business aims to achieve.

Establishing a proper business goal 910 can also involve engaging with key stakeholders and developers to gather requirements and set success criteria. It can provide a roadmap that outlines what success looks like and helps in framing the ML problem. For example, if the goal is to create loan efficiencies, the project might focus on building a predictive model that proactively identifies next steps and generates messages and paperwork for the relevant parties. Clearly defined goals not only help guide the project but also provide benchmarks for evaluating the effectiveness of the deployed model once it enters production.

Once the business goal 910 is established, various embodiments take a next step involving ML problem framing 920, wherein the goal is translated into a specific machine learning task. This can involve selecting the appropriate type of ML problem, such as classification, regression, clustering, or recommendation, and defining the target variables or outputs. For example, if the goal is to identify processor bottlenecks, the problem can be framed as a binary classification task where the model predicts whether an application can be approved or denied, etc. Proper problem framing can be important as it determines the particular data requirements, choice of model, and evaluation metrics.

During this stage, it is also prudent to consider the constraints and assumptions that may affect the model's development. This might include data availability, computational resources, ethical considerations, or regulatory compliance. Properly framing the problem ensures that the model development aligns with the business's needs and that the problem is broken down into manageable steps, ultimately increasing the project's chances of success.

Data processing 930 is a step in many embodiments where raw data is collected, cleaned, and transformed into a format suitable for machine learning. This step can involve gathering data from various sources, removing errors or inconsistencies, handling missing values, and normalizing or scaling features to ensure that the model can learn effectively. Feature engineering is often a part of this stage, where new features are derived from the raw data to capture more relevant information and improve model performance.

The quality and preparation of the utilized data can significantly impact the model's accuracy and reliability. Inadequate or poorly processed data can lead to biased or inaccurate predictions, no matter how advanced the model is. Hence, data processing 930 can require or at least benefit from careful planning and iterative refinement. Once the data is processed, it is typically split into training, validation, and test sets to develop and evaluate the model, ensuring that it generalizes well to new, unseen data.

Model development 940 is a phase in a number of embodiments where machine learning algorithms are selected, trained, and refined to create a model that addresses the framed problem. This stage can involve choosing the appropriate algorithm (e.g., decision trees, neural networks, support vector machines), setting up the model's architecture, and defining hyperparameters that will guide the training process. The model is trained on the processed data to identify patterns and relationships that allow it to make predictions or decisions.

During model development 940, the model can be evaluated using the validation dataset to fine-tune its parameters and improve performance. Techniques like cross-validation, regularization, and hyperparameter tuning can be used to prevent overfitting and ensure the model generalizes well. If proper steps are taken, the result is a model that, once it meets predefined performance metrics, is ready for deployment in a real-world environment. However, this process often involves several iterations to optimize the model for the specific business goal, indicated by the arrow back to data processing 930.

In further embodiments, deployment 950 is the stage where the developed model is integrated into the production environment to perform its intended tasks. This phase may involve setting up the necessary infrastructure, such as APIs or cloud-based services, to allow the model(s) to process live data and generate predictions. Deployment 950 can transform the model from a research tool into a functional component of a business process or product, providing real-time insights, automations, or decisions.

Proper deployment 950 can also include setting up mechanisms for logging, error handling, and user access. Since real-world environments are often dynamic and differ from training conditions, deployment may require continuous adaptation and updates to ensure the model(s) operates efficiently. This step can be important because a model's success is not only determined by its performance metrics but also by its ability to provide actionable results that align with the business goal 910.

In more embodiments, monitoring 960 is the ongoing process of tracking the model's performance and behavior after deployment. It involves collecting data on the model's predictions, accuracy, latency, and error rates to detect issues such as concept drift, where changes in the underlying data patterns can degrade the model's accuracy. By continuously monitoring 960, teams can identify when the model's performance drops and requires retraining or adjustments to align with the evolving data.

Monitoring 960 can also encompass aspects like user feedback, security, and compliance, ensuring that the model remains effective, reliable, and ethical in its application. It may serve as the feedback loop in the lifecycle, where insights gained from monitoring feed back into the earlier stages, particularly data processing 930 and model development 940, to refine the model(s) as needed. This iterative process allows the machine learning system to adapt and maintain its alignment with the original business goal 910 over time.

Although a specific embodiment for a machine learning lifecycle 900 suitable for carrying out the various steps, processes, methods, and operations described herein is discussed with respect to FIG. 9, any of a variety of systems and/or processes may be utilized in accordance with embodiments of the disclosure. For example, the particular route of development of the model(s) may not follow this cycle completely. As those skilled in the art will recognize, there are a variety of ways to develop AI products that include various iterative steps that aide in development and refinement of different model(s). The elements depicted in FIG. 9 may also be interchangeable with other elements of FIGS. 1-8 and 10-20 as required to realize a particularly desired embodiment.

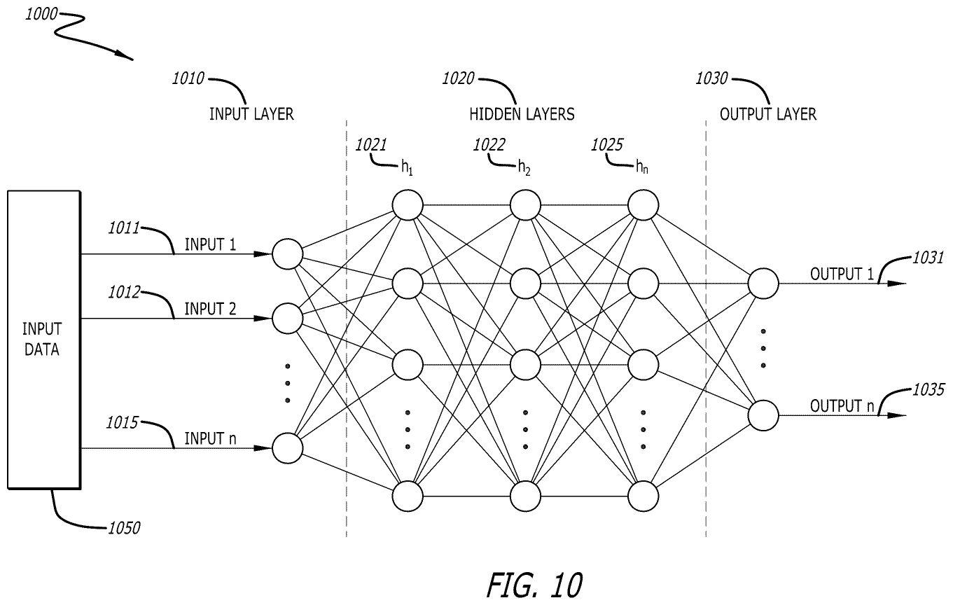

Referring to FIG. 10, an exemplary neural network 1000 in accordance with various embodiments of the disclosure is shown. The embodiment depicted specifically depicts a feedforward neural network with multiple layers. This type of network consists of an input layer 1010, one or more hidden layers 1020, and an output layer 1030. Each layer contains nodes (or neurons) that are interconnected, representing how data flows through the network. The input layer 1010 can receive raw data, which is then processed by the hidden layers 1020 through weighted connections and activation functions. These hidden layers 1020 can enable the network to learn complex patterns and relationships within the data.

The final output layer 1030 produces the network's predictions or classifications based on the processed input. The interconnected nature of the nodes allows the neural network 1000 to learn from data during training by adjusting the weights of connections to minimize prediction errors. This structure is the foundation of deep learning models, as adding more hidden layers 1020 can create a deep neural network, capable of tackling highly complex tasks such as image recognition, natural language processing, and pattern detection in large datasets.

A perceptron or a single artificial neuron is the building block of artificial neural networks (ANNs) and can perform forward propagation of information. For a set of inputs to the perceptron, weights (and biases to shift weights) can be assigned. These inputs and weights can be multiplied out correspondingly together to get a sum output. Those skilled in the art will recognize tools such as, but not limited to, PyTorch, Tensorflow, and MXNet as training packages for common neural network tasks. However, it is contemplated that other tools may be developed specifically for the neural network tasks related to the embodiments described herein.

In additional embodiments, the weight matrices of a neural network can be initialized randomly or obtained from a pre-trained model. These weight matrices can be multiplied with the input matrix (or output from a previous layer) and subjected to a nonlinear activation function to yield updated representations, which are often referred to as activations or feature maps. The loss function (also known as an objective function or empirical risk) can often be calculated by comparing the output of the neural network and the known target value data.

Feedforward networks, such as the neural network 1000 depicted in the embodiment of FIG. 10, are often configured as neural networks where information moves in one direction, from the input layer through the hidden layers to the output layer, without any cycles or loops. They are primarily used for tasks such as classification, regression, and simple pattern recognition, where each input is processed independently of others. In contrast, backpropagation is not a separate type of network but rather a training algorithm commonly used in both feedforward and other types of networks, like recurrent neural networks (RNNs).

Backpropagation involves adjusting the weights of the network in the reverse direction (from output to input) based on the error between the predicted output and the actual target during training. While feedforward describes the structure and data flow within the network, backpropagation is a technique used to optimize the model. Feedforward networks are ideal for straightforward tasks where input-output relationships are not sequential or time-dependent. However, for problems involving learning complex patterns over time, such as speech recognition or time-series analysis, networks that leverage backpropagation for training, like RNNs or deep feedforward networks with many hidden layers, become necessary to capture these intricate dependencies.

Typically, in these network arrangements, the weights are iteratively updated via various methods including, but not limited to, stochastic gradient descent algorithms in order to help minimize the loss function until the desired accuracy is achieved. Most modern deep learning frameworks can facilitate this by using reverse-mode automatic differentiation to obtain the partial derivatives of the loss function with respect to each network parameter through recursive application of the chain rule. Colloquially, this is also known as back-propagation. Common gradient descent algorithms can include, but are not limited to, Stochastic Gradient Descent (SGD), Adam, Adagrad etc. The learning rate is an important parameter in gradient descent. Except for SGD, all other methods use adaptive learning parameter tuning. Depending on the objective such as classification or regression, different loss functions such as Binary Cross Entropy (BCE), Negative Log Likelihood Loss (NLLL) or Mean Squared Error (MSE) can be used.

Neural network architecture is commonly used for a wide range of tasks in fields such as computer vision, natural language processing, financial forecasting, and materials science. For instance, it can be employed to recognize patterns in images, such as identifying objects or faces, or to classify text into categories, like spam detection in emails. It is also useful in regression problems, such as predicting stock prices or energy consumption, where input features can be processed to output continuous values. However, this is a general example of an artificial intelligence (AI) model, illustrating how a feedforward neural network works. Depending on the problem, other methods and models may be more appropriate. For example, convolutional neural networks (CNNs) are often used for image processing tasks, while recurrent neural networks (RNNs) are suitable for sequential data like time series data or text. Additionally, simpler models like linear regression, decision trees, or support vector machines (SVMs) may be sufficient if the problem is less complex, or the dataset is relatively small. The embodiment depicted in FIG. 10 is presented as an exemplary ML solution that may be deployed within one or more methods or systems described herein.

In many embodiments, the input layer 1010 is the first layer in a neural network 1000 and serves as the initial point where raw data is introduced into the model. Each node (or neuron) in this layer represents an individual feature or variable from the dataset, allowing the network to receive and process various types of data, such as pixel values in an image, numerical features in a spreadsheet, or words in a text document. For instance, in image recognition tasks, the input layer can consist of nodes that correspond to the pixel values of the image, providing the network with the visual information needed to identify objects or patterns. The number of nodes in the input layer directly depends on the number of features present in the dataset. If there are one-hundred features in the data, the input layer will typically have one-hundred nodes, each conveying one piece of the information to the subsequent layers. In more embodiments, the inputs of the neural network 1000 are generally scaled i.e., normalized to have a zero mean and/or unit standard deviation. Scaling can also be applied to the input of hidden layers (using batch or layer normalization) to improve the stability of neural network 1000.

Unlike the hidden layers 1020 and output layers 1030, the input layer 1010 typically does not perform any computations or transformations on the data. Its primary function is often to pass the input data to the next layer in the network, the first hidden layer 1021. However, it is often desired that the data fed into this layer is preprocessed appropriately, such as being normalized or standardized, to ensure that the neural network can learn efficiently. Proper preprocessing, like scaling numerical values or encoding categorical variables, can help the network process data uniformly, facilitating more stable and faster convergence during training.

The input layer's design depends on the nature of the problem. For example, in natural language processing, the input layer may represent words encoded as numerical vectors, while in time-series analysis, each node might represent a data point in a sequence. While the input layer 1010 itself does not modify the data, it sets the stage for the neural network to extract complex patterns and relationships through the deeper layers. This flexibility in handling various types of input make the neural network 1000 a powerful tool for a diverse set of applications.

With respect to the embodiments described herein, the input layer may be configured with a plurality of inputs providing input data 1050, or other data sources. For example, a model can be configured with a first input 1011 configured as a first potential customer data, a second input 1012 is configured with a loan product being applied for, while additional inputs can be added related to the number of potential assets and/or liabilities in the system. The nth input 1015 can be configured in certain embodiments to include other scoring data. However, as those skilled in the art will recognize, additional setups can be configured such that the inputs can be configured to also include different parameters of the cameras, the number of assets or points of interest in the scene, the overall camera scores of previous analyses, among other input types, etc.

In a number of embodiments, the neural network 1000 comprises a plurality of hidden layers 1020. The embodiment depicted in FIG. 10 comprises a first hidden layer 1021, a second hidden layer 1022, and an nth hidden layer 1025, which are denoted as h₁, h₂, and hₙ respectively. In many embodiments, the hidden layers 1020 are where the core of the model's learning and pattern recognition occurs. In each hidden layer, individual neurons receive inputs from the previous layer, apply a set of weights, add a bias, and pass the result through an activation function (e.g., ReLU, leaky ReLU, sigmoid, hyperbolic tangent (tanh), Swish, etc.). This process can introduce non-linearity, allowing the network to capture complex patterns in the data that simple linear models cannot. The intricate web of connections among neurons across layers helps the network transform and process input features into representations that become progressively more abstract and useful for making predictions.

The first hidden layer 1021 h₁ receives direct input from the input layer, transforming the raw data into an initial set of features. For example, in an image recognition task, this layer might begin identifying basic patterns, such as edges or simple textures. The output of the first hidden layer 1021 is then passed to a second hidden layer 1022 h₂, which builds upon the features identified by the first hidden layer 1021. This deeper layer might start recognizing more complex patterns, such as shapes or specific object components, by combining the lower-level features identified earlier. This can continue on until a last, nth hidden layer 1025 hₙ continues this abstraction process, allowing the network to recognize even higher-level, more detailed features, such as identifying an entire object within an image or understanding intricate relationships in the input data.

Each hidden layer adds a level of complexity and abstraction to the network's learning capabilities. The multi-layer structure can enable the network to move from recognizing simple patterns in the first input layer 1010 to highly complex, abstract concepts in the deeper layers. The number of hidden layers and neurons within them can vary depending on the problem's complexity. More hidden layers generally allow the network to model more intricate functions, making deep neural networks especially effective for tasks like image recognition, natural language processing, and complex predictive modeling. However, adding more layers also increases the computational demand and the risk of overfitting, highlighting the need to carefully design and tune these hidden layers for optimal performance.

In various embodiments, the output layer 1030 is often the final layer in a neural network and is responsible for producing the network's predictions or classifications based on the information processed through the previous hidden layers 1020. Each neuron in the output layer 1030 can represent a specific outcome or category that the model can predict. In the embodiment depicted in FIG. 10, the outputs are labeled as “output 1” to “output n,” indicating that the network can be designed to have a varying number of outputs depending on the nature of the problem being solved for. For example, in a binary classification task (e.g., approve or deny a loan, etc.), there would typically be a single output neuron that provides a probability score for one of the two classes/outcomes. In contrast, for multi-class classification (e.g., the type of loan products that have been approved), the output layer would contain multiple neurons, each corresponding to a different class.

The number of neurons in the output layer 1030 can also designed specifically for other types of tasks, such as regression, where the model can predict continuous values. In such cases, the output layer 1030 might contain a single neuron representing a numerical prediction, such as the price of a house or the temperature forecast, etc. Alternatively, in complex applications like multi-label classification (where each input can belong to multiple classes simultaneously), the output layer 1030 could have multiple neurons, each representing a different class, with each neuron outputting a probability of the input belonging to that specific class.

The activation function used in the output layer can vary based on the desired output. For binary classification, a sigmoid function is commonly used to produce a probability between 0 and 1. For multi-class classifications, a SoftMax function can be applied to output a set of probabilities that sum to 1, indicating the most likely class. For regression problems, a linear activation function is often used to output a continuous range of values. The flexibility in designing the output layer allows the neural network 1000 to be applied to a wide variety of tasks, from simple binary decisions to complex multi-output predictions, making them a versatile tool in artificial intelligence and machine learning.

Although a specific embodiment for an exemplary neural network suitable for carrying out the various steps, processes, methods, and operations described herein is discussed with respect to FIG. 10, any of a variety of systems and/or processes may be utilized in accordance with embodiments of the disclosure. For example, real-world neural networks are often far more complex, featuring many more layers, nodes, and connections than the simplified structure shown in the embodiment depicted in FIG. 10, which is an illustrative example meant to make it easier to explain the basic concepts of neural networks and how they process information. The specific features and functions described herein are not intended to be limiting to this specific embodiment. Additionally, the elements depicted in FIG. 10 may also be interchangeable with other elements of FIGS. 1-9, and 11-20 as required to realize a particularly desired embodiment.

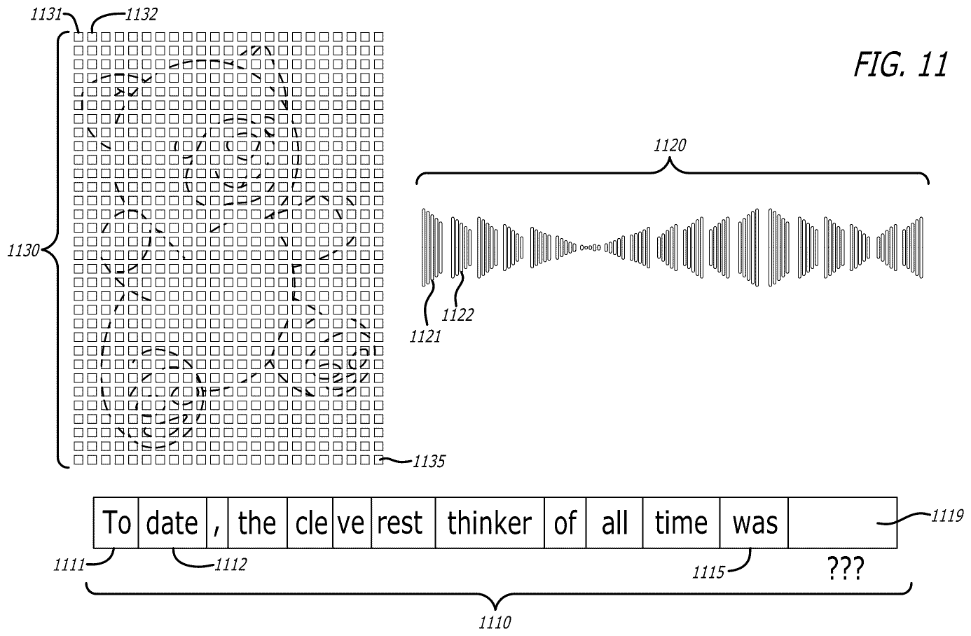

Referring to FIG. 11, a conceptual illustration of a variety of tokens for utilization within a large language model in accordance with various embodiments of the disclosure is shown. While most people are familiar with typing commands directly into a computer, interacting with a large language model (LLM) typically involves using prompts that are broken down into smaller units called tokens. These tokens can be segments of the original input prompt, such as individual words, subwords, or characters, allowing the model to process the prompt in manageable, structured pieces for a more nuanced understanding.

In fact, tokens are most often a fundamental unit of data used to represent a larger, general input for large language models (LLMs) and similar AI systems. In the context of LLMs, tokens are segments of text derived from the input prompt, where each token represents a manageable piece of the input, such as a word, part of a word, or a character. This segmentation can allow the model to break down complex text into simpler, consistent units that can be processed independently and then understood in relation to each other. By dividing input data into tokens, LLMs can handle language in a structured, flexible manner, adapting to diverse text inputs, from full sentences to specialized jargon or short phrases.

In many embodiments, tokens can serve as building blocks, enabling models to interpret language by analyzing these discrete parts and their relationships. For instance, in English, tokens often correspond to whole words, but when dealing with specialized vocabulary, slang, or languages with compound words, tokens might represent subwords or even single characters. This tokenization approach helps to maintain a balance between flexibility and precision, as smaller tokens allow the model to handle unfamiliar or highly specific terms more effectively. In a number of embodiments, each token can be encoded with a unique identifier that the model can use to differentiate it from others, preserving the distinct meaning or function it carries in context.

In the embodiment depicted in FIG. 11, a textual input prompt 1110 is shown as divided up into a plurality of tokens. A first token 1111 includes the word “To” while a second token comprises the next word “date”. In some embodiments, the first token 1111 can be configured to include the space between “To” and “date”. This small change can be utilized by the LLM to further divine meaning from the textual input prompt 1110. The number of tokens can vary depending on the type of input provided. This can extend from the first token 1111 to the nth or last token 1115 within the textual input prompt 1110. This last token 1115 can be utilized to indicate a requested or projected response 1119.

Beyond text, similar tokenization principles may apply to other data types when used in models that process audio or visual input. For audio data, tokenization can involve dividing a sound file into slices, where each token might represent a short segment of audio, perhaps a fraction of a second or a small, meaningful slice of a larger waveform. By breaking audio down in this way, the model can analyze specific sounds, pitches, or rhythms within the context of the entire recording. This segmentation enables the model to interpret audio inputs in a structured format, similar to how language is tokenized, making it easier to process complex auditory patterns and understand sounds in a sequential manner.

In the embodiment depicted in FIG. 11, the audio input prompt 1120 is shown divided into a plurality of audio slices. The first audio token 1121 comprises a number of samples within the audio input prompt 1120. Likewise, the second audio token 1122 comprises a second number of samples within the audio input prompt 1120. This slicing of the audio input prompt 1120 can continue throughout the rest of the remaining audio such that when all tokens have been processed, the system can determine a best guess for the next audio token that should be appended to the end of the audio input prompt 1120.

In the case of visual data, such as images, tokenization often involves segmenting the image into smaller chunks or patches, each of which becomes a visual token. These tokens represent different parts of the image, like color regions, edges, or textures, which the model can examine individually. Visual tokens enable the model to capture the intricate details within an image by focusing on manageable portions, while still considering their relationships to the broader visual structure. This approach allows AI systems to interpret complex images by analyzing these visual segments in the same way LLMs handle text tokens, offering a structured method for processing and understanding visual content.

In the embodiment depicted in FIG. 11, the image data prompt 1130 is divided into a plurality of smaller visual tokens. The first visual input token 1131 is shown as a small square portion of the original, larger image. This procedure of processing various chunks of the original image data prompt 1130 can occur on these smaller portions of the image, such as the second visual input token 1131, up to an including the nth visual input token 1139. Each of these smaller visual tokens can be processed individually, but often in parallel to each other.

The concept of tokens is therefore versatile, allowing diverse types of input, whether text, sound, or images, to be converted into standardized, model-friendly formats. Tokenization creates a consistent framework for representing complex data types in a way that artificial intelligence systems can process effectively. This segmentation enables each model, regardless of the input type, to dissect and examine different parts of the data with a fine level of granularity, which is especially important when working with highly detailed or nuanced inputs. This tokenized structure can enable the model to interpret the input systematically, providing a foundation for further processing and understanding of the information encapsulated within each token.

Although a specific embodiment for a variety of tokens for utilization within a large language model suitable for carrying out the various steps, processes, methods, and operations described herein is discussed with respect to FIG. 11, any of a variety of systems and/or processes may be utilized in accordance with embodiments of the disclosure. In many non-limiting examples, the type and number of tokens can vary depending on the specific application desired and/or the amount of available processing power available to handle the input prompt. The elements depicted in FIG. 11 may also be interchangeable with other elements of FIGS. 1-10 and 12-20 as required to realize a particularly desired embodiment.

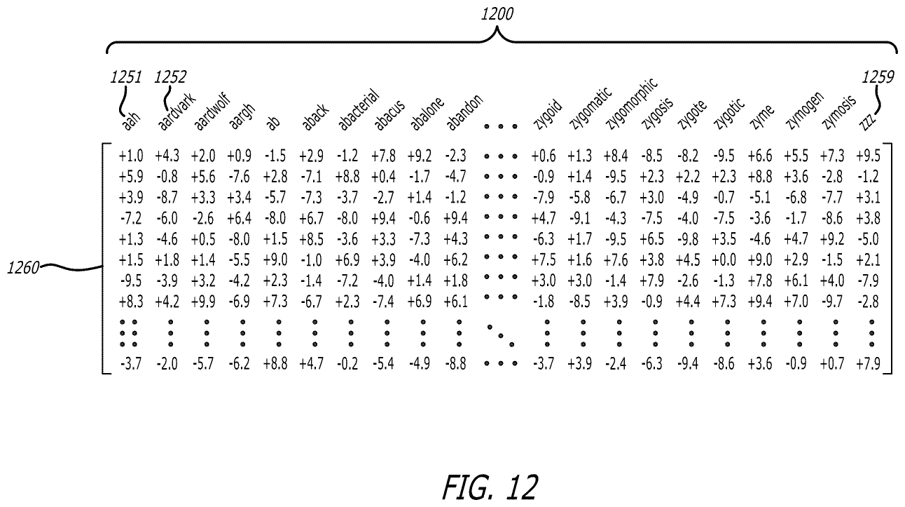

Referring to FIG. 12, a conceptual illustration of an embedding matrix 1200 for a large language model, in accordance with various embodiments of the disclosure is shown. In many embodiments of large language models (LLMs), embedding matrices are components that enable the model to interpret tokens in a mathematically accessible way. An embedding matrix 1200 is essentially a large table of vector representations, where each token in the model's vocabulary is assigned a unique vector, or array of numbers, that captures its initial meaning in relation to other tokens. When an input prompt is tokenized, each token can be matched with a corresponding entry in the embedding matrix 1200. In a number of embodiments, this lookup process can provide the token with an initial value, or embedding, which represents the token in a multi-dimensional space. These embeddings allow the model to recognize patterns, relationships, and meanings in language beyond simple string matching, forming the foundation for all further processing within the model.

In a number of embodiments, each entry in the embedding matrix 1200 is a vector of fixed size, with each dimension in the vector representing a distinct feature or aspect of the token's meaning. For example, words that are semantically or contextually similar may have embeddings that place them close to one another in this multi-dimensional space. This spatial relationship allows the model to capture a form of conceptual proximity wherein synonyms or related terms might occupy nearby areas in this space, while antonyms or unrelated words are farther apart. By assigning each token an embedding with specific values, the matrix can encode subtle linguistic and contextual information into numerical form, enabling the model to work with tokens in a highly structured, yet flexible, manner.

In the embodiment depicted in FIG. 12, the embedding matrix 1200 is associated with every known word in the English language. In other words, the matrix has a column associated with each of the around 110,000 or so words in English. Each column of the embedding matrix 1200 comprises a vector 1260 which associates the corresponding word to a location with a multi-dimensional space. For example, the first word 1251 “aah” has a corresponding vector 1260 from the first entry +1.0, to the nth entry −3.7. Likewise, the second word 1252 “aardvark” has another column of vector values associated with it starting at +4.3 and ending in −2.0. Finally, the nth word 1259 “zzz” is associated with a corresponding vector 1260 that includes the values in the column starting at +9.5 to +7.9. As each token is processed, it is assigned the corresponding vector 1260 taken from the embedding matrix 1200.

The embedding matrix 1200 is typically learned during the model's training phase. As the model is exposed to vast amounts of text, it iteratively adjusts the values in the embedding vectors to capture the relationships between tokens more accurately. Through this process, embeddings evolve to represent the associations, contexts, and distinctions that the model has observed across its training data. For instance, words that frequently appear together or in similar contexts may have embeddings that reflect this association. The embedding matrix 1200 thus serves as a kind of “knowledge base” for initial token relationships, giving the model a structured way to approach the vast variability in language.

This embedding approach is highly efficient because it enables the model to generalize across contexts and recognize similarities even with previously unseen tokens. For example, even if a token or phrase in a prompt has not been encountered during training, the model can infer its meaning based on the embeddings of other, similar tokens. This generalization is possible because embeddings capture both specific meanings and broader patterns, allowing the model to interpret novel inputs based on its learned understanding of language structure and relationships. By embedding tokens in a shared space, the model can gain a foundational understanding of language that it can apply across various prompts and contexts. This arrangement can allow the LLM to move beyond a rigid, word-by-word interpretation and instead engage with language as a rich network of interconnected meanings and ideas.

Although a specific embodiment for an embedding matrix for a large language model suitable for carrying out the various steps, processes, methods, and operations described herein is discussed with respect to FIG. 12, any of a variety of systems and/or processes may be utilized in accordance with embodiments of the disclosure. For example, similar concepts associated with the embedding matrix 1200 of FIG. 12 can be applied to other types of embedded matrices associated with other data types. It is contemplated that the embedding matrix is only limited by the types of input data that it is configured to process. The elements depicted in FIG. 12 may also be interchangeable with other elements of FIGS. 1-11 and FIGS. 13-20 as required to realize a particularly desired embodiment.

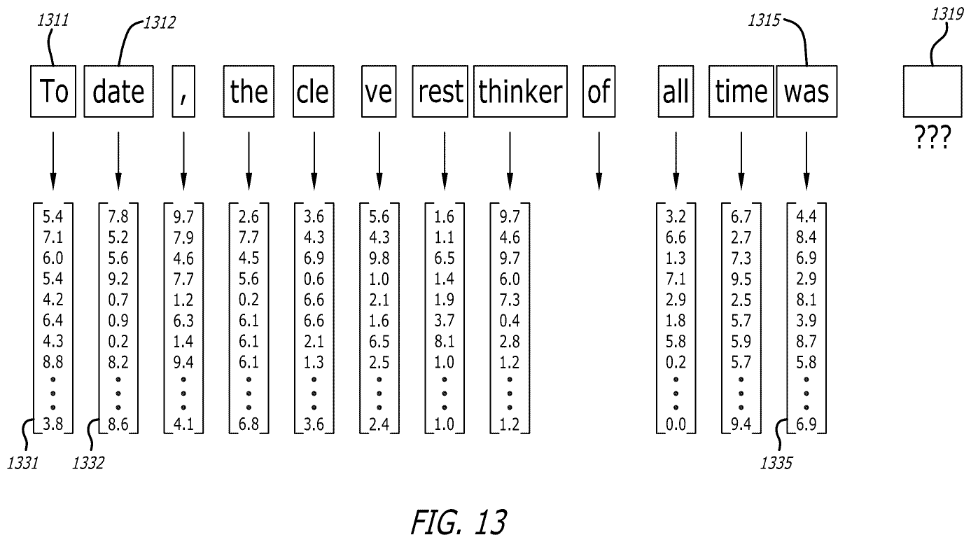

Referring to FIG. 13, a conceptual illustration of an input prompt converted from a series of tokens into a series of tensors in accordance with various embodiments of the disclosure is shown. In many embodiments, when an input prompt is converted into tokens, each of these tokens is then transformed through an embedding matrix to yield a unique vector representation, known as an embedding. This embedding is often a numerical array, or tensor, that encodes the token's position, context, and meaning within a multi-dimensional space. Essentially, once the tokenized prompt passes through the embedding matrix, each token is matched with a tensor that captures both its individual characteristics and its relationships to other tokens in the model's vocabulary. These tensors form the foundational representation of the prompt, providing structured data that the model can process to understand and generate contextually relevant responses.

Each tensor associated with a token after embedding can represent a fixed number of dimensions, often hundreds or even thousands, depending on the model's architecture. These dimensions give the tensor a rich structure, with each element in the tensor reflecting different features of the token's meaning. For instance, certain dimensions might encode aspects related to semantic similarity, part of speech, or contextual nuances observed during training. By encoding these complex features into a tensor, the model gains a detailed, flexible understanding of the token's role in the input prompt, which becomes critical for capturing context, sentiment, and intent in language processing tasks.

In various embodiments, the collection of tensors generated from the embedded tokens can create a high-dimensional representation of the entire prompt, with each tensor holding a unique set of values corresponding to its specific token. Because each tensor encodes information about a single token, the model can recognize patterns in the prompt by examining the relationships between these tensors. For example, words that often appear together may have similar values in certain dimensions of their tensors, allowing the model to capture implicit relationships and context within the input. This organized structure of tensors provides the model with a map of the prompt that it can analyze to make inferences about meaning, order, and emphasis.

In the embodiment depicted in FIG. 13, the first token 1311 is associated with the word “To” and has a corresponding tensor 1331 which is an array in multi-dimensional space. Likewise, the second token 1312 is associated with a second tensor 1332. Each token within the input prompt is subsequently associated with a corresponding tensor, up to the last and nth token 1315 which is associated with the nth tensor 1335. Processing these input prompt tokens will yield a projected or otherwise best fit for what the next token/word 1319 will be.

In further embodiments, the use of tensors can allow the model to handle complex language structures efficiently, as each token's tensor can interact with others in ways that reflect natural language dependencies. By representing each token as a tensor, the model can apply various mathematical operations across these tensors to analyze and synthesize information. These operations enable the model to determine which tokens are most relevant to one another within the context of the prompt. For instance, determining the vector difference between two related words like “man” and “woman” may be applied to a different context to determine similar words like applying that same vector difference to the vector associated with “uncle” to lead to the vector associated with the word “aunt”.

Although a specific embodiment for an input prompt converted from a series of tokens into a series of tensors suitable for carrying out the various steps, processes, methods, and operations described herein is discussed with respect to FIG. 13, any of a variety of systems and/or processes may be utilized in accordance with embodiments of the disclosure. For example, the number of elements within a tensor can number in the thousands, or even tens of thousands, depending on the complexity of the model. Additionally, in various embodiments, the position of the token within the input prompt can also be encoded within the tensor, which may be done by processing some additional value to the original tensor. The elements depicted in FIG. 13 may also be interchangeable with other elements of FIGS. 1-12 and FIGS. 14-20 as required to realize a particularly desired embodiment.

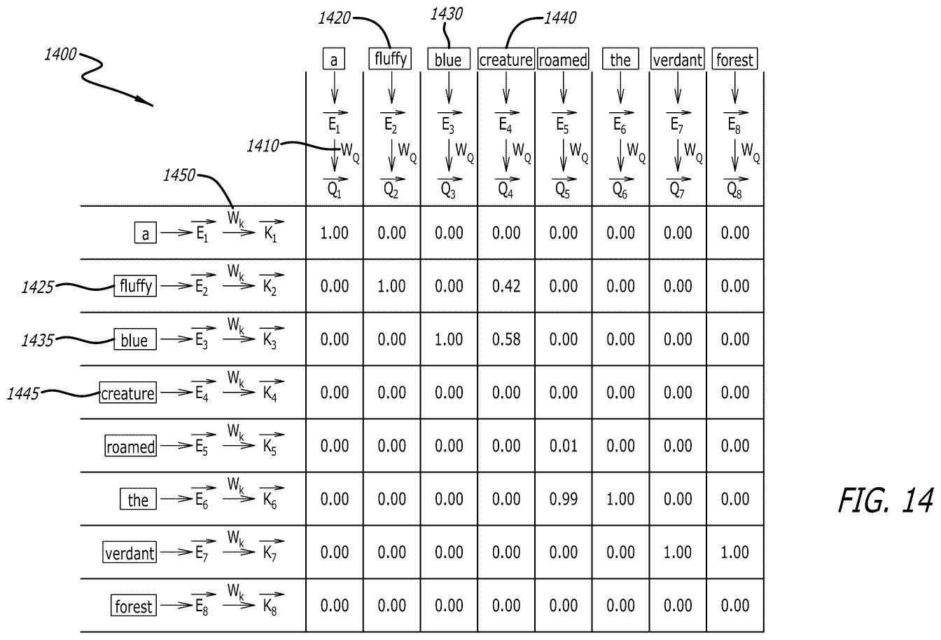

Referring to FIG. 14, a conceptual illustration of an attention layer process 1400 within a large language model in accordance with various embodiments of the disclosure is shown. When processing languages such as English, understanding the context of each word or token within an input prompt is beneficial. As such, many embodiments herein comprise at least one attention layer for processing the embedded tokens.

Take for example, the following three sentences: “I saw an American shrew mole,” “Measure one mole of carbon dioxide,” and “Take a biopsy of that mole”. Each of these sentences utilize the word “mole” in distinct contexts, demonstrating how language can carry multiple meanings based on surrounding words and phrases. In natural language processing, understanding these varied meanings requires the model to consider each token in relation to its neighbors, which is where attention layers become crucial. By focusing on the surrounding context of each instance of “mole,” an attention layer can discern whether it refers to an animal, a unit of chemical measurement, or a skin lesion. In many embodiments, the context, or set of nearby tokens, can allow the model to assign different meanings to “mole” depending on which other words are present, such as “American shrew” in the first case, “carbon dioxide” in the second, and “biopsy” in the third.

In a number of embodiments, attention layers can enable the model to weigh the relevance of each neighboring token to identify the specific meaning of “mole” in each phrase. For example, in “An American shrew mole,” the attention mechanism can emphasize the tokens “American” and “shrew,” which typically appear in contexts related to animals, thus guiding the model to interpret “mole” as a small mammal. Conversely, for the phrase “One mole of carbon dioxide,” however, the presence of “carbon dioxide” and the numerical term “one” shifts the focus toward scientific terminology, signaling that “mole” refers to a unit of chemical measurement. Similarly, in “Take a biopsy of that mole,” attention is drawn to the medical term “biopsy,” leading the model to interpret “mole” as a skin lesion. Through this mechanism, attention layers allow the model to dynamically adapt its understanding of words based on context, handling polysemous terms (words with multiple meanings) with greater accuracy.

In this way, attention layers can help the model “tease out” the correct meanings by selectively focusing on relevant tokens within the prompt. By assigning higher weights to contextually significant words, the model can make nuanced distinctions between different senses of the same token. This ability to disambiguate words based on context is essential for LLMs to generate accurate and meaningful responses, as it enables them to navigate the inherent complexity and flexibility of human language.

In literature, the generation of “attention” with these attention layers is described as:

$$Attention ( Q , K , V ) = softmax ( \frac{Q {K}^{T}}{\sqrt{{d}_{k}}} ) V$$

Wherein Q represents the query matrix which itself is a placeholder for the “query” vectors derived from each embedded token in the input sequence. When processing language, each token (or word) is associated with a specific query vector that encodes what that token is “looking for” in other tokens within the sequence. In many embodiments, these query vectors are produced by multiplying the token embeddings by a learned weight matrix specific to the queries. The query serves as a way for the model to actively seek out relevant information from other tokens, allowing it to identify connections or dependencies between different parts of the sequence. Thus, queries capture the intention or focus of each token as it interacts with the rest of the input.

K is associated with the key matrix consisting of “key” vectors, which are similarly derived from the input sequence. Each token has an associated key vector that represents the essential information it holds. While queries represent what each token is searching for, keys encode what each token offers in terms of information. Keys are generated by multiplying token embeddings with a learned weight matrix distinct from that used for queries. The relationship between queries and keys determines how strongly one token will attend to another, allowing the model to weigh the relevance of each token to each other token within the sequence.

The term QK^{T} therefore represents the dot product between the query and key matrices. This operation calculates the similarity (or relevance) between each query vector and each key vector, effectively measuring how much attention one token should give to another. The resulting score indicates how strongly each token should focus on every other token, capturing the relationships within the input sequence. This relevance score is fundamental to the attention mechanism, as it serves as the basis for distributing focus across the sequence.

Within the above equation, V stands for “value”, insomuch as a value matrix contains “value” vectors, which can represent the actual content information associated with each token. Unlike queries and keys, which often work to determine the relevance of tokens to each other, values contain the data the model will pass along through the attention layer. Value vectors are produced by multiplying token embeddings with a learned weight matrix specific to values. These value vectors carry the contextual information that the model will use when constructing output, ensuring that the information emphasized by the attention mechanism is carried forward in processing.

The division by \sqrt{dₖ} is a scaling factor where dₖ denotes the dimensionality of the query and key vectors. Without this scaling, the dot product values in QK^{T} could become large as the number of dimensions increases, which would push the SoftMax function towards extreme values, creating an unstable learning process. By scaling with \sqrt{dₖ}, the model normalizes the scores, keeping gradients more manageable and stabilizing the SoftMax output, which aids in more effective learning and model convergence.

In the embodiment depicted in FIG. 14, an input prompt of “a fluffy blue creature roamed the verdant forest” is being processed through the attention filter. Each of these tokens, such as the first token 1420 are subject to processing through a query vector 1410 shown as W_{Q}. In a very simplistic way (and described herein for illustrative purposes), the token has an associated query vector 1410 that can “ask” questions in a numerical way such as, but not limited to, “are there any adjectives in front of me” ? In response, words that are adjectives before the creature token 1440 are more likely to be activated later on.

Specifically, each token has an associated vector/tensor written down herein as E₁, E₂ onward to E₈. Each of these vectors/tensors can be multiplied by or otherwise processed by a corresponding query matrix (shown as W_{Q}) to generate a query vector, denoted by Q₁, Q₂ onward to Q₈. Likewise, the same tokens, such as the first key token 1425, second key token 1435, and fourth key token 1445 can be processed through a key matrix (shown as Wₖ) to generate a corresponding key vectors denoted by K₁, K₂, and the like. Finally, for each token, the dot product of the query vector and key vector are determined. These values are then operated on through a type of SoftMax filter to generate a specific format of numbers such that each value will be placed between 0 and 1, and the sum off all values within a column shall be equal to 1. In this way, we can see that the “fluffy” token 1420 and “blue” token 1430 output a large value in association with the token “creature” as those tokens are adjectives describing the creature token 1440. Similar values appear when “the” and “verdant” are compared to the token “forest”.

In a variety of embodiments, the result of this dot product is an “attention vector” that can be added to the original vector such that a new modified attention vector is created. The goal is to move the vector associated with the token to a spot on the multi-dimensional space that is closer to other related terms. This output can then be sent to one or more multi-layer perceptron (MLPs).

Although a specific embodiment for an attention layer process 1400 within a large language model suitable for carrying out the various steps, processes, methods, and operations described herein is discussed with respect to FIG. 14, any of a variety of systems and/or processes may be utilized in accordance with embodiments of the disclosure. For example, the process described herein with reference to FIG. 14 and the attention models is presented in a simplistic fashion in order to allow for increased comprehension. However, those skilled in the art would recognize that other steps or attention model types may be utilized such as, but not limited to multi-head attention, and multi-head attention. The elements depicted in FIG. 14 may also be interchangeable with other elements of FIGS. 1-13 and FIG. 15-20 as required to realize a particularly desired embodiment.

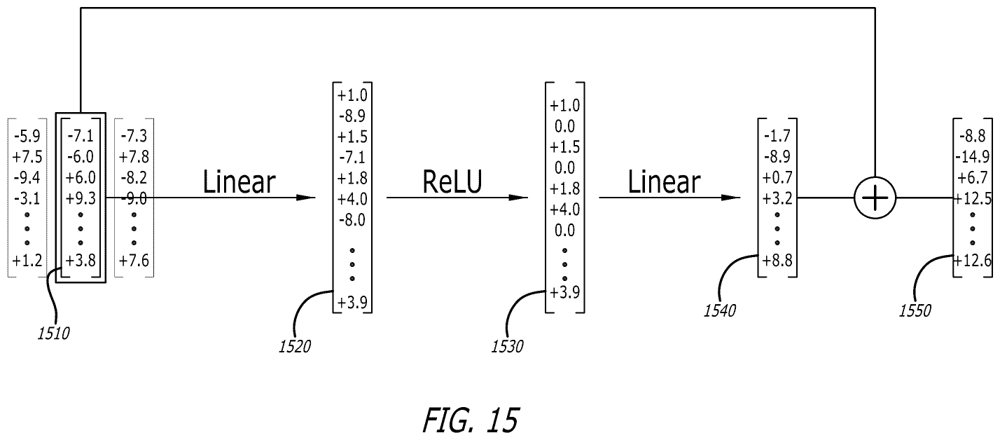

Referring to FIG. 15, a conceptual illustration of a multi-layer perceptron within a large language model in accordance with various embodiments of the disclosure is shown. In many embodiments within large language models (LLMs), multi-layer perceptrons (MLPs) play a role in refining and processing information after it has passed through the attention layers. MLPs, in the context of LLMs, are often positioned after each attention layer to add further transformations to the information embedded within each token. After the attention layer has modified each token's vector based on context and relationships with other tokens, this modified vector is then passed through an MLP. This MLP typically consists of a sequence of linear transformations, combined with a non-linear activation function, such as ReLU (Rectified Linear Unit). By applying these transformations, the MLP can help to fine-tune the representation of each token, capturing essential details and storing “factual” information that the model may rely on later.

The process can begin with a linear transformation, which expands the dimensions of the modified vector 1510, essentially mapping it to a higher-dimensional space. In the embodiment depicted in FIG. 15, the original modified vector 1510, which is typically an output of an attention layer, is processed through a linear transformation to yield a first output vector 1520. This initial expansion can allow the MLP to encode more complex information within each vector, giving it more capacity to capture and retain meaningful details.

After this expansion, various embodiments can apply a ReLU activation function, which introduces non-linearity into the processing. ReLU is particularly effective because it enables the model to focus on positive values within the vector, setting any negative values to zero. This step allows the model to highlight certain features within the token's vector while suppressing others, helping it differentiate important from less relevant information within the encoded representation. In the embodiment depicted in FIG. 15, the ReLU output vector 1530 is subsequently processed through another linear transformation.

In a number of embodiments, this second linear transformation can down-project the vector back to its original dimensionality. This step can ensure that the output from the MLP has the same dimensions as the input vector, allowing for a consistent vector size across all layers. The output vector 1540 from this down-projection is then added back to the original modified vector from the attention layer, creating what's known as a residual connection 1550. This residual connection 1550 combines the newly refined features from the MLP with the original contextual information produced by the attention layer. This approach enhances stability during training and allows the model to retain both the relational context and the refined factual details within the token's representation.

In the broader architecture of LLMs, MLPs are often considered the component where “facts” are stored. While the attention mechanism focuses on identifying relationships and associations between tokens, essentially, contextualizing each word within the sentence structure, the MLPs focus on enriching each token's representation with more granular, content-specific details. Through the repeated application of MLPs across multiple layers, the model can accumulate and consolidate information, effectively “remembering” facts and attributes associated with different words or phrases. This allows LLMs to recall specifics about language usage, word meanings, and even broader real-world information encoded in the training data.

In contrast, the attention layers are where the “associations” are stored, focusing on dynamically adjusting each token's focus depending on its context within the input sequence. Attention layers determine how strongly each token should relate to others, capturing nuances like syntax, grammar, and context-sensitive meanings. While attention layers dynamically build context, MLPs hold onto factual representations that serve as the knowledge base within each layer. Together, the attention and MLP layers enable the model to balance understanding relationships with retaining concrete information, resulting in a robust representation of both context and knowledge.

In a number of embodiments, input data often passes through multiple rounds of attention filters and multi-layer perceptron (MLP) layers, forming a sequence of transformations that incrementally refine the model's understanding of the input before reaching the final output stage. Each layer in the transformer model, the architecture commonly used for LLMs, includes both an attention component and an MLP component, with these two parts working in tandem to progressively deepen the model's comprehension of the text. This sequence is repeated over numerous layers, allowing the model to develop a sophisticated representation of the entire input sequence through cumulative transformations. By the end of these repeated passes, each token vector holds a highly nuanced, multi-dimensional understanding of the prompt. Once all layers have processed the data, the final, refined vectors proceed to the unembedding stage, where they are mapped back to language tokens that represent the model's predicted output.

Although a specific embodiment for a multi-layer perceptron within a large language model suitable for carrying out the various steps, processes, methods, and operations described herein is discussed with respect to FIG. 15, any of a variety of systems and/or processes may be utilized in accordance with embodiments of the disclosure. For example, as those skilled in the art will recognize, the specific layout and structure of the MLP layer can vary depending on the specific application desired. The elements depicted in FIG. 15 may also be interchangeable with other elements of FIGS. 1-14 and 16-20 as required to realize a particularly desired embodiment.

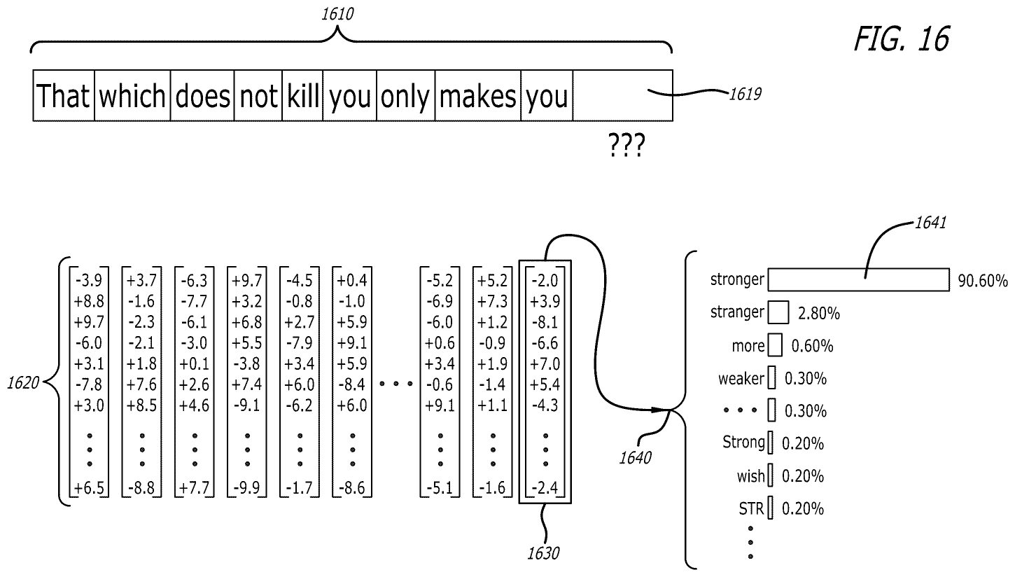

Referring to FIG. 16, a conceptual illustration of an unembedding process within a large language model in accordance with various embodiments of the disclosure is shown. In many embodiments, the final stage of a large language model's (LLM) processing is called unembedding, where it transforms the refined vectors from the last layer back into a probability distribution over potential output tokens. This stage is useful because it can allow the model to generate language tokens that represent the most likely continuations or responses to the input prompt. To achieve this, each vector (representing a token in the sequence) is mapped back to the model's vocabulary, which may contain tens of thousands of possible tokens. Unembedding utilizes a learned matrix, similar to the embedding matrix used at the input stage, but in reverse. Instead of converting tokens into vectors, it translates the processed vectors back into a set of potential language tokens that the model can output.

In a number of embodiments, the matrix output 1620 from the unembedding process is a final array 1630 where each entry corresponds to a probability score for a potential token. This probability distribution indicates how likely each word or phrase is to follow the input sequence, based on the context the model has built through its layers of attention and MLP processing. For instance, if the input prompt 1610, such as in the embodiment depicted in FIG. 16, is “That which does not kill you only makes you,” the unembedding process will produce a ranked list of possible next words. In this case, the word “stronger” might appear as the most probable continuation, with a high probability score. In FIG. 16, the probability of the “stronger” token response 1641 within the list of possible token responses 1640 is shown as 90.60 percent. This reflects the model's understanding of common phraseology and context, identifying “stronger” as a likely completion due to its frequency and relevance in similar contexts within the training data.

The ranked list produced during unembedding may include other potential outputs, each with an associated probability score that indicates its relative likelihood. For example, the word “stranger” could appear as a less probable continuation, with a probability of 2.80 percent, still present in the ranked list but much lower than “stronger.” This ranking reflects the model's capacity to recognize alternative continuations, including those that might follow less conventional but still possible language patterns. Other words, such as “more” or “weaker,” may also appear on this list, each with its own probability based on the contextual and semantic associations the model has learned. This probabilistic approach allows the model to produce flexible responses and make informed guesses about the next token in a way that mimics human language prediction.

The unembedding process may not only provide a ranked list of potential next words but also enable the model to maintain flexibility in generating responses. Depending on the application, the model might choose the highest-ranked token for a precise and likely output, or it could sample from the probability distribution to introduce variability, which can be useful in creative text generation or conversational applications. By examining the distribution of probabilities across potential tokens, the model can adapt its output strategy to different tasks, choosing the most probable word for accuracy or exploring lesser probable options for creative responses. This versatility is one of the reasons LLMs are effective across diverse language tasks, from completing sentences to generating open-ended stories.

The probability distribution generated in the unembedding phase reflects the culmination of all previous processing steps, encapsulating the context, associations, and factual information encoded within the model. Each token's probability is informed by the layers of attention and MLP transformations, which allow the model to build a nuanced understanding of the input. By ranking potential outputs, the model can provide a final “decision” on the next token based on its understanding, with the unembedding process acting as a bridge between the abstract, high-dimensional vector space within the model and the concrete language output we see.

In further embodiments, the LLM can generate entire sequences of text by using its own output as the input for subsequent steps, allowing it to create a series of tokens that form coherent responses or passages. Once the model generates a probable next token, it can feed this token back into its input pipeline, treating it as the next part of the prompt. This iterative process enables the model to build on each newly generated token, maintaining continuity and context with each step. For example, if the initial prompt is “The sky is,” and the model predicts “blue” as the most probable next word, it can then take “The sky is blue” as the new input. By repeating this cycle, the LLM can produce extended responses, updating its understanding of context and adjusting its predictions as it goes along. This feedback loop allows the model to generate complex, contextually aligned sequences, whether for completing sentences, generating stories, or engaging in conversational responses, all by sequentially predicting and incorporating each token into its evolving context.

Although a specific embodiment for an unembedding process within a large language model suitable for carrying out the various steps, processes, methods, and operations described herein is discussed with respect to FIG. 16, any of a variety of systems and/or processes may be utilized in accordance with embodiments of the disclosure. For example, the output for other types of models can be token related to images, sounds, or other data format types. The elements depicted in FIG. 16 may also be interchangeable with other elements of FIGS. 1-15, and 17-20 as required to realize a particularly desired embodiment.

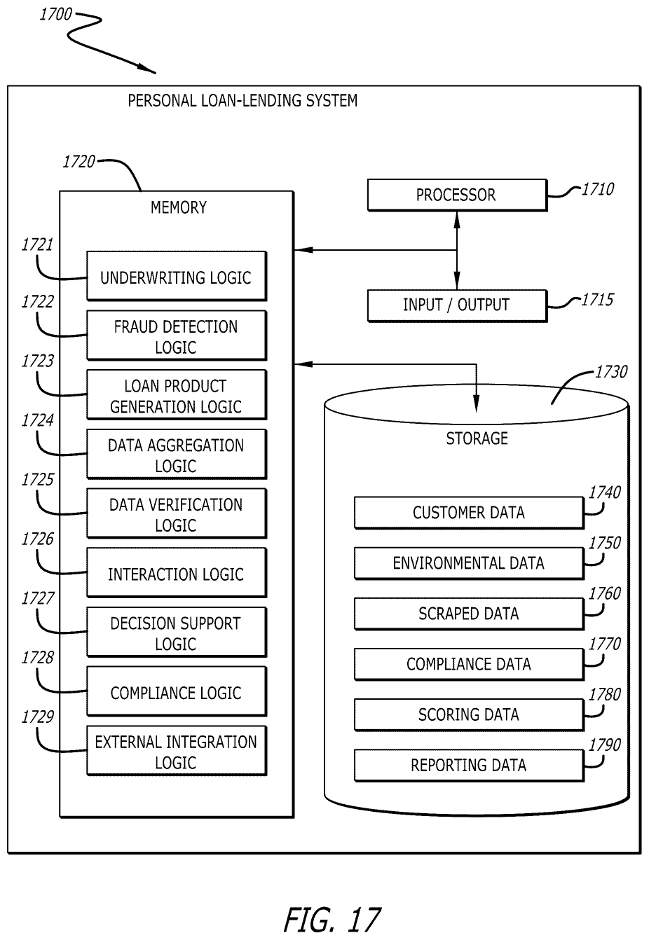

Referring to FIG. 17, a conceptual illustration of a personal loan-lending system 1700 in accordance with various embodiments of the disclosure is shown. As shown in the embodiment depicted in FIG. 17, the personal loan-lending system 1700 can include a processor 1710, memory 1720 comprising a plurality of logics, at least one input/output device 1715 and a storage 1730 including one or more data types. As those skilled in the art will recognize, this figure is simplified for illustrative purposes.

In many embodiments, an underwriting logic 1721 can enable automated assessment and decision-making processes to evaluate loan applications. This logic can include a set of rules, algorithms, and advanced decision-making frameworks designed to determine a borrower's creditworthiness and manage the risks associated with lending. By processing various inputs, underwriting logic 1721 can make determinations regarding loan approvals, terms, and other relevant factors. In some embodiments, underwriting logic 1721 may analyze borrower-provided data, such as income, employment history, and banking information, alongside third-party data, including credit scores, fraud detection results, and identity verification checks. This data can be aggregated from both internal systems and external integrations, such as credit bureaus and employment verification services. The logic may utilize predictive algorithms or machine learning techniques to weigh these data points and calculate a risk score that aligns with the lender's policies and thresholds.

Interactions between underwriting logic 1721 and other system components may occur. For instance, it may rely on an optical character recognition (OCR) module to extract data from uploaded borrower documents, such as pay stubs or tax returns. This capability can enhance the accuracy of borrower profiles by minimizing manual errors and ensuring completeness. Additionally, underwriting logic 1721 can collaborate with fraud detection logic 1722 to identify discrepancies or risks in borrower submissions. These interactions can form a comprehensive risk assessment framework, allowing the logic to consider a broad array of factors in its decision-making process. The underwriting logic 1721 can also interact with loan product generation logic 1723 to tailor loan offerings based on a borrower's profile. For example, it may generate personalized loan terms, including interest rates, repayment schedules, and loan amounts, that reflect the assessed risk. This functionality can help align loan products with both the borrower's needs and the institution's risk tolerance.

In further embodiments, underwriting logic 1721 can incorporate adaptive features, such as artificial intelligence, to refine its processes over time. By analyzing historical data, it may learn from the outcomes of prior lending decisions to improve the accuracy and fairness of its risk assessments. Feedback loops can be implemented to allow the logic to self-correct, adjusting weights and thresholds based on the success or failure of previous decisions. This adaptability can ensure that the logic remains effective in dynamic market conditions. Integration with servicing systems can be another function of underwriting logic 1721. For instance, once a loan is approved, the logic may provide the data necessary to establish repayment schedules, configure automated payments, or manage compliance with loan terms. This seamless interaction between origination and servicing systems can enhance the efficiency and reliability of the overall lending platform.

Underwriting logic 1721 can be designed to handle a variety of loan types, including unsecured loans, secured loans, and mortgages, by applying specific evaluation criteria for each category. It may utilize tailored data inputs and specialized algorithms to address the unique requirements of different loan products, ensuring that assessments remain precise and relevant. Overall, underwriting logic 1721 can facilitate the integration of diverse data sources, advanced analytics, and interconnected processes. By employing conditional and flexible methodologies, it may support the efficient origination and management of loans, while adapting to the evolving needs of both borrowers and lenders.

In a number of embodiments, a fraud detection logic 1722 may identify and mitigate fraudulent activities throughout the loan application and servicing processes. This logic may include algorithms, rules, and machine learning models that analyze data for inconsistencies, unusual patterns, or other indicators of potential fraud. By leveraging multiple sources of data, fraud detection logic 1722 can provide a robust framework for safeguarding the integrity of the lending platform. Fraud detection logic 1722 may utilize borrower-submitted information, such as personal identification details, employment records, and banking data, in combination with third-party data integrations. These integrations can include identity verification services, credit bureaus, and public record databases. The logic may also cross-reference data against internal historical records to identify discrepancies that could suggest fraudulent behavior. For example, mismatched addresses between applications and credit reports could be flagged for further review.

Interactions between fraud detection logic 1722 and other components of the lending system can enhance its functionality. For instance, it may work alongside optical character recognition (OCR) logic to validate data extracted from uploaded documents, such as pay stubs or identification cards. The logic can analyze these documents for signs of tampering, inconsistencies in formatting, or other anomalies. Similarly, fraud detection logic 1722 may collaborate with underwriting logic 1721 to assess risk holistically, incorporating fraud risk assessments into broader creditworthiness evaluations. The fraud detection logic 1722 can employ adaptive technologies, such as artificial intelligence and machine learning, to improve its accuracy over time. By analyzing patterns from previous cases of detected fraud, the logic may refine its algorithms to better identify emerging threats. For instance, it could learn to recognize new methods of document forgery or detect patterns of application behavior that are statistically associated with fraudulent activity. These adaptive capabilities can allow the system to stay ahead of evolving fraud tactics.

Data from fraud detection logic 1722 can also be used to inform other processes within the lending system. For example, if the logic identifies a high likelihood of fraud, it may trigger additional verification steps, such as requiring the borrower to provide supplementary documentation or escalating the application for manual review. This interaction can ensure that potentially fraudulent cases are addressed promptly without disrupting the overall flow of legitimate applications. Fraud detection logic 1722 can be integrated with third-party APIs to enhance its effectiveness. For instance, it may connect to databases that track known fraudulent activities or entities, allowing the system to identify applications linked to flagged individuals or organizations. It may also utilize external identity verification services to confirm that the submitted personal information matches existing records. These integrations can expand the scope of the logic's analysis and provide a more comprehensive approach to fraud prevention.

The flexibility of fraud detection logic 1722 can allow it to adapt to various types of loans and lending scenarios. Whether the system is processing unsecured personal loans, secured loans, or mortgages, the logic may apply tailored detection strategies to account for the unique risks associated with each loan type. This customization can ensure that the fraud detection measures remain effective across the diverse range of products offered by the lending platform. Overall, fraud detection logic 1722 can serve as a critical safeguard in the lending system, leveraging data from multiple sources and collaborating with other system logics to identify and prevent fraudulent activities.

In more embodiments, a loan product generation logic 1723 can tailor loan offerings to meet the needs of individual borrowers while aligning with the institution's risk management policies. This logic may include algorithms and decision-making frameworks that assess borrower profiles and generate suitable loan products, considering factors such as creditworthiness, income, and repayment capacity. By dynamically creating loan options, loan product generation logic 1723 can enhance borrower satisfaction and streamline the loan origination process.

The loan product generation logic 1723 may leverage a wide range of data inputs, including borrower-submitted information, such as employment history, income details, and stated loan purpose. It can also incorporate data from third-party sources, such as credit scores and fraud detection modules, to ensure that the proposed loan products are appropriate and aligned with risk assessment outcomes. By synthesizing this data, the logic may create a range of loan terms, including varying interest rates, loan amounts, and repayment schedules, offering borrowers flexibility in selecting a product that suits their financial needs.

Interactions with other components of the lending system can enhance the effectiveness of loan product generation logic 1723. For example, it may work closely with underwriting logic 1721 to incorporate risk assessments directly into the loan design process. If underwriting logic 1721 determines that a borrower presents a higher risk, loan product generation logic 1723 may adjust the loan options to include higher interest rates or shorter repayment periods to mitigate potential risks. Similarly, it may collaborate with fraud detection logic 1722 to ensure that the proposed loan products are only extended to verified and legitimate borrowers.

Loan product generation logic 1723 can also utilize adaptive algorithms, such as machine learning, to refine its product generation strategies over time. By analyzing data from previously originated loans, it may identify patterns in borrower preferences or outcomes that inform the creation of new loan products. For instance, if certain loan structures consistently result in successful repayment, the logic may prioritize generating similar options for borrowers with comparable profiles. This continuous learning process can ensure that the loan offerings remain competitive and effective.

In certain embodiments, the logic may further enhance its capabilities through integration with external data sources. By accessing real-time market data, such as interest rate trends or regional economic conditions, loan product generation logic 1723 may adapt its product generation strategies to reflect current financial climates. This adaptability can ensure that loan products remain relevant and appealing to borrowers while adhering to the institution's financial goals.

In various embodiments, loan product generation logic 1723 can also provide valuable data to other parts of the lending system. For instance, the logic may send proposed loan terms to borrower-facing interfaces, allowing potential borrowers to review and select loan products during the application process. Additionally, it can share generated loan terms with servicing systems to facilitate the automatic configuration of repayment schedules and other post-origination activities. This interconnectedness can create a seamless experience for borrowers and enhance the efficiency of the lending platform.

In further embodiments, a data aggregation logic 1724 may collect, consolidate, and organize information from various sources to enable seamless integration and analysis. This logic may gather data from internal databases, borrower submissions, third-party integrations, and real-time external systems to create a comprehensive dataset for further processing. By serving as the foundation for data-driven operations, data aggregation logic 1724 can enhance the accuracy and efficiency of other system components.

The data aggregation logic 1724 may handle diverse types of data, such as borrower-provided details, credit scores, employment records, and transaction histories. It can also integrate with external sources, including credit bureaus, identity verification services, and public record databases, to enrich the dataset with verified and supplementary information. This capability may ensure that the system has access to a unified and up-to-date dataset, reducing redundancy and the risk of inconsistencies.

Interactions with other logics in the system can enable data aggregation logic 1724 to support broader functionalities. For instance, it may collaborate with underwriting logic 1721 to supply consolidated borrower profiles for risk assessment. Similarly, it can interface with fraud detection logic 1722 to provide detailed transaction histories or identify anomalies in borrower behavior. These integrations may ensure that each logic operates with the most accurate and complete data available, enhancing the overall performance of the system.

In more embodiments, the data aggregation logic 1724 can also include mechanisms for prioritizing, filtering, and validating incoming data. By applying predefined rules or machine learning techniques, it may identify and eliminate irrelevant or erroneous data, ensuring that only high-quality information is retained. Additionally, the logic can manage conflicting data by evaluating the credibility of sources or reconciling discrepancies through cross-referencing. These processes may strengthen the reliability of the aggregated dataset.

This logic may further adapt to dynamic data environments by incorporating real-time updates. By continuously monitoring external APIs, data feeds, or borrower-submitted changes, data aggregation logic 1724 can ensure that its outputs reflect the latest available information. This adaptability can be especially valuable for time-sensitive processes, such as loan approvals or fraud detection, where accurate and current data can significantly impact decision-making. In various embodiments, data aggregation logic 1724 can also facilitate seamless communication with external systems and stakeholders. By standardizing and formatting data for compatibility with third-party systems, it may enable smooth interactions with external auditors, regulatory bodies, or partner organizations. Additionally, the logic can in certain embodiments generate structured datasets or reports tailored to specific requirements, supporting compliance and transparency efforts.

In additional embodiments, a data verification logic 1725 can include algorithms, rules, and workflows that compare, validate, and confirm data against predefined criteria or trusted sources. By performing these functions, data verification logic 1725 can enhance the reliability of borrower-provided information and reduce risks associated with errors or fraudulent submissions. In some embodiments, data verification logic 1725 may operate by cross-referencing data submitted by borrowers with external or internal sources. For example, it can validate employment history against third-party employment verification services or match banking details with financial institution records. This process may involve querying multiple databases, such as credit bureaus or public records, to ensure the consistency and authenticity of the data. Through these interactions, the logic can identify discrepancies, such as mismatched names or incorrect account details, that could otherwise compromise the lending process.

This logic can also interact with other logics within the system to enhance its effectiveness. For instance, it may collaborate with data aggregation logic 1724 to access consolidated datasets or with fraud detection logic 1722 to identify suspicious patterns in borrower-submitted information. These interactions may enable data verification logic 1725 to provide a more comprehensive analysis of data, supporting both risk assessment and compliance efforts. Furthermore, it can work with underwriting logic 1721 by supplying verified information that forms the basis of accurate risk evaluations. In more embodiments, data verification logic 1725 may also incorporate adaptive mechanisms to refine its processes over time. For example, it can utilize machine learning to identify common patterns of discrepancies or errors, allowing the system to focus on high-risk data points more effectively. By learning from previous verification outcomes, the logic may improve its ability to detect and address inconsistencies, ensuring that its operations remain robust in dynamic data environments.

In some embodiments, data verification logic 1725 can manage real-time data verification tasks. This may include confirming the authenticity of uploaded documents through integration with optical character recognition (OCR) modules, which extract and validate textual information. Additionally, it may handle real-time queries to external APIs to verify information, such as ensuring that a borrower's stated income aligns with tax or payroll records. These capabilities may enable the system to quickly process applications while maintaining a high level of accuracy. Data verification logic 1725 can also play a role in compliance by ensuring that the data used within the system adheres to regulatory standards. It may verify that borrower information is properly formatted, complete, and meets the requirements for legal and financial reporting. In doing so, data verification logic 1725 can help the system maintain compliance with applicable regulations while reducing the risk of penalties or legal challenges.

In still more embodiments, an interaction logic 1726 can comprise protocols, rules, and workflows designed to enable seamless interactions across internal system components, such as data aggregation, underwriting, and fraud detection, as well as external integrations with third-party services. By streamlining these interactions, interaction logic 1726 can enhance the overall efficiency and functionality of the lending platform. In certain embodiments, interaction logic 1726 may be responsible for ensuring that data flows smoothly and accurately between different parts of the system. For instance, it can facilitate the transfer of borrower information collected by user interfaces to backend modules, such as underwriting logic 1721, where the data may be analyzed. Similarly, it may coordinate the transmission of risk assessment results or verification outcomes from internal systems to borrower-facing interfaces, providing real-time updates and insights. This bidirectional flow of data can ensure that both internal processes and user interactions remain synchronized.

This logic may also enable dynamic collaborations between multiple logics, such as fraud detection logic 1722 and data verification logic 1725. For example, interaction logic 1726 can act as a mediator, allowing these logics to share data or trigger workflows based on specific events, such as identifying inconsistencies in borrower-submitted documents. These coordinated interactions can create a unified approach to tasks, such as risk evaluation or fraud prevention, ensuring that the system operates cohesively. In more embodiments, integration with third-party services can be another significant aspect of interaction logic 1726. It may handle the communication between the lending system and external APIs, such as credit bureaus, identity verification providers, or employment databases. This logic can ensure that requests are formatted correctly, responses are parsed efficiently, and relevant data is routed to appropriate system components. By managing these external interactions, it can enable the lending system to access and utilize a broader range of data sources.

In still more embodiments, interaction logic 1726 may also play a role in managing user interactions, such as those between borrowers and lender representatives. It can facilitate the exchange of messages, documents, and feedback through secure communication channels, ensuring that all parties remain informed and engaged throughout the lending process. Additionally, it may provide contextual information, such as progress updates or next steps, to enhance the user experience. To adapt to evolving requirements, interaction logic 1726 can incorporate learning capabilities or configurable workflows. For instance, it may monitor the efficiency of current interactions and suggest improvements, such as optimizing data pathways or reducing redundant communications. By analyzing historical data and system performance, the logic may refine its protocols to better support the system's operations.

In various embodiments, a decision support logic 1727 may include a combination of algorithms, predictive models, and data-driven frameworks designed to support key decisions, such as loan approvals, terms customization, and borrower risk assessments. By synthesizing information from multiple sources, decision support logic 1727 can offer recommendations that enhance the accuracy, efficiency, and reliability of the lending system. In some embodiments, decision support logic 1727 may aggregate data from both internal and external sources to form a comprehensive basis for its analyses. It can incorporate borrower-submitted information, such as financial details and employment history, along with data from credit bureaus, fraud detection services, and public records. By combining these inputs, the logic may generate actionable insights tailored to specific scenarios, such as determining appropriate loan terms or identifying high-risk applications. This capability can reduce the cognitive load on human decision-makers and improve the speed of critical lending processes.

Interaction with other logics in the system can enhance the effectiveness of decision support logic 1727. For instance, it may collaborate with underwriting logic 1721 to refine risk assessments or with loan product generation logic 1723 to suggest optimal loan offerings based on borrower profiles. It can also leverage insights from fraud detection logic 1722 to flag applications requiring additional scrutiny. These interactions may ensure that the decisions recommended by decision support logic 1727 are informed by a holistic understanding of the system's data and processes. In more embodiments, the logic can incorporate advanced technologies, such as machine learning and artificial intelligence, to refine its decision-making capabilities over time. By analyzing historical outcomes, decision support logic 1727 may identify patterns and trends that improve the accuracy of its predictions and recommendations. For example, it may learn to adjust its weighting of factors, such as income stability or credit score, based on their demonstrated relevance in past lending outcomes. This adaptability can ensure that the logic remains effective in dynamic and evolving market conditions.

In additional embodiments, decision support logic 1727 may also play a role in facilitating collaborative decision-making. For example, it can present its recommendations to human users, such as loan officers or managers, along with supporting data and reasoning. This transparency can enable users to make informed decisions while retaining the ability to override or modify the logic's suggestions when necessary. Additionally, the logic may enable multi-stakeholder collaboration by generating detailed reports or visualizations that summarize its analyses and predictions. The flexibility of decision support logic 1727 can allow it to adapt to different types of lending scenarios, including unsecured loans, secured loans, and mortgages. By applying context-specific rules and models, it may provide tailored recommendations that align with the unique requirements of each loan type. Furthermore, it can support compliance by ensuring that its decisions adhere to regulatory standards and internal policies, reducing the risk of errors or violations.

In still further embodiments, a compliance logic 1728 may comprise rules, workflows, and automated checks designed to enforce compliance across various stages of the lending lifecycle. By continuously monitoring activities and validating actions against relevant requirements, compliance logic 1728 can help mitigate legal and financial risks for the organization. In various embodiments, compliance logic 1728 may interact with borrower-submitted data and system-generated outputs to ensure adherence to regulations such as anti-money laundering (AML) laws, fair lending practices, and data privacy requirements. It can validate that borrower disclosures are complete and formatted correctly, ensure that risk assessments are performed impartially, and confirm that loan terms meet statutory or contractual limits. For example, the logic may verify that interest rates comply with local usury laws or that personal data is processed in accordance with privacy regulations like the General Data Protection Regulation (GDPR).

In some embodiments, this logic may collaborate with other components of the system to enhance its effectiveness. For instance, it may work with underwriting logic 1721 to ensure that lending decisions are made without bias or discrimination, as required by fair lending regulations. It can also interact with data verification logic 1725 to confirm the accuracy and completeness of data used in compliance checks. Furthermore, compliance logic 1728 may interface with fraud detection logic 1722 to identify and flag activities that violate anti-fraud or anti-money laundering regulations. In additional embodiments, compliance logic 1728 can also utilize external data sources and integrations to support its functions. It may connect with regulatory databases or third-party compliance platforms to verify borrower identities, cross-check against watchlists, or retrieve updated regulatory requirements. By incorporating these external inputs, the logic can maintain alignment with evolving standards and ensure the system operates within the bounds of current regulations.

As described above, the logic may employ machine learning or artificial intelligence to refine its compliance monitoring capabilities. By analyzing historical data and flagged violations, compliance logic 1728 can identify patterns or trends that indicate potential compliance risks. This adaptability can allow the system to preemptively address emerging issues and reduce the likelihood of non-compliance. Additionally, automated learning capabilities may enable the logic to generate insights that help refine internal policies or procedures to align more closely with regulatory expectations. In still more embodiments, compliance logic 1728 can also play a role in generating reports and documentation to support audits or regulatory reviews. It may compile detailed records of lending activities, including decision-making processes, borrower interactions, and system configurations, to demonstrate compliance with applicable laws. These reports can be formatted to meet the specific requirements of regulatory agencies or internal oversight bodies, contributing to transparency and accountability within the system.

In yet additional embodiments, an external integration logic 1729 can include protocols, APIs, and workflows designed to handle interactions with a wide range of external entities, such as credit bureaus, identity verification providers, fraud detection systems, and regulatory databases. By facilitating these integrations, external integration logic 1729 can ensure that the lending platform has access to accurate, up-to-date, and relevant information. This logic may manage the formatting and transmission of requests to external systems, ensuring that data from the lending platform conforms to the requirements of third-party interfaces. Similarly, it can process responses received from these entities, extracting relevant information and routing it to the appropriate internal logics or data repositories. For example, external integration logic 1729 may send a borrower's credit data request to a credit bureau and deliver the resulting credit score to underwriting logic 1721 for risk evaluation. This ability to coordinate and process external interactions can enhance the overall efficiency and accuracy of the system.

In various embodiments, external integration logic 1729 can also play a critical role in enabling real-time data exchanges. It may support rapid verification of borrower information, such as identity checks or employment confirmations, by leveraging external APIs and services. This capability can enable the system to process applications quickly while ensuring that all necessary verifications are performed. Additionally, it may facilitate real-time fraud detection by accessing external fraud monitoring databases or watchlists to identify high-risk activities or entities. This logic may interact dynamically with other internal logics to enhance system functionality. For instance, it can work with data aggregation logic 1724 to enrich borrower profiles with external data or collaborate with fraud detection logic 1722 to identify potential risks based on external alerts or flagged patterns. By integrating these external insights into internal workflows, external integration logic 1729 can contribute to a more comprehensive and effective decision-making process across the system.

To adapt to evolving requirements, some embodiments of the external integration logic 1729 can support the integration of new third-party systems or changes to existing external services. It may include configurable workflows and extensible APIs that allow the system to adapt to updates in external platforms or incorporate additional services as needed. This flexibility can ensure that the lending platform remains compatible with a diverse and changing external ecosystem. External integration logic 1729 may also include monitoring and error-handling mechanisms to ensure the reliability and security of external interactions. It can track the success or failure of data exchanges, log errors, and trigger retries or alerts when issues are detected. Additionally, it may include encryption protocols and secure authentication methods to protect sensitive data transmitted between the system and external entities.

In some embodiments, customer data 1740 can include a wide range of information specific to borrowers or potential borrowers, collected during various interactions with the system. Such information can include personal identifiers, such as names, addresses, and social security numbers, as well as financial details, such as income, employment history, and banking information. Customer data 1740 may also encompass data about borrowing behaviors, credit histories, and preferences indicated by the customer during the application process. This data can be collected from multiple sources, including direct input from the borrower through digital forms or interfaces, documents submitted for verification, and external services such as credit bureaus and identity verification platforms. Additionally, customer data 1740 may include metadata generated by the system itself, such as timestamps for application submissions, user behavior analytics, and interaction logs.

Various logics in the system may interact with customer data 1740 to perform their respective functions. For instance, underwriting logic 1721 may use this data to assess the borrower's creditworthiness, analyzing income, debt-to-income ratios, and credit scores to calculate risk levels. Fraud detection logic 1722 may analyze customer data 1740 for inconsistencies, such as mismatched addresses or duplicate applications, that could indicate fraudulent activity. Similarly, compliance logic 1728 may use customer data 1740 to ensure that borrower information adheres to regulatory requirements and internal policies. The system may also use customer data 1740 in conjunction with other types of data to enhance decision-making. For example, it can combine customer data 1740 with environmental data 1750 to understand broader economic factors affecting a borrower's financial stability or incorporate scraped data 1760 to validate borrower-submitted information against publicly available records. Scoring data 1780, which may be derived from customer data 1740, can serve as an input for logics that calculate credit scores or risk levels, providing a quantified assessment of the customer's financial health. Reporting data 1790 may rely on customer data 1740 to generate insights or compliance reports for internal or regulatory purposes.

In a number of embodiments, customer data 1740 can also be updated and refined throughout the customer lifecycle. For instance, as borrowers make payments, their repayment histories and updated account statuses may be added to the data repository, enabling the system to make adjustments to ongoing processes such as servicing or risk monitoring. Logics within the system can utilize these updates to ensure that their operations are based on the most accurate and current information available. To ensure the integrity and security of customer data 1740, the system may implement strict validation and encryption protocols. Data verification logic 1725 can validate the accuracy of customer data 1740 against trusted sources, while interaction logic 1726 can ensure that this data flows securely between internal components and external platforms. These measures can help protect sensitive information and maintain compliance with privacy regulations.

In still additional embodiments, environmental data 1750 may comprise a broad range of economic, demographic, geographic, and market-related information that contextualizes customer data 1740 and other types of data utilized by the system. Environmental data 1750 can be dynamic, reflecting real-time conditions such as interest rate trends, unemployment rates, or regional economic indicators, as well as static information, such as geographic boundaries or industry classifications. This type of data may be sourced from external databases, government reports, financial market feeds, or third-party analytics platforms. For example, environmental data 1750 can include national or regional economic indicators, such as gross domestic product (GDP), inflation rates, or consumer confidence indices. It may also include localized data, such as housing market trends, average income levels in specific regions, or environmental risks like natural disaster frequency. Additionally, it can incorporate regulatory changes or policy updates that may impact lending decisions or operational compliance.

The system's plurality of logics can interact with environmental data 1750 in some embodiments to enhance their processes and outcomes. For instance, underwriting logic 1721 may consider regional economic conditions when evaluating a borrower's risk profile, adjusting its calculations based on factors like local employment rates or housing market volatility. Similarly, loan product generation logic 1723 may use environmental data 1750 to tailor loan terms or offerings to align with market conditions, such as fluctuating interest rates or regional lending demands. Compliance logic 1728 may incorporate regulatory updates from environmental data 1750 to ensure that the system adheres to changing legal and policy requirements. Environmental data 1750 can also provide valuable context when combined with other types of data in the system. For example, customer data 1740 may be enriched with regional demographic insights from environmental data 1750 to provide a more comprehensive view of borrower behavior and needs. Scoring data 1780 may incorporate environmental factors to generate more accurate risk assessments, reflecting broader economic trends that could impact an individual's financial stability. Reporting data 1790 may include environmental data 1750 to offer stakeholders a holistic understanding of performance metrics within the context of external conditions.

In additional embodiments, the system may use real-time environmental data 1750 to adapt dynamically to changing conditions. For instance, during economic downturns or periods of market instability, the system could adjust its lending criteria, risk thresholds, or product offerings to mitigate potential risks. This adaptability can be facilitated by interaction logic 1726, which ensures that environmental data 1750 flows seamlessly to relevant components within the system, and decision support logic 1727, which interprets this data to guide strategic decisions. To maintain the relevance and reliability of environmental data 1750, the system may employ data aggregation logic 1724 to continuously collect and update information from multiple sources. Additionally, data verification logic 1725 can validate the accuracy and consistency of environmental data 1750 to prevent errors or discrepancies from affecting system operations. By integrating these safeguards, the system can ensure that its use of environmental data 1750 is both effective and secure.

In yet further embodiments, scraped data 1760 can include a wide variety of information gathered from websites, social media platforms, public records, or other online sources that can provide additional context or insights relevant to the lending system. Scraped data 1760 can serve as a supplemental data type, enriching the system's understanding of borrowers, market conditions, or other factors influencing decision-making. Scraped data 1760 may include information such as public social media profiles, business website details, news articles, or public government databases. For example, it can collect employment verification details from a company's website, validate the existence and reputation of a borrower's business, or gather real estate listings to cross-check property information submitted by a borrower. Additionally, scraped data 1760 may include reviews, ratings, or other online feedback related to entities or individuals involved in the lending process. This data type can help fill gaps in other datasets, providing additional verification or context for key decisions.

Various logics within the system can interact with scraped data 1760 in certain embodiments to enhance their processes. For instance, data verification logic 1725 may use this data to cross-check borrower-submitted information, such as employment details or the existence of collateral assets, against publicly available online records. Fraud detection logic 1722 may analyze scraped data 1760 for inconsistencies or red flags, such as identifying discrepancies in an applicant's professional claims or locating adverse news coverage about a borrower. Similarly, underwriting logic 1721 may incorporate this data to gain a more comprehensive understanding of a borrower's background, ensuring that risk assessments are based on a wide range of inputs. In some embodiments, scraped data 1760 can also complement other types of data in the system, contributing to a more holistic approach to decision-making. When combined with customer data 1740, it may provide additional context or verification for borrower-submitted information. For example, social media activity or online job listings could support claims about a borrower's employment or financial stability. When paired with environmental data 1750, scraped data 1760 may enrich insights about market trends or local conditions, such as real estate pricing fluctuations or regional business performance. Additionally, this data can inform scoring data 1780 by contributing nuanced inputs for credit or risk assessments.

In various embodiments, the system can use interaction logic 1726 to facilitate the seamless integration of scraped data 1760 into workflows, ensuring that it is routed to the appropriate logics for processing. To maintain the quality and reliability of scraped data 1760, data aggregation logic 1724 may organize and structure the information, while data verification logic 1725 can validate its accuracy and relevance. These processes may help mitigate potential risks associated with inaccuracies or outdated information that can sometimes arise in web scraping. Scraped data 1760 may also be updated or refreshed periodically to ensure that it reflects the most current and accurate information available. The system can implement mechanisms to monitor online sources for changes or updates, enabling real-time adjustments to decisions or processes. This adaptability can be particularly useful in fast-changing contexts, such as market conditions or public sentiment.

In more various embodiments, compliance data 1770 may comprise a broad range of elements, such as legal statutes, financial regulations, reporting requirements, and internal policies, which ensure that the system adheres to applicable compliance standards. Compliance data 1770 can serve as a critical foundation for maintaining the integrity of the system while reducing the risk of regulatory violations or legal disputes. This data may be sourced from external regulatory bodies, industry standards organizations, or internal governance teams responsible for policy enforcement. For example, compliance data 1770 can include updated anti-money laundering (AML) regulations, fair lending guidelines, data privacy laws, and other statutory requirements. It may also contain internal operational guidelines, such as credit approval thresholds, risk limits, and documentation standards, tailored to align with institutional priorities and compliance goals.

The plurality of logics within the system may interact extensively with compliance data 1770 to ensure their operations meet regulatory and policy requirements. Compliance logic 1728 can use this data to validate that all processes adhere to the latest rules and standards, flagging potential violations for further review. For instance, it may confirm that loan terms align with local usury laws or that borrower data is processed in accordance with privacy regulations such as the General Data Protection Regulation (GDPR). Similarly, underwriting logic 1721 may incorporate compliance data 1770 to adjust its decision-making parameters, ensuring that risk assessments are performed within permissible boundaries. Compliance data 1770 can also work in conjunction with other types of data to enhance the system's overall functionality. When combined with customer data 1740, it can ensure that borrower information is evaluated in a manner consistent with legal and policy requirements, such as anti-discrimination rules. Paired with environmental data 1750, compliance data 1770 may help the system respond to changes in regulatory conditions tied to specific geographic regions or economic factors. Additionally, scoring data 1780 may integrate compliance data 1770 to ensure that risk scores and lending decisions align with established thresholds and guidelines.

To maintain the relevance and accuracy of compliance data 1770, the system may rely in some embodiments on external integration logic 1729 to retrieve updates from regulatory bodies or third-party compliance platforms. Interaction logic 1726 can facilitate the distribution of compliance data 1770 across the system, ensuring that all relevant logics and processes have access to the most current information. Data verification logic 1725 may validate the accuracy and completeness of compliance data 1770, ensuring that outdated or erroneous information does not impact system operations. In certain embodiments, compliance data 1770 may also play a key role in reporting and audit processes. Reporting data 1790 may draw on compliance data 1770 to generate detailed documentation that demonstrates adherence to legal and policy requirements. This capability can support transparency and accountability during audits or regulatory reviews, providing stakeholders with evidence of the system's commitment to compliance.

In still yet more embodiments, scoring data 1780 may comprise quantified assessments and metrics used to evaluate various aspects of the lending process, particularly borrower risk, creditworthiness, and overall suitability for specific loan products. This data may be derived from multiple sources, including customer data 1740, environmental data 1750, and scraped data 1760, and can serve as a critical input for decision-making across the system. Scoring data 1780 may encompass credit scores, risk scores, fraud likelihood ratings, and other numeric or categorical evaluations tailored to the system's requirements. In some embodiments, scoring data 1780 may be generated through a combination of algorithms, statistical models, and machine learning techniques designed to synthesize complex datasets into actionable insights. For instance, a credit score in scoring data 1780 may combine elements such as a borrower's repayment history, outstanding debts, and income stability, while a fraud likelihood score may assess discrepancies in application data or patterns of behavior indicative of fraudulent activity. These scores can enable the system to process applications more efficiently by offering concise and standardized evaluations for each borrower or transaction.

The system's logics can interact extensively with scoring data 1780 in certain embodiments to enhance their functionality. Underwriting logic 1721 may rely on this data to evaluate the risk of extending a loan, using risk scores to inform decisions about approval, loan terms, or collateral requirements. Fraud detection logic 1722 may use scoring data 1780 to prioritize investigations, focusing on applications with higher fraud likelihood ratings. Loan product generation logic 1723 may incorporate scoring data 1780 to tailor offerings, such as adjusting interest rates or repayment schedules based on the borrower's creditworthiness. In some embodiments, scoring data 1780 can also be used in conjunction with other types of data to provide a more comprehensive view of system operations. When paired with customer data 1740, it can enable more personalized lending decisions that reflect individual borrower circumstances. Combining scoring data 1780 with environmental data 1750 may allow the system to contextualize risk assessments within broader economic or regional conditions, such as local housing market trends or unemployment rates. Compliance logic 1728 may use scoring data 1780 to verify that decisions adhere to regulatory standards, such as ensuring fairness and consistency in credit evaluations.

To ensure its accuracy and relevance, scoring data 1780 may be continuously updated and refined through feedback loops and machine learning processes. For example, the system can analyze the outcomes of past lending decisions to identify patterns or adjustments that improve the predictive accuracy of its scoring models. Data verification logic 1725 may validate scoring data 1780 against trusted sources or historical benchmarks to ensure consistency and reliability. In many embodiments, scoring data 1780 may also contribute to reporting and monitoring functions within the system. Reporting data 1790 may utilize scoring data 1780 to generate insights for internal stakeholders or regulatory bodies, such as summaries of risk distributions across the portfolio or analyses of scoring trends over time. This capability can support transparency and accountability while providing a deeper understanding of system performance.

In further additional embodiments, reporting data 1790 can include the aggregated and structured outputs of the lending system, designed to provide insights, summaries, and documentation for a variety of stakeholders. This data may include performance metrics, compliance records, operational analyses, and borrower-specific details that reflect the outcomes and processes of the system. Reporting data 1790 can be tailored to meet the needs of internal stakeholders, such as management and compliance teams, as well as external audiences, including regulators, auditors, and business partners. This type of data can be generated by synthesizing inputs from various sources, including, but not limited to, customer data 1740, environmental data 1750, scoring data 1780, and compliance data 1770. Reporting data 1790 may include summaries of loan origination activities, such as the number of loans processed, approval rates, and average loan amounts. It can also provide insights into system performance, such as risk distributions across borrowers, fraud detection trends, and compliance audit results. By consolidating these inputs into clear and actionable outputs, reporting data 1790 can serve as a critical tool for oversight and decision-making.

The system's logics may interact with reporting data 1790 in several ways. For example, compliance logic 1728 may contribute to or utilize reporting data 1790 to demonstrate adherence to legal and regulatory requirements, such as anti-money laundering (AML) and fair lending standards. Decision support logic 1727 may incorporate reporting data 1790 to inform strategic planning, such as identifying areas for operational improvement or adjusting lending criteria based on portfolio performance. Interaction logic 1726 can facilitate the distribution of reporting data 1790 to appropriate stakeholders, ensuring that the right insights reach the right audience. In more embodiments, reporting data 1790 can also include visualizations and summaries that enhance its usability and accessibility. For example, it may present key metrics through dashboards, charts, or graphs that provide at-a-glance insights into system performance. For external stakeholders, such as regulatory bodies or auditors, reporting data 1790 may include detailed records and documentation formatted to meet specific reporting standards. These capabilities can support both routine monitoring and ad hoc investigations, enabling the system to maintain transparency and accountability.

This data type may also work in tandem with other types of data to provide a more comprehensive perspective. When combined with scoring data 1780, reporting data 1790 can offer detailed analyses of borrower risk profiles or trends in creditworthiness. Paired with environmental data 1750, it may contextualize system performance within broader economic or regional conditions. Additionally, customer data 1740 can be incorporated into reporting data 1790 to generate borrower-specific insights, such as repayment histories or loan portfolio contributions. To ensure its accuracy and reliability, reporting data 1790 can be updated dynamically and validated through internal checks. Data verification logic 1725 may review the inputs and calculations that contribute to reporting data 1790, ensuring consistency and compliance with internal standards. External integration logic 1729 may retrieve additional inputs from third-party platforms or regulatory systems, enriching the outputs and ensuring that they align with external benchmarks or requirements.

Although a specific embodiment for an unembedding process within a large language model suitable for carrying out the various steps, processes, methods, and operations described herein is discussed with respect to FIG. 17, any of a variety of systems and/or processes may be utilized in accordance with embodiments of the disclosure. For example, specific number and distribution of logics and data configurations may vary based on the application desired. The elements depicted in FIG. 17 may also be interchangeable with other elements of FIGS. 1-16, and 18-20 as required to realize a particularly desired embodiment.

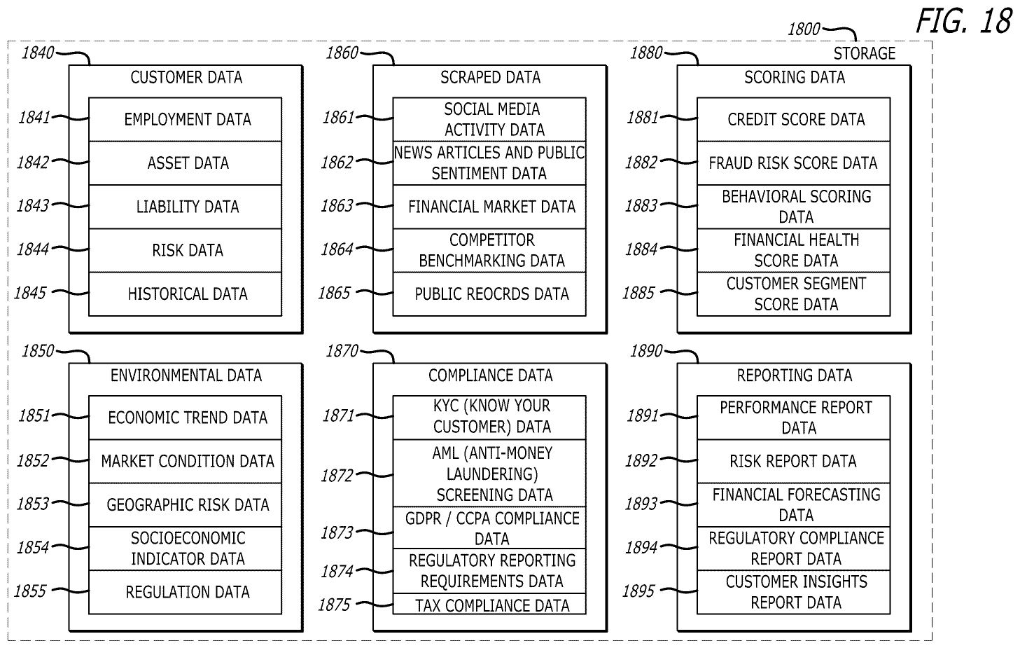

Referring to FIG. 18, a conceptual illustration of a plurality of data that can be utilized in accordance with various embodiments of the disclosure is shown. As shown in the embodiment depicted in FIG. 18, the storage 1800 can include one or more data types. As those skilled in the art will recognize, this figure is simplified for illustrative purposes.

As stated above, customer data 1840 can serve as a comprehensive repository of information related to individual borrowers or potential borrowers, forming a critical foundation for various processes within the lending system. This data type may encompass a broad array of personal, financial, and behavioral details collected from borrowers during their interactions with the system. Customer data 1840 can include personal identifiers, financial histories, credit-related information, and contextual insights, enabling the system to make informed decisions about loan origination, servicing, and compliance. Customer data 1840 may be sourced from multiple channels, including borrower-submitted forms, uploaded documents, and third-party integrations such as credit bureaus or public records. This data can be dynamically updated throughout the borrower lifecycle, ensuring that decisions are based on the most current and relevant information. Logics within the system, such as underwriting logic 1721 and fraud detection logic 1722, may interact with customer data 1840 to perform critical tasks such as risk assessment, eligibility evaluation, and compliance verification. The structure of customer data 1840 allows it to integrate seamlessly with other data types, such as scoring data 1780 or compliance data 1770, to provide a holistic view of the borrower.

In many embodiments, employment data 1841 can include details about a borrower's employment status, history, and income, serving as a key indicator of financial stability and repayment capacity. This sub-data type may encompass information such as the borrower's current job title, employer name, duration of employment, and income level. Employment data 1841 may also include verification statuses obtained through third-party integrations or documentation, such as pay stubs or employment letters. This data can be utilized by underwriting logic 1721 to assess the borrower's ability to meet repayment obligations and by fraud detection logic 1722 to verify the authenticity of employment claims. Additionally, loan product generation logic 1723 may use employment data 1841 to tailor loan terms, such as adjusting repayment schedules or interest rates based on income stability. By providing a clear picture of a borrower's financial standing, employment data 1841 can play a central role in informed decision-making.

In a number of embodiments, asset data 1842 may include information about the borrower's tangible and intangible assets, such as property holdings, vehicles, savings accounts, and investments. This sub-data type can help the system evaluate the borrower's overall financial health and the availability of collateral for secured loans. Asset data 1842 may also include asset valuation details, ownership documentation, and evidence of liquidity. Various logics within the system may interact with asset data 1842. Underwriting logic 1721 can assess the value and liquidity of assets when determining loan approval and risk levels. Fraud detection logic 1722 may use asset data 1842 to identify discrepancies or inconsistencies in asset declarations. Additionally, compliance logic 1728 may validate asset-related information to ensure adherence to legal and regulatory requirements.

In further embodiments, liability data 1843 can include information about the borrower's existing debts and financial obligations, such as mortgages, credit card balances, student loans, or other personal loans. This data type provides a comprehensive view of the borrower's financial commitments, enabling the system to calculate debt-to-income ratios and overall credit risk. Underwriting logic 1721 may analyze liability data 1843 to determine whether a borrower can manage additional loan obligations. Decision support logic 1727 can use this data to recommend appropriate loan products or repayment terms. By understanding the borrower's financial burdens, liability data 1843 can contribute to a balanced and responsible lending approach.

In certain embodiments, risk data 1844 may encapsulate metrics, scores, and qualitative assessments related to the borrower's creditworthiness and likelihood of default. This sub-data type can be derived from other datasets, such as customer data 1840, scoring data 1780, and historical data 1845, and may include credit scores, risk tier classifications, and predictive analytics. This data can be integral to underwriting logic 1721, which uses risk data 1844 to evaluate the probability of loan repayment. Fraud detection logic 1722 may also reference this data to flag borrowers with high-risk profiles for further scrutiny. By quantifying and categorizing risk, risk data 1844 can enable more precise and informed decision-making.

In additional embodiments, historical data 1845 may consist of records of a borrower's past interactions with the system, including prior applications, repayment histories, and account activities. This sub-data type provides valuable insights into borrower behavior, such as patterns of timely payments, missed deadlines, or previous loan defaults. Underwriting logic 1721 and decision support logic 1727 may use historical data 1845 to identify trends that inform current lending decisions. For example, a borrower with a strong history of on-time repayments may be offered more favorable terms. Additionally, compliance logic 1728 may rely on historical data 1845 to ensure that lending practices align with established policies and standards.

In many embodiments, environmental data 1850 can encompass external information that provides context for the lending system's operations and decisions. This data type may include a wide array of details about economic, market, geographic, and regulatory factors that influence borrower behavior, loan performance, and overall system risk. By integrating these insights, environmental data 1850 can enable the system to adapt its processes and decisions to align with external conditions, ensuring more informed and reliable outcomes. As previously described, environmental data 1850 may be sourced from governmental databases, financial market feeds, public records, and third-party analytics platforms. It can include both real-time updates and historical trends, reflecting dynamic changes in the economic landscape or regional conditions. The system's logics, such as underwriting logic 1721 and loan product generation logic 1723, may interact with environmental data 1850 to incorporate external context into their processes, enabling a more comprehensive approach to risk assessment, compliance, and product customization.

In some embodiments, economic trend data 1851 can include macroeconomic indicators, such as GDP growth rates, inflation levels, employment statistics, and consumer confidence indices. This sub-data type provides a high-level view of the economic environment in which borrowers operate, helping the system evaluate external pressures that may impact repayment behavior or borrowing demand. For instance, underwriting logic 1721 may use economic trend data 1851 to adjust risk thresholds during economic downturns, while compliance logic 1728 may ensure that lending practices remain fair and consistent in varying economic conditions.

In still more embodiments, market condition data 1852 may capture information about specific financial markets or sectors, such as real estate trends, stock market performance, or lending rate fluctuations. This data can help the system align its offerings with current market demands and identify potential risks or opportunities. Loan product generation logic 1723 may leverage market condition data 1852 to create loan products that reflect competitive interest rates or address specific sector needs. Additionally, decision support logic 1727 may use this data to inform strategic adjustments to lending policies or portfolio management.

In various additional embodiments, geographic risk data 1853 can include information about regional factors that may influence borrower risk or loan performance. This data may encompass natural disaster risks, crime rates, housing market stability, or regional economic disparities. By incorporating geographic risk data 1853, the system can tailor its assessments and offerings to reflect localized conditions. For example, underwriting logic 1721 may adjust its risk models for borrowers in high-risk areas, while fraud detection logic 1722 may use geographic risk data 1853 to identify patterns of fraudulent activity tied to specific locations.

In a number of embodiments, socioeconomic indicator data 1854 may provide insights into demographic and societal trends, such as income levels, education rates, population density, and consumer spending patterns. This sub-data type can help the system understand the broader social context in which borrowers operate, enabling more targeted and equitable lending practices. Underwriting logic 1721 may use socioeconomic indicator data 1854 to refine its risk assessments, while compliance logic 1728 may ensure that lending policies align with fair lending standards and address societal needs.

In certain embodiments, regulation data 1855 can include details about legal and policy requirements that govern lending practices in specific regions or markets. This sub-data type may encompass updates to financial regulations, local tax laws, and data privacy standards, providing the system with the information needed to maintain compliance. Compliance logic 1728 may rely on regulation data 1855 to ensure that all processes adhere to current legal requirements, while external integration logic 1729 may access regulatory databases to retrieve the latest updates for incorporation into the system.

In still more embodiments, scraped data 1860 can consist of information collected from publicly available online sources, providing supplementary insights that enrich the system's understanding of borrowers, markets, and external conditions. This data type may be gathered through automated or semi-automated web scraping techniques, enabling the system to leverage a diverse range of digital resources. Scraped data 1860 can serve as a valuable input for various logics within the system, supporting tasks such as risk assessment, fraud detection, and product customization by providing additional layers of context and verification. As described above, this data can originate from sources such as social media platforms, news outlets, public databases, financial websites, and competitor analysis tools. The variety of information available through scraped data 1860 allows the system to enhance its decision-making capabilities, particularly in cases where other data types may be incomplete or require additional corroboration. Interaction logic 1726 can facilitate the integration of scraped data 1860 into system workflows, while data verification logic 1725 may validate its accuracy and relevance to ensure reliability.

In certain embodiments, social media activity data 1861 can include publicly visible information from social networking platforms, such as user profiles, posts, interactions, and activity patterns. This sub-data type may provide insights into borrower behavior, professional affiliations, or lifestyle indicators that help assess creditworthiness or detect potential risks. For example, underwriting logic 1721 may analyze social media activity data 1861 to validate employment claims or identify discrepancies in borrower-submitted information. Fraud detection logic 1722 may also use this data to flag accounts linked to suspicious activity or networks.

In some embodiments, news articles and public sentiment data 1862 may capture current events, public opinion, and sentiment trends related to borrowers, industries, or regions. This sub-data type can help the system understand reputational risks or emerging opportunities that may influence lending decisions. Decision support logic 1727 may incorporate news articles and public sentiment data 1862 to adjust strategies in response to market developments or public perceptions, while compliance logic 1728 may ensure that decisions are aligned with reputational and ethical considerations.

In further embodiments, financial market data 1863 may include information about stock prices, bond yields, interest rates, and other market indicators gathered from public financial websites and platforms. This sub-data type can inform the system about broader economic conditions and trends that affect lending and risk management. Loan product generation logic 1723 may use financial market data 1863 to adjust loan offerings in line with market trends, while scoring data 1780 may integrate this data to refine risk assessments. Competitor benchmarking data 1864 may provide insights into the offerings, strategies, and performance of other lenders in the market. This sub-data type can be collected from competitor websites, advertisements, or industry reports, enabling the system to evaluate its position relative to peers. Loan product generation logic 1723 may leverage competitor benchmarking data 1864 to design competitive loan products, while decision support logic 1727 may use it to guide broader strategic planning and market positioning efforts.

In yet additional embodiments, public records data 1865 may consist of information available in government or institutional databases, such as property records, court filings, business registrations, and licensing information. This sub-data type can provide verified details about borrowers, collateral, or associated entities, enhancing the accuracy of the system's assessments. Data verification logic 1725 may use public records data 1865 to confirm the authenticity of borrower-submitted information, while underwriting logic 1721 may reference it to evaluate asset value or legal standing.

In still more embodiments, compliance data 1870 can serve as a cornerstone of the system's efforts to operate within legal, regulatory, and ethical frameworks. This type of data may include information related to various compliance standards and requirements that govern the system's operations, ensuring adherence to laws and regulations across jurisdictions. By providing the necessary data to monitor and enforce compliance, compliance data 1870 can help mitigate legal risks, enhance transparency, and maintain the trust of stakeholders. In more embodiments, this data type may originate from internal policies, regulatory agencies, external compliance platforms, and legal databases. Compliance data 1870 can encompass both static information, such as established legal standards, and dynamic updates, such as new regulations or changes in reporting requirements. The system's logics, including compliance logic 1728, may interact with compliance data 1870 to ensure that all processes, from loan origination to servicing, meet applicable legal and regulatory criteria. Additionally, interaction logic 1726 and external integration logic 1729 can facilitate the seamless integration of compliance data 1870 into the system's workflows.

In various embodiments, KYC (Know Your Customer) data 1871 can include information collected to verify the identity of borrowers and ensure they meet eligibility criteria. This sub-data type may encompass personal identifiers, government-issued identification documents, and verification results from third-party services. KYC data 1871 can be essential for preventing fraud, ensuring lawful lending practices, and maintaining compliance with financial regulations. Fraud detection logic 1722 may rely on KYC data 1871 to confirm the legitimacy of borrowers, while compliance logic 1728 may use this data to ensure adherence to customer due diligence requirements.

In more embodiments, AML (Anti-Money Laundering) data 1872 may include information related to monitoring and preventing illicit financial activities, such as money laundering and terrorism financing. This sub-data type can consist of flagged transactions, risk profiles, and results from watchlist screenings conducted through external compliance platforms. AML data 1872 may be utilized by compliance logic 1728 to identify and mitigate high-risk activities and by fraud detection logic 1722 to cross-reference borrower information with global watchlists or suspicious activity databases. This ensures the system operates within the bounds of anti-money laundering laws.

In certain embodiments, GDPR/CCPA compliance data 1873 can pertain to data privacy regulations, ensuring that the system processes customer information in accordance with laws such as the General Data Protection Regulation (GDPR) and the California Consumer Privacy Act (CCPA). This sub-data type may include consent records, data handling policies, and audit trails demonstrating adherence to privacy standards. Compliance logic 1728 may use GDPR/CCPA compliance data 1873 to validate data processing practices, while data verification logic 1725 may ensure that all data collected and used aligns with these regulations.

In still more embodiments, regulatory reporting requirements data 1874 can consist of information necessary to fulfill legal obligations for periodic reporting to regulators and oversight bodies. This sub-data type may include standardized templates, data fields, and guidelines for reporting on loan activity, risk assessments, and compliance performance. Compliance logic 1728 may leverage regulatory reporting requirements data 1874 to generate accurate and timely reports, while decision support logic 1727 may use this data to ensure strategic alignment with regulatory expectations.

In still additional embodiments, tax compliance data 1875 can include information about tax regulations, withholding requirements, and documentation needed for compliance with local, state, and federal tax laws. This sub-data type may encompass tax identification numbers, applicable tax rates, and records of tax-related transactions. Compliance logic 1728 may rely on tax compliance data 1875 to ensure proper tax treatment of loan products, while external integration logic 1729 may facilitate the retrieval of tax-related updates from government databases.

In a number of embodiments, scoring data 1880 can represent a critical component of the system's ability to evaluate borrower risk, creditworthiness, and overall suitability for loan products. This type of data may consist of quantified metrics and predictive assessments derived from various internal and external sources, allowing the system to synthesize complex information into actionable insights. Scoring data 1880 can support a range of functions, from risk management and fraud detection to product customization and compliance monitoring, enabling the system to operate efficiently and effectively. As discussed above, this data type may be generated using advanced algorithms, statistical models, and machine learning techniques that analyze patterns and relationships across datasets. Scoring data 1880 may combine inputs from customer data 1840, environmental data 1850, and compliance data 1870 to produce detailed and contextually relevant evaluations. Logics such as underwriting logic 1721 and fraud detection logic 1722 may interact extensively with scoring data 1880 to support key decisions. Additionally, scoring data 1880 may serve as a foundation for reporting data 1790, providing insights into overall system performance and borrower behavior.

In some embodiments, credit score data 1881 can include traditional credit scores derived from credit bureaus and internal calculations, reflecting a borrower's creditworthiness based on factors such as repayment history, debt-to-income ratios, and length of credit history. This sub-data type can be a primary input for underwriting logic 1721, enabling the system to assess the likelihood of loan repayment. Loan product generation logic 1723 may use credit score data 1881 to customize loan terms, such as interest rates or collateral requirements, ensuring alignment with the borrower's financial profile.

In more embodiments, fraud risk score data 1882 may capture predictive assessments of the likelihood of fraudulent behavior, calculated using patterns and anomalies in borrower-submitted data. This sub-data type may include factors such as inconsistencies in documentation, suspicious activity histories, or flagged associations. Fraud detection logic 1722 may rely on fraud risk score data 1882 to prioritize investigations and allocate resources efficiently. Additionally, compliance logic 1728 may use this data to ensure that high-risk activities are flagged and addressed in line with regulatory requirements.

In additional embodiments, behavioral scoring data 1883 can include metrics that analyze borrower behavior patterns, such as payment habits, borrowing frequency, and application tendencies. This sub-data type may be used by decision support logic 1727 to identify trends that inform broader lending strategies. Behavioral scoring data 1883 may also assist underwriting logic 1721 in assessing borrower reliability and by loan product generation logic 1723 to design products tailored to specific behavioral profiles.

In further embodiments, financial health score data 1884 may provide a holistic evaluation of a borrower's overall financial well-being, combining elements such as income stability, asset liquidity, and liability management. This sub-data type may serve as an input for underwriting logic 1721 to determine loan suitability and for decision support logic 1727 to assess portfolio risk. Financial health score data 1884 may also interact with customer segment score data 1885 to align borrowers with appropriate loan categories.

In some embodiments, customer segment score data 1885 may categorize borrowers into specific groups based on shared characteristics, such as demographics, financial behaviors, or geographic location. This sub-data type may help the system identify trends and tailor offerings to meet the needs of distinct customer segments. Loan product generation logic 1723 may use customer segment score data 1885 to develop targeted products, while reporting data 1790 may leverage it to provide insights into the performance of different borrower groups.

In various embodiment, reporting data 1890 can serve as a critical output of the lending system, providing structured and actionable insights for internal stakeholders, regulators, and other external entities. This type of data may encompass aggregated metrics, summaries, and detailed analyses that reflect the performance, compliance, and strategic direction of the system. Reporting data 1890 can support transparency, accountability, and decision-making by enabling a clear understanding of system operations and outcomes. As previously mentioned, this data type may be derived from a variety of inputs, including customer data 1840, environmental data 1850, scoring data 1880, and compliance data 1870. Reporting data 1890 can include both real-time updates and historical trends, offering dynamic insights into system performance. Various logics within the system, such as decision support logic 1727 and compliance logic 1728, may interact with reporting data 1890 to enhance strategic planning, regulatory adherence, and operational efficiency. Interaction logic 1726 may facilitate the distribution of reporting data 1890 to the appropriate stakeholders, ensuring its timely and effective use.

In some embodiments, performance report data 1891 can include metrics and analyses that reflect the overall operational and financial performance of the system. This sub-data type may encompass details such as loan approval rates, repayment trends, portfolio growth, and revenue generation. Performance report data 1891 may be used by decision support logic 1727 to evaluate system effectiveness and identify areas for improvement. Loan product generation logic 1723 may also reference this data to fine-tune offerings based on performance trends and market demand.

In various embodiments, risk report data 1892 may capture assessments and summaries of risks across the system, including borrower risk, portfolio risk, and market exposure. This sub-data type may include aggregated risk scores, fraud detection trends, and stress-testing results. Underwriting logic 1721 and fraud detection logic 1722 may interact with risk report data 1892 to refine their processes and strategies, while decision support logic 1727 may use it to guide long-term risk management policies.

In yet further embodiments, financial forecasting data 1893 may provide predictive insights into the future performance of the system, considering factors such as loan demand, market conditions, and economic trends. This sub-data type may include revenue projections, cost analyses, and scenario modeling outputs. Financial forecasting data 1893 can be utilized by decision support logic 1727 to align strategic initiatives with anticipated trends, while loan product generation logic 1723 may leverage it to anticipate demand for specific loan products or terms.

In some more embodiments, regulatory compliance report data 1894 may consist of documentation and summaries that demonstrate the system's adherence to legal and regulatory standards. This sub-data type may include reports on anti-money laundering activities, fair lending practices, and data privacy compliance. Compliance logic 1728 may rely on regulatory compliance report data 1894 to prepare for audits and ensure adherence to statutory requirements. External integration logic 1729 may facilitate the submission of this data to regulatory bodies as required.

In yet additional embodiments, customer insights report data 1895 may offer detailed analyses of borrower behaviors, preferences, and segment trends, providing actionable intelligence for tailoring products and improving customer engagement. This sub-data type may include summaries of customer satisfaction surveys, segment performance analyses, and lifetime value calculations. Loan product generation logic 1723 may use customer insights report data 1895 to create targeted offerings, while decision support logic 1727 may incorporate it into broader strategies for enhancing customer experience and retention.

Although a specific embodiment for a plurality of data suitable for carrying out the various steps, processes, methods, and operations described herein is discussed with respect to FIG. 18, any of a variety of systems and/or processes may be utilized in accordance with embodiments of the disclosure. For example, the output for other types of models can be token related to images, sounds, or other data format types. The elements depicted in FIG. 18 may also be interchangeable with other elements of FIGS. 1-17, and 19-20 as required to realize a particularly desired embodiment.

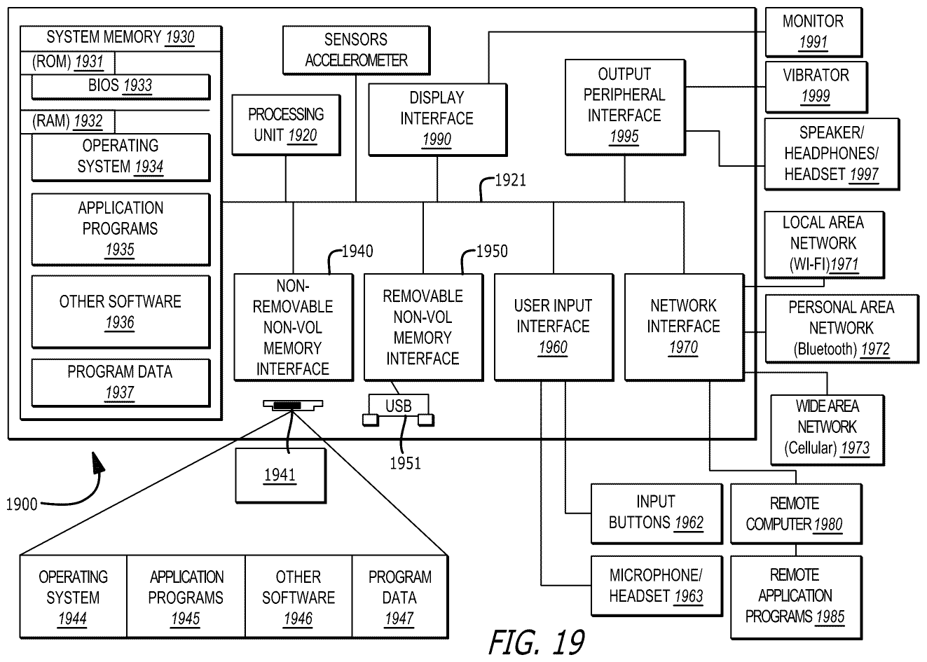

FIG. 19 provides a schematic illustrating components of a network host 1900 such as any one or more server hosts of the integrated lending-and-brokering 100 in accordance with some embodiments. Components of the network host 1900 vary in accordance with host type. As such, each and every component shown and described in reference to FIG. 19 need not be included in each host type. Furthermore, each host type can further include components not shown or described in reference to FIG. 19 but otherwise described herein.

As shown, components of the network host 1900 can include, but are not limited to, a processing unit 1920 having one or more processing cores, a primary or system memory 1930, and a system bus 1921 that couples various system components including the system memory 1930 to the processing unit 1920. The system bus 1921 can be any of several types of bus structures selected from a memory bus or memory controller, a peripheral bus, and a local bus using any of a variety of bus architectures.

The network host 1900 can include a variety of computer-readable media. Computer-readable media can be any media that can be accessed by the network host 1900 and includes both volatile and nonvolatile media, as well as removable and non-removable media. By way of example, and not limitation, use of computer-readable media includes storage of information, such as computer-readable instructions, data structures, other executable software, or other data. Computer-readable media includes, but is not limited to, RAM, ROM, EEPROM, flash memory or other memory technology, CD-ROM, digital versatile disks (“DVD”) or other optical disk storage, magnetic cassettes, magnetic tape, magnetic disk storage or other magnetic storage devices, or any other tangible medium that can be used to store the desired information for access by the network host 1900. Transitory media such as wireless channels are not included in the computer-readable media. Communication media typically embody computer-readable instructions, data structures, other executable software, or other transport mechanisms and includes any information delivery media. As an example, some client hosts on a network might not have optical or magnetic storage.

The system memory 1930 includes computer-readable media in the form of volatile or nonvolatile memory such as read only memory (“ROM”) 1931 and random-access memory (“RAM”) 1932. A basic input-output system 1933 (“BIOS”) containing the basic routines that help to transfer information between elements within the network host 1900, such as during start-up, is typically stored in ROM 1931. RAM 1932 typically contains software or data that are immediately accessible for operations by the processing unit 1920. By way of example, and not limitation, FIG. 19 illustrates that RAM 1932 can include a portion of the operating system 1934, application programs 1935, other executable software 1936, and program data 1937.

The network host 1900 can also include other computer-readable media. By way of example only, FIG. 19 illustrates a solid-state memory 1941. Other computer-readable media that can be used in the example operating environment include, but are not limited to, universal serial bus (“USB”) drives and devices, flash memory cards, solid state RAM, solid state ROM, or the like. The solid-state memory 1941 is typically connected to the system bus 1921 through a non-removable memory interface such as interface 1940, and USB drive 1951 is typically connected to the system bus 1921 by a removable memory interface such as interface 1950.

The drives and their associated computer-readable media provide storage of computer-readable instructions, data structures, other executable software, or other data for the network host 1900. In FIG. 19, for example, the solid-state memory 1941 is illustrated for storing operating system 1944, application programs 1945, other executable software 1946, or program data 1947. Note that these components can either be the same as or different from operating system 1934, application programs 1935, other executable software 1936, and program data 1937. Operating system 1944, application programs 1945, other executable software 1946, and program data 1947 are given different numbers here to illustrate that, at a minimum, they are different copies.

A user can enter commands and information into the network host 1900 through input devices such as a keyboard, touchscreen, or software or hardware input buttons 1962, a microphone 1963, a pointing device such as a mouse, or scrolling input component such as a trackball or touch pad. The microphone 1963 can cooperate with speech recognition software. These and other input devices are often connected to the processing unit 1920 through a user input interface 1960 that is coupled to the system bus 1921 but can be connected by other interface and bus structures, such as a parallel port, game port, or USB. A display monitor 1991 or other type of display screen device is also connected to the system bus 1921 via an interface such as a display interface 1990. In addition to the monitor 1991, the network host 1900 can also include other peripheral output devices such as speakers 1997 and other output devices, which can be connected through an output peripheral interface 1995.

The network host 1900 can operate in a networked environment using logical connections to one or more other network hosts such as network host 1980. Like the network host 1900, the network host 1980 can be a personal computer, a server, a router, a network PC, a peer device, or another network node. The logical connections depicted in FIG. 19 can include a local area network (“LAN”) 1971 (e.g., Wi-Fi) or a wide area network (“WAN”) 1973 (e.g., cellular network). Such networking environments are commonplace in offices, enterprise-wide computer networks, intranets and the Internet. A browser application can be resident on the network host 1900 and stored in the memory.

When used in a LAN networking environment, the network host 1900 is connected to the LAN 1971 through an adapter or network interface 1970, which can be, for example, a Bluetooth® or Wi-Fi adapter. When used in a WAN networking environment (e.g., Internet), the network host 1900 can include some means for establishing communications over the WAN 1973. With respect to telecommunication technologies, for example, a radio interface, which can be internal or external, can be connected to the system bus 1921 via the network interface 1970, or another appropriate mechanism. In a networked environment, other software depicted relative to the network host 1900, or portions thereof, can be stored in the remote memory storage device. By way of example, and not limitation, FIG. 19 illustrates remote application programs 1985 as residing on the network host 1980. It will be appreciated that the network connections shown are examples and other means of establishing a communications link between the network hosts can be used.

As discussed, the network host 1900 can include a processor or processing unit 1920, a memory (e.g., ROM 1931, RAM 1932, etc.), an AC power input, a display screen, and built-in Wi-Fi circuitry to wirelessly communicate with other network hosts connected to the network. Another device that can be coupled to bus 1921 is a power supply such as a DC power supply (e.g., battery) or an AC adapter circuit. As discussed above, the DC power supply can be a battery, a fuel cell, or similar DC power source that needs to be recharged on a periodic basis. A wireless communication module can employ a Wireless Application Protocol to establish a wireless communication channel. The wireless communication module can implement a wireless networking standard.

In some embodiments, software used to facilitate algorithms discussed herein can be embodied into a non-transitory computer-readable medium. A computer-readable medium includes any mechanism that stores information in a form readable by a computer. For example, a non-transitory machine-readable medium can include ROM; RAM; magnetic disk storage media; optical storage media; flash memory devices; DVDs, EPROMs, EEPROMs, FLASH memory, magnetic or optical cards, or any type of media suitable for storing electronic instructions.

An application described herein includes, but is not limited to, software applications and programs that are part of an operating system or integrated with or on an application layer thereof. Some portions of this description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as C, C+, or other similar languages. Also, an algorithm can be implemented with lines of code in software, configured logic gates in software, or a combination of both. In an embodiment, the logic consists of electronic circuits that follow the rules of Boolean Logic, software that contain patterns of instructions, or any combination of both.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a network host, or similar electronic computing device, that manipulates and transforms data represented as physical (electronic) quantities within the computer system's registers and memories into other data similarly represented as physical quantities within the computer system memories or registers, or other such information storage, transmission or display devices.

Many functions performed by electronic hardware components can be duplicated by software emulation. Thus, a software program written to accomplish those same functions can emulate the functionality of the hardware components in input-output circuitry. Note that while the embodiment depicted in FIG. 19 illustrates various components of a data processing system, it is not intended to represent any particular architecture or manner of interconnecting the components; as such details are not germane to embodiments of the present disclosure. It should also be appreciated that network computers, handheld computers, mobile phones, and other data processing systems, which have fewer components or perhaps more components, may also be used with embodiments of the disclosure described herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it should be appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The techniques shown in the figures can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals).

The processes or methods depicted in the preceding figures may be performed by processing logic that comprises hardware (e.g. circuitry, dedicated logic, etc.), firmware, software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

A non-transitory CRM can include executable instructions that, when executed on one or more server hosts such as the server hosts by at least an equal number of processors, cause the one or more server hosts to instantiate a personal loan-lending system configured to perform a number of operations of the personal loan-lending system. The operations include instantiating a personal loan-originating application stack of a personal loan-originating system for originating personal loans, instantiating a personal loan-servicing application stack of a personal loan-servicing system for servicing the personal loans, and providing third-party integration or supporting the originating or the servicing of the personal loans. The third-party integration or includes one or more APIs configured for transferring loan-related information between the personal loan-lending system and third parties.

The operations further include operating the personal loan-originating application stack at least in part in a primary memory of at least one server host of the one or more server hosts. The personal loan-originating application stack includes a web server, an application server, a database server, and an e-mail server. The operations further include operating the personal loan-servicing application stack at least in part in a same primary memory of the at least one server host or a different primary memory of at least one other server host of the one or more server hosts. The personal loan-servicing application stack includes a web server, an application server, a database server, and an e-mail server.

The operations further include providing at least a mobile web application by way of the application server. The mobile web application is configured to operate at least in part in a primary memory of a mobile device and present the borrower GUI within a mobile web browser on a touchscreen of a display of the mobile device. The borrower GUI is configured to allow potential borrowers to enter borrower-related information into a number of borrower-fillable sections of a digital application.

The operations further include providing at least a web application by way of the application server. The web application is configured to operate at least in part in a primary memory of a personal computer and present the lender GUI within a web browser on a screen of a monitor associated with the personal computer. The lender GUI is configured to allow a representative of the lender to review the borrower-related information entered in the number of sections of the digital application. The operations further include sending secured e-mail messages through the lender GUI by way of the e-mail server. The lender GUI is configured to allow the representative of the lender to send the secured e-mail messages with automatic e-mail headers and attachments determined in accordance with a focus in the lender GUI on a particular borrower and loan process step.

The operations further include transferring to the database server and storing in a database on a storage device of the at least one server host of the one or more server hosts borrower-related information held in the number of sections of the digital application. The number of sections of the digital application for the personal loan include a borrower-account registration section, a loan-purpose section, a borrower-profile section, an income-information section, an employment-history section, a banking-information section, or a combination thereof.

The operations further include automatically underwriting with the automatic underwriting module of the personal loan-originating application stack. The automatic underwriting module is configured to perform detailed risk assessments in view of the borrower-related information transferred to the database server and stored in the database on the storage device of the at least one server host of the one or more server hosts.

It is contemplated that, in some embodiments, an artificial intelligence model can be configured to accurately perform one or more of the steps comprising automatically underwriting loans, as described herein. For example, in some embodiments, automatic underwriting module 3570 may further include an artificial intelligence (AI) module that is configured to train one or more AI (e.g., machine learning or other suitable AI) models to perform one or more steps of the disclosure. In some embodiments, the AI module can be implemented using any of various techniques including, without any limitation, case-based reasoning, rule-based systems, fuzzy models, genetic algorithms, cellular automata, multi-agent systems, swarm intelligence, reinforcement learnings, artificial neural networks, hybrid systems, and the like. In one embodiment, the AI module may employ an artificial neural network to obtain and process fragmented pieces of information, as mentioned above. In some embodiments, the AI module may be trained on dataset(s) representing user account histories and/or previous readjustments, determinations, qualifying offers, weights, metrics, thresholds, qualifying scores, or any other suitable or relevant training data. In some embodiments, the AI module may be trained on the specific user's account(s) and/or credit history.

In some embodiments, the AI module may be configured to self-correct and improve based on a reward feedback circuit for modifying the one or more assigned weights and/or unique thresholds. For example, upon a readjustment of the weights of metrics, the readjustment values can be measured as leading to a desired outcome or undesired outcome according to one or more criteria, then fed back into the AI module as training data. As the AI module further trains on the readjustments, it makes and whether those readjustments are desirable or undesirable, the AI module self-corrects and improves as it continues to make readjustments. A wide variety of potential AI module can be employed for such a self-correcting technique. In some embodiments, one or more AI models comprising the AI module may be used in a similar manner for other determinations, computations, and/or predictions within the system. In some embodiments, one or more AI models comprising the AI module may be configured to automatically generate any one or more of metrics, weights, thresholds, tiers, qualifying scores for tiers, qualifying offers, reports, or any other suitable aspect of the systems described herein, without limitation. In some embodiments, such AI models comprising the AI module may be configured to similarly self-correct and improve this generation based on feedback reward circuits.

The operations further include providing a servlet configured to allow the potential borrowers to upload electronic copies or images of documents selected from at least driver's licenses, pay stubs, and bank statements. Each section of the number of sections of the digital application optionally includes a graphical element configured to activate the servlet upon activation of the graphical element by a potential borrower and upload the electronic copes or images of documents. The operations further include recognizing text in uploaded images of documents with the OCR module of the personal loan-originating application stack, extracting text from the uploaded images of documents with the OCR module, and providing the text by way of the web server for automated filling of the borrower-related information.

The operations further include automatically depositing personal-loan funds by way of the personal loan-originating system. The borrower-related information from the banking information section transferred to the database server and stored in the database on the storage device of the at least one server host of the one or more server hosts is used for automatically depositing the personal-loan funds. The operations further include automatically setting up monthly ACH payments by way of the personal loan-originating system on personal loans in accordance with terms of the personal loans. The borrower-related information from the banking information section transferred to the database server and stored in the database on the storage device of the at least one server host of the one or more server hosts is used for automatically setting up the monthly ACH payments.

The concepts provided herein including the particular embodiments thereof represent a technological advancement in lending and servicing, particularly lending and servicing with respect to personal loans. The personal loan-lending system incorporates computer-related technology for tight integration including information sharing between the personal loan-originating system and the personal loan-servicing system in order to provide such a technological advancement. At least one example is using borrower-related information for a bank account, or the linked bank account itself, to automatically deposit personal-loan funds in the bank account as well as automatically set up monthly ACH payments to pay down the personal loan.

Various embodiments of the system described can provide significant technological benefits, addressing challenges associated with the fragmented, manual, and often error-prone processes traditionally found in lending platforms. By integrating a plurality of logics, each interacting with distinct but interconnected types of data, the system offers a streamlined, automated approach that improves the functionality of lending systems. These improvements are rooted in the system's ability to manage, analyze, and utilize diverse data types dynamically, ensuring faster, more reliable, and more compliant decision-making processes.

One of the key advantages of the system lies in its ability to enhance data processing and interaction through a highly integrated architecture. The system's use of interaction logic to facilitate seamless communication among logics, coupled with its reliance on structured data types such as customer data, environmental data, and scoring data, transforms traditional data handling methodologies. This configuration ensures that data flows are consistent, accurate, and secure, reducing latency and improving the reliability of lending operations. This enhanced data processing is not a mere abstract idea but rather a concrete improvement in the way lending systems manage data.

Another benefit of the system is its ability to dynamically adapt to changing conditions and inputs. For example, the integration of scoring data derived from real-time updates in environmental data enables the system to adjust risk assessments and loan terms dynamically. This adaptability is implemented through specialized logics, such as decision support logic and compliance logic, which actively process and respond to new data. These features provide a technical improvement over static systems by allowing the lending platform to operate effectively in fluctuating economic and regulatory environments, addressing practical issues such as compliance risks and operational inefficiencies.

The system also enhances compliance and regulatory adherence in ways that go beyond conventional practices. By incorporating compliance data and regulatory reporting mechanisms directly into its workflows, the system ensures that all decisions, from loan origination to servicing, align with applicable laws and standards. This integration is achieved through a combination of automated validation, reporting, and auditing functions, reducing the likelihood of human error and the associated legal risks. Such features demonstrate that the system offers specific and concrete solutions to compliance challenges, transcending general concepts or abstract ideas.

Additionally, the system's ability to combine various types of data, such as scraped data, customer data, and compliance data, provides a holistic view that informs decision-making processes across multiple dimensions. This comprehensive data utilization reduces redundancies and enables the system to identify and mitigate risks more effectively. For example, the combination of fraud risk score data and geographic risk data provides a granular understanding of potential threats, allowing the system to implement targeted safeguards. These functionalities represent technical improvements that directly enhance the operation of lending platforms, ensuring security, efficiency, and adaptability.

Although a specific embodiment for a schematic illustrating components of a network host in accordance with some embodiments suitable for carrying out the various steps, processes, methods, and operations described herein is discussed with respect to FIG. 19, any of a variety of systems and/or processes may be utilized in accordance with embodiments of the disclosure. For example, the specific arrangement and components presented may vary based on the application desired. The elements depicted in FIG. 19 may also be interchangeable with other elements of FIGS. 1-18, and 20 as required to realize a particularly desired embodiment.

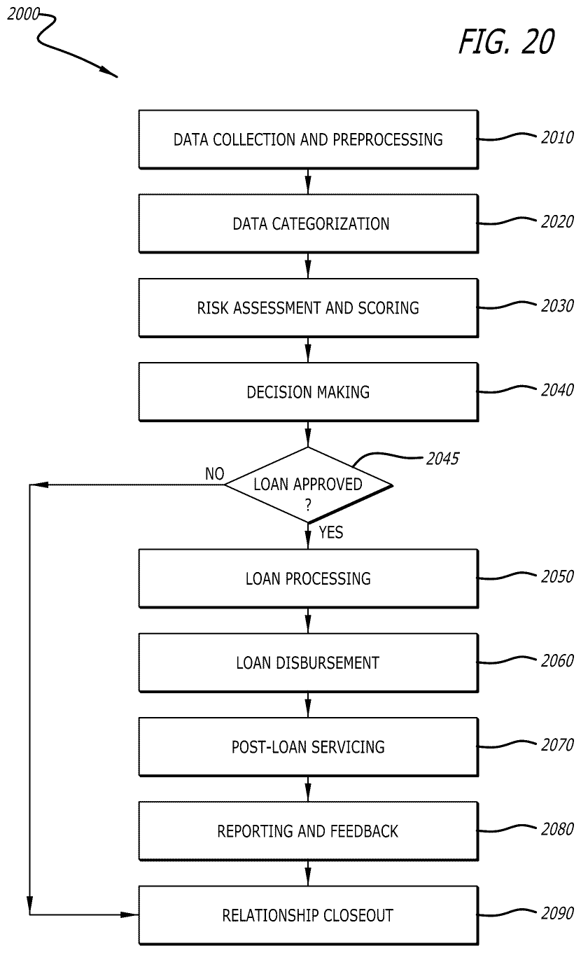

Referring to FIG. 20, a process 2000 for loan processing in accordance with various embodiments of the disclosure is shown. In many embodiments, the process 2000 can execute data collection and preprocessing (block 2010). In some embodiments, preprocessing this data may involve cleaning, validating, and organizing it into standardized formats for use by other components of the system. This stage can involve various logics such as data aggregation logic 1724 and data verification logic 1725, ensuring that the information is accurate and ready for subsequent steps.

In a number of embodiments, the process 2000 can categorize data (block 2020). In still other embodiments, this categorization step can streamline the analysis and decision-making process, allowing the system to apply specific logics to relevant data subsets. Interaction logic 1726 may play a critical role in ensuring that the categorized data is routed to appropriate modules for further processing. Data categorization may be done internally, or via a third-party service, machine learning process, or LLM, etc.

In more embodiments, the process 2000 can conduct risk assessment and scoring (block 2030). In certain embodiments conducting of risk assessment and scoring are functions executed by scoring data 1880, and they may rely on logics such as underwriting logic 1721 and fraud detection logic 1722. The outcome of this stage can inform the subsequent decision-making steps in the process. This may also be done internally, or via a third-party service, machine learning process, or LLM, etc.

In further embodiments, the process 2000 can make one or more decisions (block 2040). In some embodiments, decision support logic 1727 may facilitate this step by synthesizing inputs from various data types and providing recommendations. This stage can be for determining whether the loan should be approved or denied. The decision can be automated by the system or prompted for human review before deciding.

In additional embodiments, the process 200 can determine if the loan is approved (block 2045). If it is determined that the loan has not been approved, then the process 2000 can closeout the relationship (block 2090). However, if it is determined that the loan is approved, the process 2000 can process the loan (block 2050). The loan may be processed traditionally or via one or more network devices.

In still more embodiments, the process 2000 can disburse the loan (block 2060). In many embodiments, the loan product generation logic 1723 and compliance logic 1728 may be utilized in this step, ensuring that the loan terms align with regulatory and institutional standards. The disbursement can be done via ACH or by traditional check.

In yet further embodiments, the process 2000 can undergo post-loan servicing (block 2070). Customer data 1840 and historical data 1845 may be utilized at this stage to track repayment behaviors and ensure that the borrower's account remains up-to-date. This post-loan servicing can be done through one or more brick-and-mortar locations or via a web service.

In various embodiments, the process 2000 can generate reporting and feedback (block 2080). This step may be used to inform stakeholders and optimize future operations. Compliance logic 1728 and decision support logic 1727 may also use this stage to identify opportunities for improvement or ensure regulatory adherence. The reporting and/or feedback can be generated for internal purposes only or for internal and external/customer use as well.

In some embodiments, the process can eventually closeout the relationship (block 2090). At the end of the loan lifecycle, the system may close out the relationship with the borrower. This could involve finalizing payments, providing closing documentation, and archiving the borrower's data. Interaction logic 1726 may ensure that all components of the system transition smoothly to closure.

Although a specific embodiment for a process for loan processing in accordance with some embodiments suitable for carrying out the various steps, processes, methods, and operations described herein is discussed with respect to FIG. 20, any of a variety of systems and/or processes may be utilized in accordance with embodiments of the disclosure. For example, the specific arrangement of steps presented may vary based on the application desired. The elements depicted in FIG. 20 may also be interchangeable with other elements of FIGS. 1-19 as required to realize a particularly desired embodiment.

While the personal loan-lending system and methods have been described in terms of particular variations and illustrative figures, those of ordinary skill in the art will recognize that the personal loan-lending system is not limited to the variations or figures described. In addition, where methods and steps described above indicate certain events occurring in certain order, those of ordinary skill in the art will recognize that the ordering of certain steps may be modified and that such modifications are in accordance with the variations of the personal loan-lending system. Additionally, certain of the steps may be performed concurrently in a parallel process, when possible, as well as performed sequentially as described above. To the extent there are variations of the personal loan-lending system, which are within the spirit of the disclosure or equivalent to the personal loan-lending system found in the claims, it is the intent that this patent will cover those variations as well. Therefore, the present disclosure is to be understood as not limited by the specific embodiments described herein, but only by scope of the appended claims.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A lending system, comprising:
a processor;
at least one network interface controller configured to enable data exchange with external systems; and
a memory communicatively coupled to the processor, wherein the memory comprises a lending management logic configured to:
execute a personal loan-lending system wherein one or more loans are generated by:
collecting and preprocessing borrower data from multiple sources;
conducting risk assessment and scoring to the collected data;
generating one or more scores based on the conducted risk assessment; and
approving a loan based on the one or more scores, wherein the one or more scores are generated via one or more machine learning processes.

2. The lending system of claim 1, wherein the borrower data collected from one or more sources comprising: customer data, environmental data, or compliance data.

3. The lending system of claim 1, wherein the lending management logic is further configured to validate the collected borrower against at least Know Your Customer (KYC) data and Anti-Money Laundering (AML) requirements.

4. The lending system of claim 1, wherein the one or more machine learning processes include training models using historical data and real-time borrower behavior to improve an accuracy of the generated scores.

5. The lending system of claim 1, wherein the memory further comprises an external integration logic configured to retrieve additional borrower information from third-party data providers to enhance an accuracy of risk assessment.

6. The lending system of claim 1, wherein the one or more scores include a credit score, a fraud likelihood score, and a financial health score, each generated using distinct algorithms tailored to specific data inputs.

7. The lending system of claim 1, wherein the lending management logic is further configured to dynamically adjust a loan approval criteria based on at least one of: environmental data, including geographic risk data or market condition data.

8. The lending system of claim 1, wherein the score generation is based on at least borrower demographics and financial profiles generated by one or more large language models.

9. The lending system of claim 1, wherein the lending management logic is further configured to generate detailed risk assessment reports for each loan via the one or more machine learning processes, summarizing the collected data and scoring metrics.

10. The lending system of claim 1, wherein the one or more machine learning processes are configured to self-optimize by analyzing outcomes of previously approved loans to refine scoring algorithms.

11. The lending system of claim 1, wherein the lending management logic is further configured to track and update borrower repayment history in near real-time to continuously adjust risk and financial health scores.

12. The lending system of claim 1, wherein the lending management logic further comprises utilizing compliance logic to generate at least one regulatory compliance report based on borrower data and the scoring process.

13. A method for operating a loan server, wherein the method comprises:
executing a personal loan-lending system wherein one or more loans are generated by:
collecting and preprocessing borrower data from multiple sources;
conducting risk assessment and scoring to the collected data;
generating one or more scores based on the conducted risk assessment; and
approving a loan based on the one or more scores, wherein the one or more scores are generated via one or more machine learning processes.

14. The method of claim 13, wherein executing the personal loan-lending system further comprises generating a borrower financial profile via one or more machine learning processes prior to conducting a risk assessment.

15. The method of claim 14, wherein the one or more machine learning processes is a large language model.

16. The method of claim 15, wherein the risk assessment utilizes the generated borrower financial profile.

17. The method of claim 15, wherein executing the personal loan-lending system further comprises converting the risk assessment into an input compatible with a neural network.

18. The method of claim 16, wherein the one or more machine learning processes utilize at least a neural network configured with at least the one or more scores as an input to the neural network.

19. The method of claim 17, wherein the one or more machine learning processes utilize at least a neural network configured with at least the one or more scores, and converted risk assessments as inputs to the neural network.

20. A personal loan-lending system operable by way of a set of executable instructions stored in non-transient machine-readable media of one or more server hosts by at least an equal number of processors, the personal loan-lending system comprising:
a personal loan-originating system configured for originating personal loans, wherein originating personal loans includes at least:
collecting and preprocessing borrower data from multiple sources;
conducting risk assessment and scoring to the collected data;
generating one or more scores based on the conducted risk assessment; and
approving a loan based on the one or more scores, wherein the one or more scores are generated via one or more machine learning processes;
a personal loan-servicing system configured for servicing the personal loans; and
third-party integration supporting the originating or the servicing of the personal loans.
